(19) United States
(12) Patent Application Publication
(10) Pub. No.: US 2010/0104879 A1
(43) Pub. Date: Apr. 29, 2010

(54) CLEAR HARD COAT FILM, ANTI-REFLECTION FILM, POLARIZING PLATE AND DISPLAY DEVICE EMPLOYING THE SAME

(76) Inventor: Satoshi Okano, Tokyo (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/452,165

(22) PCT Filed: May 16, 2008
(86) PCT No.: PCT/JP2008/059040

§ 371 Date: Dec. 17, 2009

(30) Foreign Application Priority Data
Jun. 26, 2007 (JP) 2007-167197

(51) Int. Cl. B32B 27/28; B32B 27/08

(52) U.S. Cl. 428/447

(57) ABSTRACT

The invention provides a clear hard coat film which exhibits excellent film strength even after the alkali saponification treatment of the hard coat layer conducted in order to improve the tight adhesion property to PVA film constituting a substrate of a polarizing film in laminating the polarizing film with the hard coat film and which is little deteriorated in the film strength even after the durability test under exposure to ozone; and anti-reflection film, a polarizing plate and a display device made by using the clear hard coat film. The invention relates to a clear hard coat film comprising hard coat layer having clear hard coat film on a transparent film substrate wherein the hard coat layer contains a fluorine-siloxane graft polymer and an energy actinic radiation curable resin. It is preferable that the weight ratio of the fluorine-siloxane graft polymer to energy actinic radiation curable resin is 0.05:100 to 5.00:100, and the energy actinic radiation curable resin is preferably a UV ray curable resin. It is preferable to subject the hard coat layer to alkali saponification.

### TECHNICAL FIELD

The present invention directs to a clear hard coat film, an anti-reflection film employing the clear hard coat film, a polarizing plate employing the anti-reflection film, and a display device employing the polarizing plate.

### BACKGROUND

A clear hard coat film is provided at the uppermost layer of a display device such as a cathode ray tube display device (CRT), a plasma display (PDP), an electroluminescent display (ELD), a liquid crystal display device (LCD) for the purpose of surface protection in general. The clear hard coat film is manufactured by providing a clear hard coat layer on a substrate film such as a cellulose acetate resin (mainly triacetylcellulose), a polyethyleneterephthalate or acryl type resin and so on.

The clear hard coat film is employed as a protective layer of a polarizing film, which is prepared by forming a polarizing film by making iodine or dichroic dye absorbed on a polarizing film substrate film orientated by stretching then the protective layer is formed on both sides.

Practically, the hard coat layer is employed generally by providing at the uppermost layer of a cellulose ester film such as triacetate film as a protective layer.

Polyvinyl alcohol (referred as PVA) and its derivative film are mainly used for the polarizing film substrate. The polarizing film is manufactured by a method in which a hard coat layer is formed previously on a cellulose ester film such as triacetate film and it is laminated on a polarizing film, but not a method in which a cellulose ester film such as a triacetate film on which a hard coat layer is formed is laminated with polarizing film, to produce a high quality products with more efficiently, that is, high speed, mass productivity, high yield and at low cost in the producing process.

In case of laminating on the polarizing film, the cellulose ester film such as triacetate film, on which a hard coat layer is formed, is laminated previously subjected to alkali saponification treatment to improve adhesion performance with PVA as a polarizing film substrate film.

The clear hard coat film is expected to have a function as a protective layer of the display device at the uppermost layer, and it is practically required to have such properties that stain or dust are hardly adhered and easily cleaned if adhered, and to have hardness and strong anti-abrasion properties regardless preservation condition.

Various anti-stain protective layers are proposed to improve performance of inhibiting adhesion of stain or dust and the following patent documents are known.

Patent document relates to a fluorosilicone compound and a composition containing the compound, and describes a fluorosilicone compound having at least two hydroxy groups in a molecule and a hardenable composition containing the compound and a general hardening agent. It is described that the hardenable composition may be used as anti-stain coating composition and a coating composition for optical use.

Patent document 2 discloses an anti-stain substrate having a layer of organic fluorine polymer containing silicon formed on the substrate surface, and is described that the anti-stain substrate is excellent in anti-stain performance against oily staining substances.

Patent document 3 relates to a non-glare film having an anti-stain, and described that a non-glare layer of the non-glare film contains a fluorine modified compound.
Patent document 1: WO 95/33001
Patent document 2: JP-A H09-157582
Patent document 3: JP-A 2000-194272

### DESCRIPTION OF THE INVENTION

### Technical Problem to be Dissolve the Problem

There are problems in the technologies described the patent documents 1 to 3 that a film strength (anti-abrasion properties, pencil hardness) after alkali saponification treatment is insufficient when the above described clear hard coat film is laminated with a polarizing film, and film strength degrades after durability test under ozone exposure condition assuming long term use in a usual room as a protective layer used at the uppermost layer of a display device.

The object of the present invention is to dissolve the problems of the conventional technology and to provide a clear hard coat film having excellent film strength after alkali saponification treatment as well as inhibiting deterioration of film strength after durability test under ozone exposure condition, and an anti-reflection film, a polarizing plate and a display device employing the clear hard coat film.

### Technical Means to Dissolve the Problems

The inventor of this invention completed the present invention have found that the problems of the conventional technologies are dissolved by to compose a hard coat layer by a fluorine-siloxane graft polymer and an energy actinic radiation curable resin after a result of the earnest research considering the above described items.

The invention described in claim 1 is characterized in that in a clear hard coat film having a hard coat layer on a transparent film substrate the hard coat layer comprises a fluorine-siloxane graft polymer and an energy actinic radiation curable resin, to attain the object.

The fluorine-siloxane graft polymer is defined as a copolymer obtained by that siloxane (including siloxane) and/or organo siloxane (organo including siloxane) is grafted to at least fluorine resin.

The invention described in claim 2 is the clear hard coat film described in claim 1 characterized in that a content ratio by weight of the fluorine-siloxane graft polymer to energy actinic radiation curable resin is from 0.05:100 to 5.00:100.

The invention described in claim 3 is the clear hard coat film described in claim 1 or 2 characterized in that the energy actinic radiation curable resin is a UV ray curable resin.

The invention described in claim 4 is the clear hard coat film described in any one of claims 1 to 3 characterized in that the hard coat layer is subjected to alkali saponification treatment.

The invention described in claim 5 is the clear hard coat film described in any one of claims 1 to 4 characterized in that the hard coat layer comprises organic particles and/or inorganic particles.

The invention described in claim 6 is the clear hard coat film described in any one of claims 1 to 5 characterized in that the hard coat layer comprises a fluorine-acryl copolymer resin.

The invention described in claim 7 is the clear hard coat film described in any one of claims 1 to 6 characterized in that a layer having at least fluorine-acryl copolymer resin is laminated on the hard coat layer.

The invention described in claim 8 is the clear hard coat film described in any one of claims 1 to 7 characterized in that the transparent film substrate is a cellulose ester film.

The invention described in claim 9 is the clear hard coat film described in any one of claims 1 to 8 characterized in that the transparent film substrate comprises at least one compound containing an acryloyl group represented by Formula (Z).

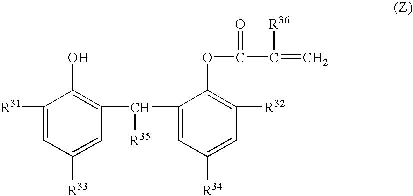

In the formula, R³¹ to R³⁵ are same or different each other and a hydrogen atom or an alkyl group having 1 to 10 carbon atoms, R³⁶ is a hydrogen atom or a methyl group.

The invention described in claim 10 is an anti-reflection film characterized in that a layer of high refractive index is provided on the hard coat layer of the clear hard coat film described in any one of claims 1 to 9, and a layer of low refractive index is provided on the layer of high refractive index.

The invention described in claim 11 is a polarizing plate characterized in that the clear hard coat film described in any one of claims 1 to 9 is employed at one surface.

The invention described in claim 12 is the polarizing plate described in claim 10 characterized in that the anti-reflection film is employed at one surface.

The invention described in claim 13 is a display device characterized in that the polarizing plate described in claim 11 or 12 is employed.

### ADVANTAGE OF THE INVENTION

The invention described in claim 1 is, in a clear hard coat film having a hard coat layer on a transparent film substrate, the hard coat layer comprises a fluorine-siloxane graft polymer and an energy actinic radiation curable resin, to attain the object. According to the invention described in claim 1, such advantages as having excellent film strength after alkali saponification treatment and inhibiting deterioration of film strength after durability test under ozone exposure condition are displayed.

The invention described in claim 2 is the clear hard coat film described in claim 1 wherein a content ratio by weight of the fluorine-siloxane graft polymer to energy actinic radiation curable resin is from 0.05:100 to 5.0:100. According to the invention described in claim 1, such an excellent advantage as inhibiting deterioration of film strength high alkali concentration condition of alkali saponification treatment or under severe condition of exposure to ozone.

The invention described in claim 3 is the clear hard coat film described in claim 1 or 2 wherein the energy actinic radiation curable resin is a UV ray curable resin. According to the invention described in claim 3, such advantages as having excellent film strength and inhibiting deterioration of film strength after durability test under ozone exposure condition are displayed.

The invention described in claim 4 is the clear hard coat film described in any one of claims 1 to 3 wherein the hard coat layer is subjected to alkali saponification treatment. According to the invention described in claim 4, such advantages as having excellent film strength after alkali saponification treatment and inhibiting deterioration of film strength after durability test under ozone exposure condition are displayed.

The invention described in claim 5 is the clear hard coat film described in any one of claims 1 to 4 wherein the hard coat layer comprises organic particles and/or inorganic particles. According to the invention described in claim 5, such advantage as inhibiting deterioration of film strength after durability test under ozone exposure condition are displayed.

The invention described in claim 6 is the clear hard coat film described in any one of claims 1 to 5 wherein the hard coat layer comprises a fluorine-acryl copolymer resin. According to the invention described in claim 6, such advantage as inhibiting deterioration of film strength after durability test under ozone exposure condition are displayed.

The invention described in claim 7 is the clear hard coat film described in any one of claims 1 to 6 wherein a layer having at least fluorine-acryl copolymer resin is laminated on the hard coat layer. According to the invention described in claim 7, such advantage as inhibiting deterioration of film strength after durability test under ozone exposure condition are displayed.

The invention described in claim 8 is the clear hard coat film described in any one of claims 1 to 7 wherein the transparent film substrate is a cellulose ester film. According to the invention described in claim 8, such advantage that the clear hard coat film has small deformation property against thermal process and is excellent in flatness.

The invention described in claim 9 is the clear hard coat film described in any one of claims 1 to 8 characterized in that the transparent film substrate comprises at least one compound containing an acryloyl group represented by Formula (Z).

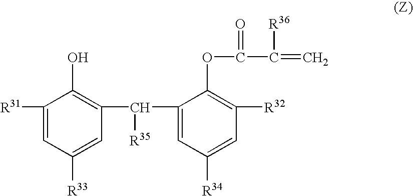

In the formula, R³¹ to R³⁵ are same or different each other and a hydrogen atom or an alkyl group having 1 to 10 carbon atoms, R³⁶ is a hydrogen atom or a methyl group.

According to the invention described in claim 9, such advantage as inhibiting deterioration of film strength after durability test under ozone exposure condition are displayed.

The invention described in claim 10 is an anti-reflection film characterized in that a layer of high refractive index is provided on the hard coat layer of the clear hard coat film described in any one of claims 1 to 9, and a layer of low refractive index is provided on the layer of high refractive index. According to the invention described in claim 10, such advantage as inhibiting deterioration of film strength after durability test under ozone exposure condition is displayed.

The invention described in claim 11 is a polarizing plate wherein the clear hard coat film described in any one of claims 1 to 9 is employed at one surface, and therefore, according to the invention of polarizing plate described in claim 11, such advantage as excellent visibility (easy view) installed in a display device is displayed.

The invention described in claim 12 is the polarizing plate described in claim 10 wherein the anti-reflection film is employed at one surface, and therefore, according to the invention of polarizing plate described in claim 12, such advantage as excellent visibility (easy view) installed in a display device is displayed.

The invention described in claim 13 is a display device characterized in that the polarizing plate described in claim 11 or 12 is employed, and therefore, according to the invention of display device described in claim 13, such advantage as excellent visibility (easy view) is displayed.

### PREFERABLE EMBODIMENT OF THE INVENTION

The embodiment of the present invention is described, but the present invention is not limited thereto.

The clear hard coat film of the present invention is characterized to comprise a fluorine-siloxane graft polymer and an energy actinic radiation curable resin, and according to the clear hard coat film of the present invention, such advantages as having excellent film strength after alkali saponification treatment and inhibiting deterioration of film strength after durability test under ozone exposure condition are displayed.

The fluorine-siloxane graft polymer is described, first. The fluorine-siloxane graft polymer is a copolymer obtained by that siloxane (including siloxane) and/or organo siloxane (organo including siloxane) is grafted to at least fluorine resin, as mentioned above. Practically, the following compounds are listed.

The fluorine-siloxane graft polymer includes, for example, (A) fluorine resin soluble in organic solvent having radically polymerizable unsaturated bond portion through urethane bond (which may be referred as radical polymerization fluorine resin (A), hereafter),

(B) a mono-terminal radical polymerization polysiloxane represented by following Formula (1) and/or a mono-terminal radical polymerization polysiloxane represented by following Formula (2), and
(C) a compound formed by graft copolymerization in which radical polymerization fluorine resin (A) is copolymerized under radical polymerization reaction condition with radical polymerizable monomer which does not react other than polymerization reaction by a double bond.

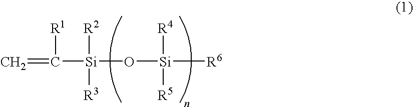

In the formula, R¹ is a hydrogen atom or a hydrocarbon group having 1 to 10 carbon atoms, for example, an alkyl group (a methyl, ethyl, propyl, butyl, pentyl and hexyl group), an aryl group such as a phenyl group), or a cycloalkyl group such as a cyclohexyl group). R¹ is preferably a hydrogen atom or a methyl group. R², R³, R⁴, R⁵ and R⁶, which may be same or different each other, and is a hydrogen atom or a hydrocarbon group having 1 to 10 carbon atoms, R², R³, R⁴ and R⁵ is preferably a methyl group, or a phenyl group independently. R⁶ is preferably a methyl group, butyl group, or a phenyl group. n is an integer of 2 or more, preferably an integer of 10 or more, and more preferably an integer of 30 or more.

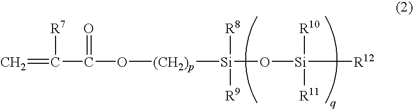

In the formula, R⁷ is a hydrogen atom or a hydrocarbon group having 1 to 10 carbon atoms, preferably a hydrogen atom or a methyl group. R⁸, R⁹, R¹⁰, R¹¹ and R¹², which may be same or different each other, is a hydrogen atom or a hydrocarbon group having 1 to 10 carbon atoms and R⁸, R⁹, R¹⁰ and R¹¹ is preferably a methyl group or a phenyl group, independently. R¹² is preferably a methyl group, a butyl group or a phenyl group. p is an integer of 0 to 10, preferably an integer of 10 or more, and more preferably an integer of 30 or more. q is an integer of 2 or more.

Next, (A) fluorine resin soluble in organic solvent having radically polymerizable unsaturated bond portion through urethane bond is described in detail.

The radical polymerization fluorine resin (A) can be obtained by reaction of a fluorine resin having a hydroxy group soluble in organic solvent (A-1) with radical polymerizable monomer having an isocyanate group (A-2).

The fluorine resin having a hydroxy group soluble in organic solvent (A-1) is not particularly limited, as far as it contains at least a hydroxy group containing monomer portion and polyfluoro paraffin portion as a composing component, and includes for example, those containing a recurring unit represented by following Formula (3) and those containing a recurring unit represented by following Formula (4).

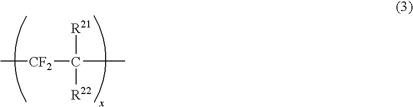

In the formula, R²¹ and R²² are, each independent in each recurring unit, and may be same or different, a hydrogen atom, a halogen atom such as a fluorine or chlorine atom), an alkyl group having 1 to 10 carbon atoms such as a methyl group, or an ethyl group), an aryl group having 6 to 8 carbon atoms such as a phenyl group), a halogen atom such as a fluorine or chlorine atom), an alkyl group having 1 to 10 carbon atoms and substituted with one or plural substituents such as a trifluoromethyl group, 2,2,2-trifluoroethyl group, or a trichloromethyl group), or a halogen atom such as a fluorine or chlorine atom), an aryl group having 6 to 8 carbon atoms and substituted with one or plural substituents, such as a pentafluorophenyl group), and, x is an integer of 2 or more.

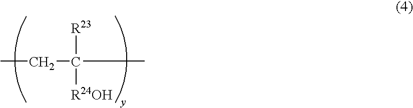

In the formula, R²³ are, each independent in each recurring unit, a hydrogen atom, a halogen atom (for example, a fluorine or chlorine atom), an alkyl group having 1 to 10 carbon atoms (for example, a methyl group, or ethyl group), an aryl group having 6 to 8 carbon atoms (for example, a phenyl group), an alkyl group having 1 to 10 carbon atoms substituted with one or plural halogen atom such as a fluorine or chlorine atom (for example, a trifluoromethyl group, 2,2,2-trifluoroethyl group or a trichloromethyl group) or an aryl group having 6 to 8 carbon atoms substituted with one or plural halogen atom such as a fluorine or chlorine atom (for example, a pentafluorophenyl group), R²⁴ is, each independent in each recurring unit, a two valent group selected from OR^{25a} group, CH₂OR^{25b} group and COOR^{25c} group, wherein R^{25a}, R^{25b} and R^{25c} are two valent group selected from an alkylene group having 1 to 10 carbon atoms (for example, a methylene, ethylene, trimethylene, tetramethylene and hexamethylene group), a cycloalkylene group having 6 to 10 carbon atoms (for example, a cyclohexylene group), an alkylidene group having 2 to 10 carbon atoms (for example, an isopropylidene group), and y is an integer of 2 or more.

The fluorine resin having a hydroxy group soluble in organic solvent (A-1) may contain a recurring unit represented by following Formula (5) as another composing component.

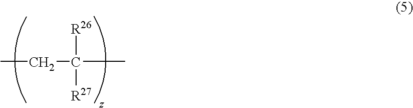

In the formula, R²⁶ is, independent in each recurring unit, a hydrogen atom, a halogen atom such as a fluorine or chlorine atom), an alkyl group having 1 to 10 carbon atoms such as a methyl group or ethyl group), an aryl group having 6 to 10 carbon atoms such as a phenyl group), a halogen atom such as a fluorine or chlorine atom), an alkyl group having 1 to 10 carbon atoms and substituted with one or plural substituents such as a trifluoromethyl group, 2,2,2-trifluoroethyl group, or a trichloromethyl group), or a halogen atom such as a fluorine or chlorine atom), an aryl group having 6 to 10 carbon atoms and substituted with one or plural substituents such as a pentafluorophenyl group), R²⁷ is, each independent in each recurring unit, OR^{28a} group or OCOR^{28b} group, R^{28a} and R^{28b} are a hydrogen atom, a halogen atom such as a fluorine or chlorine atom), an alkyl group having 1 to 10 carbon atoms such as a methyl group, or ethyl group) an aryl group having 6 to 10 carbon atoms such as a phenyl group), a cycloalkyl group having 6 to 10 carbon atoms such as a cyclohexyl group), a halogen atom such as a fluorine or chlorine atom), an alkyl group having 1 to 10 carbon atoms and substituted with one or plural substituents such as a trifluoromethyl group, 2,2,2-trifluoroethyl group, or a trichloromethyl group), or a halogen atom such as a fluorine or chlorine atom) and an aryl group having 6 to 10 carbon atoms and substituted with one or plural substituents such as a pentafluorophenyl group), z is an integer of 2 or more.

The fluorine resin having a hydroxy group soluble in organic solvent (A-1) improves solubility in an organic solvent by containing a recurring unit represented by Formula (5).

A hydroxyl value of the fluorine resin having a hydroxy group soluble in organic solvent (A-1) is preferably 5 to 250, more preferably 10 to 200, and further preferably 20 to 150. When the hydroxyl value is not more than 5, content ratio of the radical polymerizable monomer having an isocyanate group (A-2) becomes remarkably small and a reaction mixture has a tendency to be turbid. On the other hand when a hydroxyl value excesses 250, compatibility with a mono-terminal radical polymerization polysiloxane <component (B)> deteriorates and may not precede the graft copolymerization as mentioned later. The fluorine resin having a hydroxy group soluble in organic solvent (A-1) may contain a free carboxylic group.

The fluorine resin having a hydroxy group soluble in organic solvent (A-1) can be prepared by conventional methods, or can be obtained in a market. Marketed products include a vinylether fluorine resin (LUMIFLON LF-100, LF-200, LF-302, LF-400, LF-554, LF-600, LF-986N, manufactured by Asahi Glass Co., Ltd.), an allylether type fluorine resin (CEFRAL COAT PX-40, A606X, A202B, and CF-803; manufactured by Central Glass Co., Ltd.), vinyl carboxylate/acrylic acid ester type fluorine resin (ZAFLON FC-110, FC-220, FC-250, FC-275, FC-310, FC-575, XFC-973; manufactured by Toagosei Co., Ltd.), and vinylether/vinyl carboxylate type fluorine resin (FLUONATE; manufactured by Dainippon Ink And Chemicals, Inc.).

The fluorine resin having a hydroxy group soluble in organic solvent (A-1) may be used singly or two or more in combination.

Radical polymerizable monomer having an isocyanate group (A-2) is not particularly limited as far as the monomer contains an isocyanate group and radical polymerizable portion. It is preferable to employ a radical polymerizable monomer containing an isocyanate group but not another functional group such as a hydroxy group or a polysiloxane chain).

It is preferable that to use a radical polymerizable monomer represented by following Formula (6) or a radical polymerizable monomer represented by following Formula (7) represented by radical polymerizable monomer, for example, as the suitable radical polymerizable monomer having an isocyanate group (A-2).

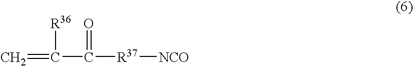

In the formula, R³⁶ is a hydrogen atom or a hydrocarbon group having 1 to 10 carbon atoms, for example, an alkyl group having 1 to 10 carbon atoms (such as a methyl group, an ethyl group, a propyl group, a butyl group, a pentyl group or a hexyl group), an aryl group having 6 to 10 carbon atoms (such as phenyl group), or a cycloalkyl group having 3 to 10 carbon atoms such as a cyclohexyl group, R³⁷ is an oxygen atom or a straight or branched two valent hydrocarbon group having 1 to 10 carbon atoms, for example, an alkylene group having 1 to 10 carbon atoms such as a methylene group, an ethylene group, a trimethylene group, or a tetramethylene group), an alkylidene group having 2 to 10 carbon atoms such as an isopropylidene group), or an arylene group having 6 to 10 carbon atoms such as a phenylene group, a tolylene group, or a xylene group), or a cycloalkylene group having 3 to 10 carbon atoms such as a cyclohexylene group).

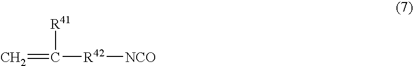

In the formula, R⁴¹ is a hydrogen atom or a hydrocarbon group having 1 to 10 carbon atoms, for example, an alkyl group having 1 to 10 carbon atoms such as a methyl group, an ethyl group, a propyl group, a butyl group, a pentyl group or a hexyl group), an aryl group having 6 to 10 carbon atoms such as a phenyl group), or a cycloalkyl group having 3 to 10 carbon atoms such as a cyclohexyl group, R⁴² is an oxygen atom or a straight or branched two valent hydrocarbon group having 1 to 10 carbon atoms, for example, an alkylene group having 1 to 10 carbon atoms such as a methylene group, an ethylene group, a trimethylene group or a tetramethylene group), an alkylidene group having 2 to 10 carbon atoms such as an isopropylidene group), or an arylene group having 6 to 10 carbon atoms such as a phenylene group, a tolylene group, or a xylene group), or a cycloalkylene group having 3 to 10 carbon atoms such as a cyclohexylene group.

The radical polymerizable monomer (A-2) includes, practically, a methacryloyl isocyanate, 2-isocyanate ethylmethacrylate, or m- or p-isopropenyl-α,α-dimethylbenzylisocyanate.

In a reaction to prepare the radical polymerization fluorine resin (A) from the fluorine resin having a hydroxy group soluble in organic solvent (A-1) and the radical polymerizable monomer having an isocyanate group (A-2), radical polymerizable monomer having an isocyanate group (A-2) is reacted in an amount of preferably not less than 0.001 mol and not more than 0.1 mol, and more preferably not less than 0.01 mol and not more than 0.08 mol, per equivalent of a hydroxy group of the fluorine resin having a hydroxy group soluble in organic solvent (A-1).

When an amount of the radical polymerizable monomer having an isocyanate group (A-2) is not more than 0.001 mol, it is not preferable since graft copolymerization is difficult, and the reaction mixture becomes turbid and separates into two layers with time. When an amount of the radical polymerizable monomer having an isocyanate group (A-2) is not less than 0.1 mol, it is not preferable since gelation is apt to occur during the graft copolymerization. The reaction of the fluorine resin having a hydroxy group soluble in organic solvent (A-1) with the radical polymerizable monomer having an isocyanate group (A-2) can be conducted at room temperature to 80° C. in the presence of absence of a catalyser.

The radical polymerization fluorine resin (A) thus obtained is used in an amount of 2 to 70 percent by weight, preferably 4 to 60 percent by weight of total amount of fluorine-siloxane graft polymer as used. When an amount of the radical polymerization fluorine resin (A) is not more than 2 percent by weight of total amount of fluorine-siloxane graft polymer as used, it is not preferable since stability during graft polymerization may be lowered, and when it exceeds 70 percent by weight, gelation may occurred during graft polymerization.

The mono-terminal radical polymerization polysiloxane (B) is described. Marketed examples of the mono-terminal radical polymerization polysiloxane (B) include, SILAPLANE FM-0711 (number average molecular weight 1,000, manufactured by Chisso Corporation), SILAPLANE FM-0721 (number average molecular weight 5,000, manufactured by Chisso Corporation Chisso Corporation), SILAPLANE FM-0725 (number average molecular weight 10,000, manufactured by Chisso Corporation), and X-22-174DX (number average molecular weight 4,600, manufactured by Shin-Etsu Chemical Co., Ltd.).

The mono-terminal radical polymerization polysiloxane (B) may be used by mixing with the aforementioned mono-terminal radical polymerization polysiloxane represented by the Formula (1) singly or two kinds or more, or the aforementioned mono-terminal radical polymerization polysiloxane represented by the Formula (2) singly or two kinds or more. Further it can be used by mixing with one kind or more of the aforementioned mono-terminal radical polymerization polysiloxane represented by the Formula (1) and one kind or more of the aforementioned mono-terminal radical polymerization polysiloxane represented by the Formula (2).

The mono-terminal radical polymerization polysiloxane (B) is used in an amount of 4 to 40 percent by weight, preferably 10 to 30 percent by weight with respect to a total amount of the fluorine-siloxane graft polymer. When the mono-terminal radical polymerization polysiloxane (B) is not more than 4 percent by weight with respect to a total amount of fluorine-siloxane graft polymer, lubrication may be insufficient, and when it exceeds 40 percent by weight, content of an unreacted monomer composition after polymerization increases to sometimes cause undesirable matter such as softening of the coated layer or bleed out of an unreacted monomer composition.

The radical polymerizable monomer (C), which does not react with the aforementioned radical polymerization fluorine resin (A) under radical polymerization reaction condition other than polymerization reaction by a double bond, is described

Examples of the radical polymerizable monomer (C), which does not react with the aforementioned radical polymerization fluorine resin (A) under radical polymerization reaction condition other than polymerization reaction by a double bond, include, a styrene type monomer such as styrene, p-methylstyrene, p-chloromethylstyrene, and vinyl toluene; a (meth)acrylate type monomer having a hydrocarbon group such as methyl(meth)acrylate, ethyl(meth)acrylate, n-propyl(meth)acrylate, i-propyl(meth)acrylate, n-butyl(meth)acrylate, i-butyl(meth)acrylate, tert-butyl(meth)acrylate, n-hexyl(meth)acrylate, cyclohexyl(meth)acrylate, 2-ethylhexyl(meth)acrylate, lauryl(meth)acrylate, stearyl(meth)acrylate, isobornyl(meth)acrylate, adamantyl(meth)acrylate, phenyl(meth)acrylate, and benzyl(meth)acrylate; a (meth)acrylate type monomer in which hydrogen atom of the (meth)acrylate type monomer is substituted by a fluorine atom, a chlorine atom, a bromine atom, and so on; a vinylester type monomer such as vinylacetate, vinylbenzoate, or vinylester of branched monocarboxylic acid (VeoVA; manufactured by Shell Chemicals Japan); acrylonitrile type monomer such as acrylonitrile, or methacrylonitrile; a vinylether type monomer such as ethyl vinylether, n-butyl vinylether, i-butyl vinylether, or cyclohexyl vinylether; an acrylamide type monomer such as (meth)acrylamide, dimethyl(meth)acrylamide, and diaceto acrylamide; a basic nitrogen containing vinyl type monomer such as vinylpyridine, N,N-dimethylaminoethyl(meth)acrylate, N,N-diethylaminoethyl(meth)acrylate, N,N-dimethyl(meth)acrylamide, 4-(N,N-dimethylamino)styrene and N-{2-(meth) acryloyloxyethyl}piperidine; a monomer of vinyl type compound containing epoxy group such as glycidyl(meth)acrylate, 3,4-epoxycyclohexylmethyl(meth)acrylate and 3,4-epoxyvinylcyclohexane; an acid vinyl compound type monomer such as (meth)acrylic acid, angelic acid, crotonic acid, maleic acid, 4-vinyl benzoic acid, p-vinyl benzenesulfonic acid, 2-(meth)acryloyloxyethane sulfonic acid and mono{2-(meth)acryloyloxyethyl}acid phosphate; a hydroxy group containing vinyl compound type monomer such as p-hydroxymethylstyrene, 2-hydroxyethy(meth)acrylate, 2-hydroxypropyl(meth)acrylate, 3-hydroxypropyl(meth)acrylate, 2-hydroxybutyl(meth)acrylate, 4-hydroxybutyl(meth)acrylate, di-2-hydroxyethylfumarate, polyethyleneglycol or polypropyleneglycol mono (meth)acrylate, or e-caprolactone adduct thereof, hydroxyalkylesters of α,β-ethylenic unsaturated carboxylic acid, (meth)acrylic acid, crotonic acid, maleic acid, s-caprolactone; adduct with α,β-ethylenic unsaturated carboxylic acid such as fumaric acid, itaconic acid or citraconic acid, or adduct of aforementioned α,β-ethylenic unsaturated carboxylic acid with an epoxy compound such as butyl glycidyl ether, phenyl glycidyl ether, branched monocarboxylic acid glycidyl ester and (CARDULA E, manufactured by Shell Chemicals Japan); a silane compound type monomer such as vinyl methoxysilane, γ-methacryloxy ethyltrimethoxysilane and γ-methacryloxy ethylmethyldimethoxysilane; an olefin type monomer such as ethylene and propylene; a halogenated olefin type monomer such as vinyl chloride, vinylidene chloride, vinyl bromide, vinyl fluoride, tetrafluoroethylene, and chlorotrifluoroethylene; maleimide; and vinyl sulfone.

The radical polymerizable monomer (C), which does not react with the aforementioned radical polymerization fluorine resin (A) under radical polymerization reaction condition other than polymerization reaction by a double bond may be used singly or mixing two kinds or more, (meth)acrylate type monomer is preferably used mainly in view of copolymerization.

The radical polymerizable monomer (C), which does not react with the aforementioned radical polymerization fluorine resin (A) under radical polymerization reaction condition other than polymerization reaction by a double bond is used in an amount of 15 to 94 percent by weight, preferably 30 to 70 percent by weight with respect to a total amount of fluorine-siloxane graft polymer. In case of not more than 15 percent by weight, it may be difficult to adjust glass transition temperature of the copolymer, and in case of exceeding 94 percent by weight, lubrication may becomes insufficient.

Ratio of amount of the radical polymerization fluorine resin (A) to sum of the amount of the mono-terminal radical polymerization polysiloxane (B) and radical polymerizable monomer (C), which does not react with the aforementioned radical polymerization fluorine resin (A) under radical polymerization reaction condition other than polymerization reaction by a double bond, that is, A/(B+C), which may be called “fluorine resin/acryl ratio”, is preferably 2/1 to 1/50. When the fluorine resin/acryl ratio A/(B+C) is not less than 2/1, glossiness may be lowered, and when the fluorine resin/acryl ratio is not more than 1/50, stability of blended polymer may be lowered.

Conventional polymerization methods are used in preparation of the fluorine-siloxane graft polymer by employing the radical polymerization fluorine resin (A), a mono-terminal radical polymerization polysiloxane (B) and the radical polymerizable monomer (C), which does not react with the aforementioned radical polymerization fluorine resin (A) under radical polymerization reaction condition other than polymerization reaction by a double bond. It is most simply and preferable to use a solution radical polymerization method or a non aqueous dispersion radical polymerization method in particular.

The another fluorine-siloxane graft polymer can be prepared by graft copolymerization of (A) a fluorine resin soluble in organic solvent having a radically polymerizable unsaturated bond portion through a urethane bond, (B) a mono-terminal radical polymerization polysiloxane represented by aforementioned Formula (1) and/or Formula (2), (D) a mono-terminal radical polymerization alkoxypolyalkylene glycol represented by following Formula (8), and (E) a radical polymerizable monomer other than component (A), (B) and (D).

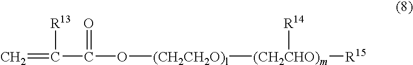

In the formula, R¹³ is a hydrogen atom or a hydrocarbon group having 1 to 10 carbon atoms, and preferably a hydrogen atom or a methyl group. R¹⁴ is a hydrocarbon group having 1 to 10 carbon atoms, and preferably a methyl group. R¹⁵ is a straight or branched hydrocarbon group having 1 to 10 carbon atoms which may be substituted by a halogen atom, and preferably an alkyl group such as a methyl, ethyl, propyl and butyl group, a phenyl group or an alkyl substituted phenyl group. “1” is an integer 1 or more, preferably 2 to 100. “m” is an arbitral integer, preferably 0 to 10, more preferably 0.

The radical polymerization fluorine resin (A) and, the mono-terminal radical polymerization polysiloxane (B) represented by the aforementioned Formula (1) and/or (2) are described above. The mono-terminal radical polymerization alkoxypolyalkyleneglycol (D) is described.

Known compounds may be also employed as the mono-terminal radical polymerization alkoxypolyalkyleneglycol (D), and the examples include practically, BLEMMER PME-100, PME-200, PME-400, PME-4000, 50POEP-800B (manufactured by NOF Corporation), LIGHT-ESTER MC, MTG, 130MA, 041MA (manufactured by KYOEISHA CHEMICAL Co., LTD), and LIGHT-ACRYLATE BO-A, EC-A, MTG-A, 130A (Manufactured by KYOEISHA CHEMICAL Co., LTD).

The mono-terminal radical polymerization alkoxypolyalkyleneglycol (D) can be used by mixing singly or two kinds or more. The mono-terminal radical polymerization alkoxypolyalkyleneglycol (D) is used in an amount of 1 to 25 percent by weight, preferably 1 to 15 percent by weight, with respect to a total amount of the fluorine-siloxane graft polymer.

When the mono-terminal radical polymerization alkoxypolyalkyleneglycol (D) is not more than 1 percent by weight with respect to a total amount of fluorine-siloxane graft polymer, or exceeds 25 percent by weight, anti-stain performance may become insufficient.

The radical polymerizable monomer (E) other than components (A), (B) and (D) is described. The radical polymerizable monomer (E) other than components (A), (B) and (D) includes for example, a styrene type monomer such as styrene, p-methylstyrene, p-chloromethylstyrene and vinyl toluene; a (meth)acrylate type monomer having a hydrocarbon group such as methyl(meth)acrylate, ethyl(meth)acrylate, n-propyl(meth)acrylate, i-propyl(meth)acrylate, n-butyl(meth)acrylate, i-butyl(meth)acrylate, tert-butyl(meth)acrylate, n-hexyl(meth)acrylate, cyclohexyl(meth)acrylate, 2-ethylhexyl(meth)acrylate, lauryl(meth)acrylate, stearyl(meth)acrylate, isobornyl(meth)acrylate, adamantyl(meth)acrylate, phenyl(meth)acrylate, and benzyl(meth)acrylate; the (meth)acrylate type monomer in which a hydrogen atom of (meth)acrylate type monomer is substituted by a fluorine atom, a chlorine atom or a bromine atom; a vinylester type monomer such as vinylacetate, vinylbenzoate, and a vinylester of branched monocarboxylic acid (VeoVA; manufactured by Shell Chemicals Japan); an acrylonitrile type monomer such as acrylonitrile and methacrylonitrile; a vinylether type monomer such as ethyl vinylether, n-butyl vinylether, i-butyl vinylether and cyclohexyl vinylether; an acrylamide type monomer such as (meth)acrylamide, dimethyl(meth)acrylamide and diaceto acrylamide; a basic nitrogen containing vinyl type monomer such as vinylpyridine, N,N-dimethylaminoethyl(meth)acrylate, N,N-diethylaminoethyl(meth)acrylate, N,N-dimethyl(meth)acrylamide, 4-(N,N-dimethylamino) styrene and N-{2-(meth)acryloyloxyethyl}piperidine; a monomer of vinyl type compound containing epoxy group such as glycidyl(meth)acrylate, 3,4-epoxycyclohexylmethyl(meth)acrylate and 3,4-epoxyvinylcyclohexane; an acid vinyl compound type monomer such as (meth)acrylic acid, angelic acid, crotonic acid, maleic acid, 4-vinyl benzoic acid, p-vinyl benzenesulfonic acid, 2-(meth)acryloyloxyethane sulfonic acid and mono{2-(meth)acryloyloxyethyl}acid phosphate; p-hydroxymethylstyrene, 2-hydroxyethy(meth)acrylate, 2-hydroxypropyl(meth)acrylate, 3-hydroxypropyl(meth)acrylate, 2-hydroxybutyl(meth)acrylate, 4-hydroxybutyl(meth)acrylate, di-2-hydroxyethylfumarate, polyethyleneglycol or polypropyleneglycol mono(meth)acrylate, or ε-caprolactone adduct thereof, an adduct of α,β-ethylenic unsaturated carboxylic acid with ε-caprolactone such as (meth)acrylic acid, crotonic acid, maleic acid, fumaric acid, itaconic acid or citraconic acid, hydroxyalkylesters of α,β-ethylene unsaturated carboxylic acid, or a hydroxy group containing vinyl compound type monomer such as an adduct of an epoxy compound of the aforementioned α,β-ethylenic unsaturated carboxylic acid with butylglycidyl ether, phenylglycidyl ether, branched carboxy acid glycidyl ester (CARDULA E, manufactured by Shell Chemical Japan); a silane compound type monomer such as vinyl methoxysilane, γ-methacryloxy ethyltrimethoxysilane and γ-methacryloxy ethylmethyldimethoxysilane; an olefin type monomer such as ethylene and propylene; halogenated olefin type monomer such as vinyl chloride, vinylidene chloride, vinyl bromide, vinyl fluoride, tetrafluoroethylene and chlorotrifluoroethylene; in addition thereto, maleimide and vinyl sulfone.

These monomers may be used singly or mixing two kinds or more, (meth)acrylate type is used preferably in view of mainly copolymerization performance.

An amount of the radical polymerizable monomer (E) other than components (A), (B) and (D) is 28 to 92 percent by weight, preferably 30 to 70 percent by weight with respect to a total amount of used fluorine-siloxane graft polymer.

When the amount of the radical polymerizable monomer (E) is not more than 28 percent by weight with respect to a total amount of used fluorine-siloxane graft polymer, it may be difficult to adjust glass transition temperature of the copolymer, and when exceeds 92 percent by weight, lubrication may becomes insufficient.

Ratio of used weight of the radical polymerization fluorine resin (A) to sum of total used weight of a mono-terminal radical polymerization polysiloxane (B), aforementioned single end alkoxypolyalkyleneglycol (D) and radical polymerizable monomer (E) other than components (A), (B) and (D), that is, A/(B+D+E), which may be referred as “fluorine resin/acryl ratio” hereafter, is preferably 2/1 to 1/50. When the fluorine resin/acryl ratio is not less than 2/1, glossiness may be lowered, and the fluorine resin/acryl ratio is not more than 1/50, stability performance may be lowered.

Conventional polymerization methods are used in preparation of the fluorine-siloxane graft polymer by employing the radical polymerization fluorine resin (A), the mono-terminal radical polymerization polysiloxane (B), aforementioned single end alkoxypolyalkyleneglycol (D) and the radical polymerizable monomer (E) other than components (A), (B) and (D). It is most simply and preferable to use a solution radical polymerization method or a non aqueous dispersion radical polymerization method in particular among them.

The fluorine-siloxane graft polymer can be prepared by a graft copolymer by co-polymerizing (A) fluorine resin soluble in organic solvent having a radically polymerizable unsaturated bond portion through a urethane bond, (B) a mono-terminal radical polymerization polysiloxane represented by the above mentioned Formula (1) and/or above mentioned Formula (2), (F) the radical polymerizable monomer having one radical polymerizable double bond and at least one fluoroalkyl group in a molecule, and (G) the radical polymerizable monomer other than the component (A), (B), (F).

The radical polymerization fluorine resin (A), a mono-terminal radical polymerization polysiloxane (B) represented by the aforementioned Formula (1) and/or (2) are the same as described above, and the radical polymerizable monomer having one radical polymerizable double bond and at least one fluoroalkyl group in a molecule (F) is described.

The radical polymerizable monomer having one radical polymerizable double bond and at least one fluoroalkyl group in a molecule (F) includes, for example, perfluorobutyl ethylene, perfluorohexyl ethylene, perfluorooctyl ethylene, perfluorodecyl ethylene, 1-methoxy (perfluoro-2-methyl-1-propene), 2,2,2-trifluoro ethyl(meth)acrylate, 2,2,3,3,3-pentafluoropropyl(meth)acrylate, 2-(perfluorobutyl)ethyl(meth)acrylate, 3-perfluorobutyl-2-hydroxypropyl(meth)acrylate, 2-(perfluorohexyl)ethyl(meth)acrylate, 3-perfluorohexyl-2-hydroxypropyl(meth)acrylate, 2-(perfluorooctyl)ethyl(meth)acrylate, 3-perfluorooctyl-2-hydroxypropyl(meth)acrylate, 2-(perfluorodecyl)ethyl(meth)acrylate, 3-perfluorodecyl-2-hydroxypropyl(meth)acrylate, 2-(perfluoro-3-methylbutyl)ethyl(meth)acrylate, 3-(perfluoro-3-methylbutyl)-2-hydroxypropyl(meth)acrylate, 2-(perfluoro-3-methylhexyl)ethyl(meth)acrylate, 2-(perfluoro-3-methyloctyl)ethyl(meth)acrylate, 2-(perfluoro-3-methyldecyl) and ethyl(meth)acrylate. Products in the market include, for example, ACRYESTER 3FE, 4FE, SFE, SFE, 17FE (manufactured by Mitsubishi Rayon Co., Ltd.), VISCOAT 3F, 3FM, 4F, 8F, 8FM (manufactured by Osaka Organic Chemical Industry Ltd.), LIGHT-ESTER M-3F, M-4F, M-6F, FM-108, LIGHT-ACRYLATE FA-108 (manufactured by KYOEISHA CHEMICAL Co., LTD.), M-1110, M-1210, M-1420, M-1620, M-1633, M-1820, M-1833, M-2020, M-3420, M-3433, M-3620, M-3633, M-3820, M-3833, M-4020, M-5210, M-5410, M-5610, M-5810, M-7210, M-7310, R-1110, R-1210, R-1420, R-1433, R-1620, R-1633, R-1820, R-1833, R-2020, R-3420, R-3433, R-3620, R-3633, R-3820, R-3833, R-4020, R-5210, R-5410, R-5610, R-5810, R-7210 and R-7310 (manufactured by Daikin Industries, Ltd.), and HFIP-M, HFIP-A, TFOL-M, TFOL-A, PFIP-A, HpIP-AE and HFIP-I (manufactured by Central Glass Co., Ltd.).

The radical polymerizable monomer having one radical polymerizable double bond and at least one fluoroalkyl group in a molecule (F) is used singly or mixing two kinds or more.

An amount of the radical polymerizable monomer having one radical polymerizable double bond and at least one fluoroalkyl group in a molecule (F) is 1 to 50 percent by weight, preferably 2 to 40 percent by weigh with respect to a total amount of used fluorine-siloxane graft polymer. In case of not more than 1 percent by weight, stability may be insufficient, and in case of exceeding 50 percent by weight cost of the copolymer is expensive and is not practical.

The radical polymerizable monomer (G) other than the component (A), (B) and (F) is described. The radical polymerizable monomer (G) other than the component (A), (B) and (F) includes, for example, a styrene type monomer such as styrene, p-methylstyrene, p-chloromethylstyrene, and vinyl toluene; a (meth)acrylate type monomer having a hydrocarbon group such as methyl(meth)acrylate, ethyl(meth)acrylate, n-propyl(meth)acrylate, i-propyl(meth)acrylate, n-butyl(meth)acrylate, i-butyl(meth)acrylate, tert-butyl(meth)acrylate, n-hexyl(meth)acrylate, cyclohexyl(meth)acrylate, 2-ethylhexyl(meth)acrylate, lauryl(meth)acrylate, stearyl(meth)acrylate, isobornyl(meth)acrylate, adamantyl(meth)acrylate, phenyl(meth)acrylate and benzyl(meth)acrylate; a vinylester type monomer such as vinylacetate, vinylbenzoate, or vinylester of branched monocarboxylic acid (VeoVA; manufactured by Shell. Chemicals Japan); acrylonitrile type monomer such as acrylonitrile and methacrylonitrile; a vinylether type monomer such as ethyl vinylether, n-butyl vinylether, i-butyl vinylether and cyclohexyl vinylether; an acrylamide type monomer such as (meth)acrylamide, dimethyl(meth)acrylamide and diacetoacrylamide; a basic nitrogen containing vinyl type monomer such as vinylpyridine, N,N-dimethylaminoethyl(meth)acrylate, N,N-diethylaminoethyl(meth)acrylate, N,N-dimethyl(meth)acrylamide, 4-(N,N-dimethylamino)styrene and N-{2-(meth)acryloyloxyethyl}piperidine; a monomer of vinyl type compound containing epoxy group such as glycidyl(meth)acrylate, 3,4-epoxycyclohexylmethyl(meth)acrylate and 3,4-epoxyvinylcyclohexane; an acid vinyl compound type monomer such as (meth)acrylic acid, angelic acid, crotonic acid, maleic acid, 4-vinyl benzoic acid, p-vinyl benzenesulfonic acid, 2-(meth)acryloyloxyethane sulfonic acid and mono{2-(meth)acryloyloxyethyl}acid phosphate; a hydroxy group containing vinyl compound type monomer such as p-hydroxymethylstyrene, 2-hydroxyethy(meth)acrylate, 2-hydroxypropyl(meth)acrylate, 3-hydroxypropyl(meth)acrylate, 2-hydroxybutyl(meth)acrylate, 4-hydroxybutyl(meth)acrylate, di-2-hydroxyethylfumarate, polyethyleneglycol or polypropyleneglycol mono(meth)acrylate, or ε-caprolactone adduct thereof, an adduct of α,β-ethylenic unsaturated carboxylic acid with ε-caprolactone (meth)acrylic acid, crotonic acid, maleic acid, fumaric acid, itaconic acid, or citraconic acid, aforementioned hydroxyalkylesters of α,β-ethylene unsaturated carboxylic acid, and an adduct of an epoxy compound with aforementioned α,β-ethylenic unsaturated carboxylic acid, and such as butylglycidyl ether, phenylglycidyl ether and branched carboxy acid glycidyl ester (CARDULA E; manufactured by Shell Chemicals Japan); a silane compound type monomer such as vinyl methoxysilane, γ-methacryloxy ethyltrimethoxysilane and γ-methacryloxy ethylmethyldimethoxysilane; an olefin type monomer such as ethylene and propylene; halogenated olefin type monomer such as vinyl chloride, vinylidene chloride, vinyl bromide, vinyl fluoride, tetrafluoroethylene, and chlorotrifluoroethylene; in addition thereto, maleimide and vinyl sulfone.

The radical polymerizable monomer (G) other than the component (A), (B) and (F) may be used singly or mixing two kinds or more, and (meth)acrylate type is used preferably in view of mainly copolymerization performance and anti-yellowing property.

An amount of the component (G) is 4 to 93 percent by weight, preferably 20 to 80 percent by weight with respect to a total amount of used fluorine-siloxane graft polymer. In case of not more than 4 percent by weight, it may be difficult to adjust glass transition temperature of the copolymer, and in case of exceeding 93 percent by weight, anti-stain performance becomes insufficient.

Ratio of used weight of component (A) to sum of total used weight of component (B), component (F) and component (G), that is, A/(B+F+G), which may be referred as “fluorine resin/acryl ratio” hereafter, is preferably 2/1 to 1/50. When the fluorine resin/acryl ratio is more than 2/1, glossiness may be lowered, and the fluorine resin/acryl ratio is not more than 1/50, repellency to water and oil performance may be lowered.

Conventional polymerization methods are used in preparation of the fluorine-siloxane graft polymer employing the components (A), (B), (F) and (G). It is most simply and recommendable to use a solution radical polymerization method or a non aqueous dispersion radical polymerization method among them.

Solvents used in the above mentioned polymerization include, for example, aromatic hydrocarbon type compound such as toluene, xylene, or mixture of aromatic hydrocarbon compound (SOLVESSO 100, manufactured by Esso petroleum); an aliphatic and alicyclic type compound such as n-hexane, cyclohexane, octane, mineral spirit, or kerosene; an ester type compound such as ethyl acetate, n-butylacetate, i-butylacetate and hydrocarbon butyl cellosolve acetate; an alcoholic type compound such as methanol, ethanol, n-propanol, i-propanol, n-butanol, i-butanol, ethyleneglycol, propylene glycol, ethyl cellosolve and butyl cellosolve. These solvents may be used singly or in mixture of two kinds or more.

Polymerization may be conducted by a conventional method employing various radical polymerization initiator, for example, azo type compound or peroxide compound radical polymerization initiator. Time for polymerization is not limited, and usually selected 1 to 48 hours. Temperature of polymerization is usually 30 to 120° C., preferably 60 to 100° C. The polymerization may be conducted, if necessary, employing a conventional chain transfer agent, for example, butyl mercaptan, dodecyl mercaptan, and α-methylstyrene dimer. Molecular weight of the graft polymer is not particularly limited, and the weight average molecular weight by polystyrene converted GPC (gel permeation chromatography) is preferably about 5,000 to 2,000,000, more preferably about 10,000 to 1,000,000). When the weight average molecular weight of the raft polymer is not more than 5,000, there may be lowering of film forming performance, and when it exceeds 2,000,000, there may be fear to occur gelation during polymerization.

The fluorine-siloxane graft polymer on the market includes ZX-022H, ZX-007C, ZX-049 and ZX-047-D, manufactured by FUJI KASEI KOGYO CO., LTD. These compounds may be used in mixture.

The actinic energy curable resin, feature of the present invention, is described.

The actinic energy curable resin is a resin cured via crosslinking reaction and so on, with exposure to an actinic ray such as UV ray and an electron beam. As the actinic energy curable resin, components containing a monomer having an ethylenical unsaturated double bond are employed preferably, which forms an actinic energy curable resin layer via curing by exposing to an actinic ray such as UV ray and an electron beam. Examples of the actinic energy curable resin include representatively a UV ray curable resin or an electron beam curable resin, and UV ray curable resin is preferable in view of the effects of the present invention.

A UV ray curable urethane acrylate type resin, a UV ray curable polyester acrylate type resin, a UV ray curable epoxy acrylate type resin, a UV ray curable polyol acrylate type resin and a UV ray curable resin epoxy resin are, for example, preferably employed as the UV ray curable resin includes. A UV ray curable resin acrylate type resin is preferable among them.

The UV ray curable acrylurethane type resin can be easily obtained by, in general, reacting a reaction product of polyester polyol with an isocyanate monomer or prepolymer 2-hydroxy-ethylacrylate, with an acrylate type monomer having a hydroxy group such as 2-hydroxy-ethylmethacrylate (the term represented by “acrylate” includes methacrylate) and 2-hydroxy-propylacrylate. For example, those described in JP-A-S59-151110 can be used. For example, a mixture of 100 parts of UNIDIC 17-806 (manufactured by Dainippon Ink And Chemicals, Inc.) and 1 part of Coronate L (manufactured by Nippon Polyurethane Industry Co., Ltd.) is preferably employed.

The UV ray curable polyesteracrylate resins include those prepared easily by reacting a polyesterpolyol with 2-hydroxyethylacrylate or 2-hydroxypropylacrylate, disclosed for example, in JP-A S59-151112.

Examples of the UV ray curable epoxyacrylate resin include those prepared by reacting an epoxyacrylate oligomer in the presence of a reactive diluting agent and a photoinitiator, disclosed for example, in JP-A H01-105738.

Examples of the UV ray curable polyol acrylate resin include trimethylolpropane triacrylate, ditrimethylolpropane tetraacrylate, pentaerythritol triacrylate, pentaerythritol tetraacrylate, dipentaerythritol hexaacrylate or alkyl-modified dipentaerythritol pentaacrylate.

The photoinitiators for the UV ray curable resins include benzoin or its derivative, or acetophenones, benzophenones, hydroxy benzophenones, Michler's ketone, α-amyloxime esters, thioxanthones or their derivatives. These photoinitiators may be used together with a photo-sensitizer. The above photoinitiators also work as a photo-sensitizer. Sensitizers such as n-butylamine, triethylamine and tri-n-butylphosphine can be used in photo-reaction of epoxyacrylates. The content of the photoinitiators or sensitizers in the UV ray curable resin layer is 0.1 to 15 parts by weight, and preferably 1 to 10 parts by weight, based on the 100 parts by weight of the UV ray curable resin layer.

The polymerizable monomers having one unsaturated double bond in the molecule include general monomers such as methyl acrylate, ethyl acrylate, butyl acrylate, benzyl acrylate, cyclohexyl acrylate, vinyl acetate, and styrene. The polymerizable monomers having two or more unsaturated double bonds in the molecule include ethylene glycol diacrylate, propylene glycol diacrylate, divinylbenzene, 1,4-cyclohexane diacrylate, 1,4-cyclohexyldimethyl diacrylate, trimethylol propane triacrylate, and pentaerythritol tetraacrylate. The UV curable resins can be employed by selecting from those available on the market including ADEKAOPTOMER KR or BY Series such as KR-400, KR-410, KR-550, KR-566, KR-567 and BY-320B (manufactured by Asahi Denka Co., Ltd.); KOEIHARD A-101-KK, A-101-WS, C-302, C-401-N, C-501, M-101, M-102, T-102, D-102, NS-101, FT-102Q8, MAG-1-P20, AG-106 and M-101-C (manufactured by Koei Chemical Co., Ltd.); SEIKABEAM PHC2210(S), PHC X-9(K-3), PHC2213, DP-10, DP-20, DP-30, P1000, P1100, P1200, P1300, P1400, P1500, P1600 and SCR900 (manufactured by Dainichiseika Color & Chemicals Mfg. Co., Ltd.); KRM7033, KRM7039, KRM7130, KRM7131, UVECRYL 29201 and UVECRYL 29202 (manufactured by Daicel U. C. B. Co., Ltd.); RC-5015, RC-5016, RC-5020, RC-5031, RC-5100, RC-5102, RC-5120, RC-5122, RC-5152, RC-5171, RC-5180 and RC-5181 (manufactured by Dainippon Ink & Chemicals, Inc.); OLEX No. 340 CLEAR (manufactured by Chugoku Marine Paints, Ltd.); SANRAD H-601, RC-750, RC-700, RC-600, RC-500, RC-611 and RC-612 (manufactured by Sanyo Chemical Industries, Ltd.); SP-1509 and SP-1507 (manufactured by Showa Highpolymer Co., Ltd.); RCC-15C (manufactured by Grace Japan Co., Ltd.) and ARONIX M-6100, M-8030 and M-8060 (manufactured by Toagosei Co., Ltd.), and NK HARD B-420, NK ESTER A-DOG and NK ESTER A-IBD-2E (manufactured by Shin-Nakamura Chemical Co., Ltd.). Practical examples of the compounds include trimethylol propane triacrylate, di-trimethylol propane tetraacrylate, pentaerythritol triacrylate, pentaerythritol tetraacrylate, dipentaerythritol hexaacrylate, dioxane glycolacrylate, ethoxylated acrylate, alkyl-modified dipentaerythritol pentaacrylate and so on.

It is preferable that the hard coat layer contains a fluorine-acryl copolymer resin in view of effects of the present invention. The fluorine-acryl copolymer resin is described.

It is preferable that the hard coat layer contains a fluorine-acryl copolymer resin in view of effects of the present invention. The fluorine-acryl copolymer resin is described.

The fluorine-acryl copolymer resin is a copolymer resin composed of a fluorine monomer an acrylic monomer, and a block copolymer composed of a fluorine monomer segment and an acrylic monomer segment is preferable in particular.

The fluorine monomer is described first. A known monomer containing fluorine can be used as the fluorine monomer, and its practical examples are monomers having structure represented by following Formula (H) to (N).

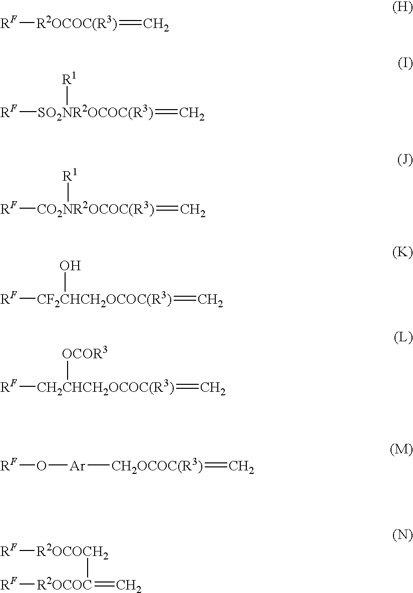

In the Formulas (H) to (N) R^{F} is a polyfluoro alkyl group or polyfluoro alkenyl group having 3 to 21 carbon atoms, preferably a polyfluoro alkyl group or polyfluoro alkenyl group having 6 to 12 carbon atoms. When it has not more than 2 carbon atoms, performance by fluorine is difficult to display, and when not less than 22 carbon atoms, it has a tendency that degree of conversion lowers because of long chain.

R¹ is a hydrogen atom or an alkyl group having 1 to 10 carbon atoms, preferably having 1 to 40 carbon atoms an alkyl group. When the number of carbon atoms exceeds 10, it has a tendency that degree of conversion lowers because of long chain. R² is an alkylene group having 1 to 10 carbon atoms, preferably an alkylene group having 1 to 40 carbon atoms. When the number of carbon atoms exceeds 10, it has a tendency that degree of conversion lowers because of long chain.

R³ is a hydrogen atom or a methyl group.

Ar is an aryl group or an aryl group having a substituent such as an alkyl group having 1 to 10 carbon atoms, an ester group, a ketone group, an amino group, an amido group, an imido group, a nitro group, a hydroxyl group, a carbonic acid group, a thiol group and an ether group.

Practical examples of the aforementioned Formula (H) include monomers of the following formulas (H-1) to (H-14).

F(CF₂)₆(CH₂)₂OCOCH═CH₂ (H-1)

F(CF₂)₈(CH₂)₂OCOCH═CH₂ (H-2)

F(CF₂)₁₀(CH₂)₂OCOCH═CH₂ (H-3)

F(CF₂)₁₂—(CH₂)₂OCOCH═CH₂ (H-4)

H(CF₂)₈CH₂OCOCH═CH₂ (H-5)

(CF₃)₂CF(CF₂)₆(CH₂)₂OCOCH═CH₂ (H-6)

(CF₃)₂CF(CF₂)(CH₂)₂OCOCH═CH₂ (H-7)

F(CF₂)₆(CH₂)₂OCOC(CH₃)═CH₂ (H-8)

F(CF₂)₈(CH₂)₂OCOC(CH₃)═CH₂ (H-9)

F(CF₂)₁₀(CH₂)₂OCOC(CH₃)═CH₂ (H-10)

F(CF₂)₁₂(CH₂)₂OCOC(CH₃)=CH₂ (H-11)

H(CF₂)₈CH₂OCOC(CH₃)═CH₂ (H-12)

(CF₃)₂CF(CF₂)₆(CH₂)₂OCOC(CH₃)═CH₂ (H-13)

(CF₃)₂CF(CF₂)₈(CH₂)₂OCOC(CH₃)═CH₂ (H-14)

Practical examples of the aforementioned Formula (I) include monomers of the following formulas (I-1) to (I-7).

F(CF₂)₈SO₂N(CH₃)CH₂CH₂OCOCH═CH₂ (I-1)

F(CF₂)₈SO₂N(CH₃)(CH₂)₄OCOCH═CH₂ (I-2)

F(CF₂)₈SO₂N(CH₃)(CH₂)₁₀OCOCH═CH₂ (I-3)

F(CF₂)₈SO₂N(C₂/H₅)C(C₂H₆)HCH₂OCOCH═CH₂(I-4)

F(CF₂)₈SO₂N(CH₃)CH₂CH₂OCOC(CH₃)═CH₂ (I-5)

F(CF₂)₈SO₂N(C₂H₆)CH₂CH₂OCOC(CH₃)═CH₂ (I-6)

F(CF₂)₈SO₂N(C₃H₇)CH₂CH₂OCOC(CH₃)═CH₂ (I-7)

Practical examples of the aforementioned Formula (J) include monomers of the following formulas (J-1) to (J-4).

F(CF₂)₈CON(C₂H₆)CH₂OCOCH═CH₂(J-1)

F(CF₂)₈CON(CH₃)CH(CH₃)CH₂OCOCH═CH₂ (J-2)

F(CF₂)₈CON(CH₂CH₂CH₃)CH₂CH₂OCOC(CH₃)═CH₂ (J-3)

F(CF₂)₈CON(C₂H₈)CH₂OCOC(CH₃)═CH₂ (J-4)

Practical examples of the aforementioned Formula (K) include monomers of the following formulas (K-1) to (K-4).

F(CF₂)₈CH₂CH(OH)CH₂OCOCH═CH₂ (K-1)

(CF₃)₆CF(CF₂)₂CH₂CH(OH)CH₂OCOCH═CH₂ (K-2)

F(CF₂)₈CH₂CH(OH)CH₂OCOC(CH₃)═CH₂ (K-3)

(CF₃)₂CF(CF₂)₆CH₂CH(OH)CH₂OCOC(CH₃)═CH₂ (K-4)

Practical examples of the aforementioned Formula (L) include monomers of the following formulas (L-1) and (L-2).

(CF₃)₂CF(CH₂)₆CH₂CH(OCOCH₃)CH₂OCOCH═CH₂ (L-1)

(CF₃)₂CF(CH₂)₆CH₂CH(OCOCH₃)CH₂OCOC(CH₃)═CH₂ (L-2)

Practical examples of the aforementioned Formula (M) include monomers of the following formulas (M−1) to (M-4).

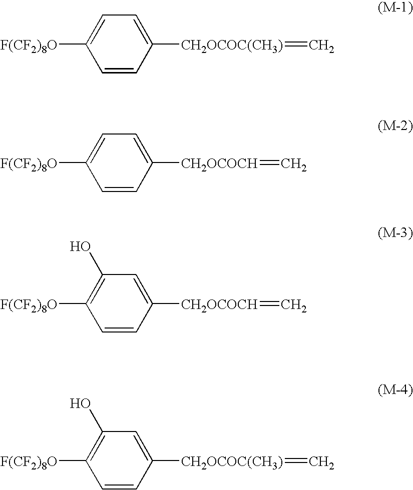

Practical examples of the aforementioned Formula (N) include monomers represented by the following formula (N-1).

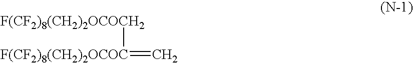

Practical examples of the fluorine monomers other than the Formulas (H) to (N) include the following monomers.

F(CF₂)₆CH₂OCH═CH₂

F(CF₂)₈CH₂OCH═CH₂

F(CF₂)₁₀CH₂OCH═CH₂

F(CF₂)₆CH₂OCF═CF₂

F(CF₂)₈CH₂OCF═CF₂

F(CF₂)₁₀CH₂OCF═CF₂

F(CF₂)₆CH═CH₂

F(CF₂)₈CH═CH₂

F(CF₂)₁₀CH═CH₂

F(CF₂)₆CF═CF₂

F(CF₂)₈CF═CF₂

F(CF₂)₁₀CF═CF₂

CH₂═CF₂

CF₂═CF₂

The fluorine monomer can be used solely or mixing two more kinds. Monomers of Formula (H), Formula (I) and Formula (N) are effective in view of displaying performance of fluorine.

Compound described by aforementioned Formulas (H-1), (H-2), (H-3), (H-4), (H-6), (H-7), (H-8), (H-9), (H-10), (H-11), (H-13), (H-14), and (N-1) are particularly effective among them.

The acrylic monomer is described.

The acrylic monomer is preferably a higher alkyl (meth)acrylic acid which has an alkyl group of 12 to 20 carbon atoms. Practically, listed are, for example, dodecyl(meth)acrylic acid, tridecyl (meth)acrylic acid, tetradecyl(meth)acrylic acid, pentadecyl(meth)acrylic acid, hexadecyl(meth)acrylic acid, octadecyl(meth)acrylic acid and behenyl(meth)acrylic acid.

More preferably hexadecyl(meth)acrylic acid, octadecyl(meth)acrylic acid and behenyl(meth)acrylic acid are listed among them. The fluorine-acryl copolymer resin is used preferably in an amount of not less than 0.05 parts by weight, and not more than 10 parts by weight more preferably not less than 0.1 parts by weight, and 10 parts by weight, with respect to the energy actinic radiation curable resin when it is used in the energy actinic radiation curable resin. The effects of the present invention are displayed markedly with the amount mentioned above.

Molecular weight of the fluorine-acryl copolymer resin is preferably 5000 to 1,000,000, more preferably 10,000 to 300,000, and further preferably 10,000 to 100,000 in terms of number average molecular weight. In case of not more than 5000, effects of the present invention are not displayed sufficiently, and in case exceeding 1,000,000 it has a tendency that the production becomes difficult.

The fluorine-acryl copolymer resin can be manufactured by a conventional preparation process employing polymeric peroxide as a polymerization initiator, disclosed in such as JP-B H5-41668, JP-B H5-59942.

The polymeric peroxide is a compound having two or more peroxy bonds in a molecule. On or more kinds of various polymeric peroxides described in JP-B H5-59942 can be used.

The fluorine-acryl copolymer resins in the market include those having trade name of MODIPER F-200, MODIPER F-600, and MODIPER F-2020 from NOF Corporation.

It is preferable that the hard coat layer contains organic microparticles and/or inorganic microparticles in view of effects of the present invention.

The organic and inorganic microparticles are described.

Particle diameter of the organic and inorganic microparticles is not limited, and an average particle diameter is preferably not more than 0.5 μm, more preferably not more than 0.1 μm, and preferably 0.1 μm to 0.001 μm in particular, in view of showing no anti-glare performance described below and easy to display effects of the present invention. The average particle diameter can be measured by, for example, a laser diffraction type particle size distribution measuring apparatus.

The organic microparticles are described practically. The organic microparticles include microparticles of polymethylmethacrylates, polystyrenes, polymer of melamines, benzoguanamines or polyurethanes.

Polystyrene type microparticles include, for example, SX-130H, SX-200H and SX-350H, manufactured by Soken Chemical & Engineering Co., Ltd.), SBX series (SBX-6 and SBX-8) manufactured by Sekisui Plastics Co., Ltd., from the market.

The melamine polymer type microparticles include, for example, benzoguanamine-melamine-formaldehyde condensation product (trade names of EPOSTAR GRADE M30 and EPOSTARGP GRADE H40 to H110, manufactured by Nippon Shokubai Co., Ltd), melamine-formaldehyde condensation product (trade names of EPOSTAR GRADE S12, S6, S, and SC4). Further core-shell type sphere composite hardened melamine resin particles, in which the core is composed of melamine type resin and shell is filled with silica, is mentioned. Practically it is manufactured by a method described in JP-A 2006-171033, and includes product in the market such as melamine resin-silica composite particles (Trade name of OPTOBEADS, manufactured by Nissan Chemical Industries, Ltd.).

The polymethylmethacrylate type microparticles include products in the market, for example, MX150 and MX300, manufactured by Soken Chemical & Engineering Co., Ltd.; EPOSTAR MA GRADE MA1002, MA1004, MA1006, MA1010, EPOSTARMX (Emulsion), GRADE MX020 W, MX030 W, MX050 W and MX100 W), manufactured by Nippon Shokubai Co., Ltd; MBX series (MBX-8 and MBX12), manufactured by Sekisui Plastics Co., Ltd., and MG-151, MG-152, S-1200 and S-1500, manufactured by s Nippon Paint Co., Ltd.

Organic microparticles in which acryl and styrene are crosslinked are mentioned, practical examples thereof include, for example, FS-102, FS-401, FS-201, and MG-351 manufactured by Nippon Paint Co., Ltd.

The Benzoguanamine type microparticles include, for example, benzoguanamine-formaldehyde condensation product (trade name of EPOSTAR GRADE L15, M05, MS and SC25), manufactured by Nippon Shokubai Co., Ltd.

The polyurethane type microparticles include, for example, DINAMICBEADS manufactured by Dainichiseika Color & Chemicals Mfg. Co., Ltd., and ethylene-methylmethacrylate copolymer.

In addition thereto, fluorine containing acryl resin microparticles may be incorporated. The fluorine containing acryl resin microparticles include, for example, microparticles composed of monomer or polymer of fluorine containing acrylate or methacrylate. Practical examples of the fluorine containing acrylate or methacrylate includes 1H,1H,3H-tetrafluoropropyl(meth)acrylate, 1H,1H,5H-octafluoropentyl(meth)acrylate, 1H,1H,7H-dodecafluoroheptyl(meth)acrylate, 1H,1H,9H-hexadecafluorononyl(meth)acrylate, 2,2,2-trifluoroethyl(meth)acrylate, 2,2,3,3,3-pentafluoropropyl(meth)acrylate, 2-(perfluorobutyl)ethyl(meth)acrylate, 2-(perfluorohexyl)ethyl(meth)acrylate, 2-(perfluorooctyl)ethyl(meth)acrylate, 2-perfluorodecyl ethyl(meth)acrylate, 3-perfluorobutyl-2-hydroxypropyl(meth)acrylate, 3-perfluorohexyl-2-hydroxypropyl(meth)acrylate, 3-perfluorooctyl-2-hydroxypropyl(meth)acrylate, 2-(perfluoro-3-methylbutyl)ethyl(meth)acrylate, 2-(perfluoro-5-methylhexyl)ethyl(meth)acrylate, 2-(perfluoro-7-methyloctyl)ethyl(meth)acrylate, 3-(perfluoro-3-methylbutyl-2-hydroxypropyl(meth)acrylate, 3-(perfluoro-5-methylhexyl)-2-hydroxypropyl(meth)acrylate, 3-(perfluoro-7-methyloctyl)-2-hydroxypropyl(meth)acrylate, 1H-1-(trifluoromethyl)trifluoro ethyl(meth)acrylate, 1H,1H,3H-hexafluoro butyl (meth)acrylate, trifluoroethylmethacrylate, tetrafluoropropylmethacrylate, perfluorooctylethylacrylate and 2-(perfluorobutyl)ethyl-α-fluoroacrylate. Microparticles composed of 2-(perfluorobutyl)ethyl-α-fluoroacrylate, fluorine containing polymethylmethacrylate microparticles, and microparticles obtained by copolymerization of fluorine containing methacrylic acid with vinyl monomer in the presence of a linking agent are preferable among the fluorine containing acryl resin microparticles, and more preferable is fluorine containing polymethylmethacrylate microparticles.

The vinyl monomers capable of copolymerization with fluorine containing(meth)acrylic acid those having a vinyl group, and practically include alkylmethacrylate such as methylmethacrylate, and butylmethacrylate; alkylacrylate such as methylacrylate and ethyl acrylate; and styrenes such as α-methylstyrene such as styrene. These may be used singly or in mixture. Crosslinking agent used in polymerization reaction is not particularly limited, and it is preferable to use those having two or more unsaturated groups, for example, two functional dimethacrylate such as ethyleneglycol dimethacrylate, polyethyleneglycol dimethacrylate, trimethylol propane trimethacrylate and divinyl benzene.

Polymerization reaction to prepare fluorine containing polymethylmethacrylate microparticles may be both of random copolymerization or block copolymerization. A method described in, for example, JP-A 2000-169658 may be listed practically. Available products in the market include, for example, FS-701, manufactured by Nippon Paint Co., Ltd., MF-0043, manufactured by Negami Chemical industrial Co., ltd. The fluorine containing acryl resin microparticles are used singly or two or more in combination.

The inorganic microparticles include Al₂O₃, B₂O₃, TiO₂, ZrO₂, SnO₂, CeO₂, P₂O₃, Sb₂O₃, MoO₃, ZnO₂, WO₃, MgF₂ and silica, and silica microparticles is preferable, in view of easy to display the effects of the present invention among them.

The silica microparticles include products in the market, for example, Aerosil 200, 200V and 300, manufactured by Nippon Aerosil, Aerosil OX50 and TT600, manufactured by Degussa AG and SILYSIA 350 manufactured by Fuji Silysia Chemical Ltd.

Colloidal silica is preferable among silica microparticles. Colloidal silica is a dispersion of silicon dioxide in water or organic solvent as colloidal state, and has shapes of sphere, needle or necklace, but not particularly limited. Average particle diameter of the colloidal silica is preferably 5 to 300 nm. Particle diameter of the colloidal silica is preferably monodispersion having coefficient of variation of 1 to 40%. Average particle diameter can be measured via electron microscope picture by such as a scanning electron microscope (SEM). It can be measured via particle size distribution meter and so on employing dynamic light-scattering method or static light-scattering method.

The colloidal silica is obtained from the market, for example, SNOWTEX series by Nissan Chemical Industries, Ltd., CATALOID-S series by JGC Catalysts and Chemicals Ltd. and LEVASIL series by Bayer.

Further, necklace shaped colloidal silica is preferably employed. It is formed by linking colloidal silica cationic modified by alumina sol or aluminum hydroxide, or primary particles of silica via bonding between particles with two or more valent metal ion connecting in necklace shape.

The necklace shaped colloidal silica includes SNOWTEX AK series, SNOWTEX PS series and SNOWTEX UP series by Nissan Chemical Industries, Ltd., practically, for example, IPS-ST-L (isopropanol silica sol, particle diameter of 40 to 50 nm, silica concentration of 30%) and MEK-ST-MS (methyl ethyl ketone silica sol, particle diameter of 17 to 23 nm, silica concentration of 35%), MEK-ST (methyl ethyl ketone silica sol, particle diameter of 10 to 15 nm, silica concentration of 30%), MEK-ST-L (methyl ethyl ketone silica sol, particle diameter of 40 to 50 nm, silica concentration of 30%), MEK-ST-UP (methyl ethyl ketone silica sol, particle diameter of 9 to 15 nm (chain structure), silica concentration of 20%) are mentioned.

MgF₂ includes, for example, MFS-10P (isopropyl alcohol sol, particle diameter of 100 nm) and NF-10P manufactured by Nissan Chemical Industries, Ltd.

It is preferable that solid component concentration is made low to lower viscosity of coating composition in view of leveling performance or handling easiness during high speed coating. content of the above mentioned organic and inorganic microparticles is preferably 0.01 to 500 parts by weight, more preferably 0.1 to 100 parts by weight, and preferably in particular 1 to 30 parts by weight based on 100 parts by weight of the above mentioned actinic energy curable resin since stability and good dispersion property of coating composition can be obtained in such state.

In addition thereto, hard coat layer may be incorporated with a UV ray curable resin composition such as silicone type resin powder, polystyrene type resin powder, polycarbonate resin powder, polyolefin type resin powder, polyester based resin powder, polyamide type resin powder, polyimide type resin powder, and polyfluorinated ethylene type resin powder. Further microparticles described in JP-A-2000-241807 may be incorporated if necessary.

The hard coat layer is formed by applying the coating composition for forming the hard coat layer employing conventional coating method such as a gravure coater, a dip coater, a reverse coater, a wire bar coater, a die coater and an inkjet method, after coating, drying by heat and subjected to UV curing process. Coating amount is suitably 0.1 to 40 μm, preferably, 0.5 to 30 μm in terms of wet thickness. Dry thickness is 0.1 to 30 μm, preferably 1 to 20 μm in average.

Light sources to cure layers of UV curable-resin by photo-curing reaction are not specifically limited, and any light source may be used as far as DV ray is generated. For example, a low-pressure mercury lamp, a medium-pressure mercury lamp, a high-pressure mercury lamp, an ultrahigh-pressure mercury lamp, a carbon arc lamp, a metal halide lamp and a xenon lamp may be utilized. The preferable irradiation quantity of light may vary depending on the type of lamps, however, it is preferably from 5 to 500 mJ/cm², and more preferably from 5 to 150 mJ/cm². Irradiation of an actinic ray is preferably carried out under tension in the longitudinal direction of the film and more preferably under tension in both the lateral and the longitudinal directions. The preferable tension is from 30 to 300 N/m. The method to apply tension to the film is not specifically limited and tension may be applied while the film is transported with back rolls or may be applied in a tenter in the lateral direction or in the biaxial directions of the film, whereby a cellulose ester film exhibiting a superior flatness can be obtained.

An organic solvent used for a coating solution of the UV curable-resin can be selected from, for example, hydrocarbons (toluene and xylene), alcohols (methanol, ethanol, isopropanol, butanol and cyclohexanol), ketones (acetone, methylethyl ketone and methylisobutyl ketone), esters (methyl acetate, ethyl acetate and methyl lactate), glycol ethers and other organic solvents. These organic solvents may be also used in combination.

The above mentioned organic solvents preferably contain propylene glycol monoalkylether (the alkyl having 1 to 4 carbon atoms) or propyleneglycol monoalkyletheracetate (the alkyl having 1 to 4 carbon atoms) in an amount of 5 percent by weight or more, and more preferably from 5 to 80 percent by weight.

The clear hard coat film of the present invention is clear type which does not have anti-glare performance. Anti-glare performance is make reflected image on the surface not annoying during watching images on an image display device such as a liquid crystal display, an organic EL display and a plasma display by shading the contour of reflected image on the surface to lower the visibility reflected image, practically, above mentioned property can be obtained by roughening the surface.

The hard coat layer of the clear hard coat film of the present invention has a mean center-line roughness (Ra) prescribed by JIS B 0601 of 0.05 μm or less. The mean center line roughness (Ra) is measured by means of a non-contact surface micro morphology meter, for example, manufactured by WYKO Corporation.

It is also preferable to incorporate silicon surfactant or polyoxyether compound described in the item of layer of low refractive index in the hard coat layer. These improve coating performance. The component is employed preferably in amount of 0.01 to 3 by weight with respect to solid component.

Examples of the polyoxy ether compound include polyoxyethylene alkyl ether compounds, such as polyoxyethylene alkylether, polyoxyethylene laurylether, polyoxyethylene cetylether and polyoxyethylene stearylether; polyoxy-alkyl phenylether compounds, such as polyoxyethylene nonylphenylether and polyoxyethylene octylphenylether; polyoxy-alkylene alkylether, polyoxyethylene higher alcohol ether, polyoxyethylene octyldodecylether, etc. Examples of commercial products of polyoxyethylene alkylether include EMULGEN 1108 and EMULGEN 1118S-70 (produced by Kao Corp.), examples of commercial products of polyoxyethylene lauryl ether include EMULGEN 103, EMULGEN 104P, EMULGEN 105, EMULGEN 106, EMULGEN 108, EMULGEN 109P, EMULGEN 120, EMULGEN 123P, EMULGEN 147, EMULGEN 150 and EMULGEN 130K (produced by Kao Corp.), examples of commercial products of polyoxyethylene cetyl ether include EMULGEN 210P and EMULGEN 220 (produced by Kao Corp.), examples of commercial products of polyoxyethylene stearylether include EMULGEN 220 and EMULGEN 306P (produced by Kao Corp.), examples of commercial products of polyoxy-alkylene alkyl ether include EMULGEN LS-106, EMULGEN LS-110, EMULGEN LS-114 and EMULGEN MS-110 (produced by Kao Corp.), and examples of commercial products of polyoxyethylene higher alcohol ether include EMULGEN 705, EMULGEN 707 and EMULGEN 709.

Among these polyoxy-ether compounds, preferable is polyoxyethylene oleyl ether compound and a compound generally represented by Formula (9):

C₁₈H₃₅—O(C₂H₄O)ₙH (9)

In the Formula, n represents 2 to 40.

An average additive number (n) of ethylene oxide to an oleyl portion is 2 to 40, preferably 2 to 10. The compound represented by Formula (9) can be obtained by a process of reacting ethylene oxide and oleyl alcohol.

Examples of specific commercial products include EMULGEN 404 (polyoxyethylene(4) oleylether), EMULGEN 408 (polyoxyethylene(8) oleylether), EMULGEN 409P (polyoxyethylene(9) oleylether), EMULGEN 420 (polyoxyethylene(13) oleylether), EMULGEN 430 (polyoxyethylene (30) oleylether) produced by Kao Corp., and NOFABLEEAO-9905 (polyoxyethylene (5) oleylether) produced by NOF Corporation. The number in parenthesis ( ) indicates “n”.

The polyoxyether compound may be used singly or two or more in combination. The preferable additive amount of a polyoxy-ether compound and a silicone surfactant as the total amount of them to the actinic radiation curable resin in a hard coat layer is 0.1 percent by weight to 8.0 percent by weight, more preferably 0.2 percent by weight to 4.0 percent by weight. In these ranges, they exist stably in the hard coat layer.

The fluorine surfactant, acetylene-glycol compound, nonionic surfactant, radical polymerizable nonionic surfactant and so on as described as for the layer of low refractive index mentioned below may be used in combination.

The clear hard coat layer of the clear hard coat film of the present invention has a mean center-line roughness (Ra) prescribed by JIS B 0601 of 0.05 μm or less.

Examples of the other nonionic surfactants include polyoxy-alkyl ester compounds, such as polyoxyethylene monolaurate, polyoxyethylene monostearate and polyoxyethylene monoolate; and sorbitan ester compounds, such as sorbitan monolaurate, sorbitan monostearate and sorbitan monoolate. Examples of the acetylene glycol-based compound include SURFYNOL 104E, SURFYNOL 104PA, SURFYNOL 420, SURFYNOL 440, DYNOL 604 (produced by Nissin Chemical Industry Co., Ltd.).

Examples of the radical polymerizable nonionic surfactant include polyoxyalkylene alkyl phenyl ether (meth)acrylate based polymerizable surfactants, such as RMA-564, RMA-568, and RMA-1114 (product name produced by Nippon Nyukazai Co., Ltd.).

The hard coat layer may be incorporated with, as a hardening aid, polyfunctional thiol compound, for example, 1,4-bis(3-mercaptobutylyloxy)butane, pentaerythritol tetrakis (3-mercaptobutylate), 1,3,5-tris(3-mercaptobutyloxyethyl)-1,3,5-triazine-2,4,6(1H,3H,5H)-trione. Compound in the trade name of KARENZ MT series manufactured by Showa Denko K. K. can be obtained in the market. The polyfunctional thiol compound is added in an amount of preferably 0.01 to 50 parts by weight, and more preferably 0.05 to 30 parts by weight with respect to an actinic energy curable resin 100 parts by weight. It works suitably as a hardening, aid, and exists stably in the hard coat layer when added in above mentioned amount.

The hard coat layer may have multi-layer structure composed of two or more layers. One of the layers among them may be, for example, a so called antistatic layer containing electroconductive microparticles or an ionic polymer. Otherwise it may incorporated with a color adjusting agent such as a die or a pigment having a color adjusting function as a color compensating filter for various display element.

Further an electromagnetic wave blocking agent, a UV ray absorbent etc. may be incorporated so as to display their functions.

The clear hard coat film of the present invention is preferably subjected to saponification treatment by alkali solution so as to improve adhesion properties of a transparent film substrate composing hard coat film with polarizing plate mentioned later, particularly, in case that a triacetate film such as cellulose ester film is employed for a transparent film substrate. The clear hard coat film of the present invention is preferable to have excellent film strength after alkali saponification treatment, though the hard coat layer is also liable to deteriorate in lubrication property of the surface or film strength, in this instance. There is a method in which protective film for an optical film is applied to the hard coat layer of the clear hard coat film before the alkali saponification treatment, then the alkali saponification treatment is conducted. This method is not preferable in view of increasing productivity load or cost because of increasing the number of processes such as applying the protective film for an optical film on the hard coat layer or peeling.

The protective film of an optical film is in the market and can be obtained form, for example Fujimori Kogyo Co., Ltd., SEKISUI CHEMICAL Co., LTD. and so on.

The alkali saponification treatment is conducted, in general, including cycles of immersing the clear hard coat film in alkali solution, then washing and drying. The alkali solution includes potassium hydroxide solution and sodium hydroxide solution. A normality of hydroxy ion is 0.1 to 3 N, and more preferably 0.5 to 2 N. An excellent adhesion property with a polarizing plate can be obtained in the aforementioned value.

Temperature of alkali solution is preferably 25 to 90° C. and more preferably 40 to 70° C. in view of precipitation of alkali solution etc. It is also preferable to conduct various surface treatments on the hard coat layer to improve tight adhesion property to a layer of high refractive index or a layer of low refractive index mentioned later.

Recently, there is a tendency that the process is conducted with increased concentration of hydroxy ion in the saponification bath to shorten a time for alkali saponification treatment in view pouf productivity. The effects of the present invention are displayed markedly by selecting a content ratio by weight of fluorine-siloxane graft polymer to energy actinic radiation curable resin of the hard coat layer as fluorine-siloxane graft polymer/energy actinic radiation curable resin being 0.05/100 to 5.00/100, under the hard condition.

The clear hard coat film may be used by applying the transparent film substrate at the back side of the hard coat layer on a surface of CRT, LCD, PDP and ELD via a sticking agent or an adhesive.

The hard coat layer of the clear hard coat film of the present invention preferably has a pencil hardness of 2H to 8H, since it is difficult to be damaged in the use of surface of display devices such as LCD or preparation process of polarizing plate mentioned later.

The hard coat film having pencil hardness of 2H to 8H is recognized as a hard coat layer having the clear hard coat film of the present invention. Preferable hardness is 3H to 6H in particular.

The pencil hardness is measured by pencil hardness evaluation method defined by JIS-K-5400 employing a test pencil defined by JIS-S-6006, after the prepared hard coat film samples are conditioned at 25° C., 60% RH.

### (Back Coat Layer)

The hard coat film of the present invention may be provided with a back coat layer on the other surface of a hard coat layer. A back coat film is provided to prevent curling which may occur when a hard coat layer is provided.

This means that the force to curl toward the hard coat layer side may be balanced out by adding a counter force to curl toward the back coat side. Also, a back coat layer preferably has a feature to prevent blocking. It is preferred that inorganic or organic microparticles are added to a coating composition of the back coat layer so as to endow a blocking function in this instance.

Microparticles added to the back coat layer include inorganic microparticles, for example, silicon dioxide, titanium dioxide, aluminum oxide, zirconium oxide, calcium carbonate, calcium carbonate, talc, clay, calcined kaolin, calcined calcium silicate, tin oxide, indium oxide, zinc oxide, ITO, hydrated calcium silicate, aluminum silicate, magnesium silicate and calcium phosphate.

Examples of the inorganic microparticles available on the market include: AEROSIL R972, R927V, R974, R812, 200, 200V, 300, R202, OX50 and TT600 (manufacture by Nippon Aerosil Co. Ltd.), SEAHOSTAR KE-P10, SEAHOSTAR KE-P30, SEAHOSTAR KE-P50, SEAHOSTAR KE-PP100, SEAHOSTAR KE-P150, and SEAHOSTAR KE-P250 (manufacture by Nippon Shokubai Co. Ltd.).

Examples of polymer include silicone resin, fluorine-containing resin and acrylic resin. Silicone resin is preferred and those, having a three dimensional net structure, are particularly preferable; for example, products under the name of TOSPEARL 103, 105, 108, 120, 145, 3120 and 240 (produced by Toshiba Silicones Co., Ltd.) are available on the market and can be utilized.

Among these, Aerosil 200V and Aerosil R972, SEAHOSTAR KE-P30, KE-P50 and KE-P100 are specifically preferably utilized. The content of microparticles contained in the back coat layer is preferably from 0.1 to 50 percent by weight and more preferably from 0.1 to 10 percent by weight with respect to a binder. The increase in haze after the hard coat film is provided with a back coat layer is preferably 1.5 percent or less, more preferably 0.5 percent or less and specifically preferably from 0.0 to 0.1 percent.

Coating composition for forming the back coat layer preferably contains a solvent. The examples include dioxane, acetone, methylethyl ketone, methylisobutyl ketone, N,N-dimethylformamide, methyl acetate, ethyl acetate, trichloroethylene, methylene chloride, ethylene chloride, tetrachloroethane, trichloroethane, chloroform, water, methanol, ethanol, n-propyl alcohol, i-propyl alcohol, n-butanol, cyclohexanone, cyclohexanol, propyleneglycol monomethyl ether, propyleneglycol monoethyl ether, and hydrocarbons (such as toluene and xylene). These may be employed in combination.

Resins used as a binder in a back coat layer include, for example: vinyl type homopolymers or copolymers such as a vinyl chloride/vinyl acetate copolymer, a vinyl chloride resin, a vinyl acetate resin, a copolymer of vinyl acetate and vinyl alcohol, a partially hydrolyzed vinyl chloride/vinyl acetate copolymer, a vinyl chloride/vinylidene chloride copolymer, a vinyl chloride/acrylonitrile copolymer, an ethylene/vinyl alcohol copolymer, a chlorinated polyvinylchloride, an ethylene/vinyl chloride copolymer and a ethylene/vinyl acetate copolymer, cellulose derivatives such as cellulose nitrate, cellulose acetate propionate (preferably acetyl group having degree of substitution of 1.8 to 2.3, propionyl group, and degree of substitution of 0.1 to 1.0), cellulose diacetate and cellulose acetate butylate, a copolymer of maleic acid and/or acrylic acid, a copolymer of acrylate ester, an acrylonitrile/styrene copolymer, a chlorinated polyethylene, an acrylonitrile/chlorinated polyethylene/styrene copolymer, a methylmethacrylate/butadiene/styrene copolymer, an acrylic resin, a polyvinylalcohol resin, a polyvinyl acetal resin, a polyvinylbutyral resin, a polyester polyurethane resin, a polyether polyurethane resin, a polycarbonate polyurethane resin, a polyester resin, a polyether resin, a polyamide resin, an amino resin, rubber type resins such as a styrene/butadiene resin and a butadiene/acrylonitrile resin; a silicone type resin; and a fluorine type resin, however, the present invention is not limited thereto.

Examples of acrylic resins available on the market include homopolymers and copolymers produced from acryl or methacryl monomers, such as: ACRYPET MD, VH, MF and V (manufactured by Mitsubishi Rayon Co., Ltd.), Hi Pearl M-4003, M-4005, M-4006, M-4202, M-5000, M-5001 and M-4501 (Negami Chemical Industrial Co., Ltd.), DIANAL BR-50, BR-52, BR-53, BR-60, BR-64, BR-73, BR-75, BR-77, BR-79, BR-80, BR-82, BR-83, BR-85, BR-87, BR-88, BR-90, BR-93, BR-95, BR-100, BR-101, BR-102, BR-105, BR-106, BR-107, BR-108, BR-112, BR-113, BR-115, BR-116, BR-117 and BR-118 (manufactured by Mitsubishi Rayon Co., Ltd.). A resin used in the present invention may suitably be selected from the above examples.

For example, it is preferable to use a blended composition of cellulose ester such as cellulose diacetate and cellulose acetate propionate with an acryl resin as a resin used as a binder. A back coat layer with high transparency can be obtained by employing particles composed of an acryl resin to make a difference between particles and a binder being 0 to 0.02.

Coefficient of dynamic friction of the back coat layer is preferably not more than 0.9, particularly 0.1 to 0.9.

It is preferable that the coating composition for forming the back coat layer is applied on a surface of the transparent resin film by employing a gravure coater, a dip coater, a reverse coater, a wire bar coater and a die coater, or spray coating, inkjet coating etc., so as to have wet thickness of 1 to 100 μm, more preferably 5 to 30 μm.

The back coat layer is formed by drying by heat after coating and further being subjected to curing processing, if necessary. The curing processing is conducted by the process described in the item of the layer of low refractive index.

The back coat layer may be formed by twice or more divided coating. The back coat layer may also be an easy adhesion layer improving adhesion property to a polarizer.

### (Anti-Reflection Film)

The clear hard coat film of the present invention may have an anti-reflection layer, considering refractive index, thickness, a number of the layers, a layer order etc., so as to reduce reflectance by optical interference, on the hard coat layer. The anti-reflection layer is composed of a layer of high refractive index having higher refractive index than the transparent film substrate and a layer of low refractive index having lower refractive index than the transparent film substrate etc. The hard coat layer may be worked as a layer of high refractive index as well.

An anti-reflection film having an excellent tight adhesion property after a durability test may be formed by incorporating at least one species of hollow silica microparticles inside of which is porous or void described below in layer of low refractive index. It is preferable that the anti-reflection film is provided with a layer of high refractive index between the hard coat layer and a layer of low refractive index.

Examples of preferred layer configuration of the antireflection film of the present invention will now be described. These show that plural layers are provided.

Back coat layer/transparent film substrate/hard coat layer/layer of low refractive index

Back coat layer/transparent film substrate/hard coat layer/layer of high refractive index/layer of low refractive index
Antistatic layer/transparent film substrate/hard coat layer/layer of high refractive index/layer of low refractive index
Back coat layer/transparent film substrate/hard coat layer/layer of high refractive index/layer of low refractive index/layer of high refractive index/layer of low refractive index

### (Layer of High Refractive Index)

The layer of high refractive index is described. The layer of high refractive index is a layer having higher refractive index than the transparent film substrate. The preferable refractive index of the layer of high refractive index is in a range of 1.5 to 2.2, based on measurement at 23° C. with a wavelength of 550 nm. Since means to adjust a refractive index of a layer of high refractive index are primarily the type of electro-conductive particles and its addition amount, a refractive index of electro-conductive particles is preferably 1.60 to 2.60 and more preferably 1.65 to 2.50.

A thickness of a layer of high refractive index is preferably 5 nm to 1 μm, more preferably 10 nm to 0.3 μm and most preferably 30 nm to 0.2 μm because of the characteristics required for the optical interference layer.

Electro-conductive particles are described which is used to adjust refractive index of a layer of high refractive index.

The electro-conductive particles is at least one species of electroconductive microparticles selected from a group of antimony oxide, tin oxide, zinc oxide, indium tin oxide (ITO), antimony tin oxide (ATO) and zinc antimonate.

An average particle diameter of primary particles of the electro-conductive particles is 10 to 200 nm, more preferably 20 to 150 nm, and particularly preferably 30 to 100 nm. An average particle diameter of the electro-conductive particles can be measured by electron microscope picture via a scanning electron microscope (SEM) etc. It can be measured by particle size distribution meter and so on employing a dynamic light-scattering method or static light-scattering method. When the particle diameter is too small, the particles are apt to aggregate and dispersion property deteriorates. When the particle diameter is too large, it is not preferable because haze increases remarkably. Shape of the electro-conductive particles is preferably rice grain shape, sphere, cubic, spindle shape, needle or amorphous.

Electro-conductive particles may be surface treated with an organic compound. By modifying the surface of electro-conductive particles with an organic compound, dispersion stability in an organic solvent is improved and control of a dispersed particle diameter becomes easy as well as it is also possible to restrain aggregation and precipitation due to aging. The amount of surface modification with an organic compound is 0.1 to 5 percent by weight and more preferably 0.5 to 3 percent by weight, against electro-conductive particles for this purpose. Practical examples of an organic substance utilized for the surface treatment include polyol, Alkanol amine, stearic acid, a silane coupling agent and a titanate coupling agent. Among them, a silane coupling agent described later is preferred. Two or more types of surface treatments may be utilized in combination.

The amount of electro-conductive particles to be used is preferably 5 to 85 percent by weight in a layer of high refractive index, more preferably 10 to 80 percent by weight and most preferably 20 to 75 percent by weight. If the used amount is small, the desired refractive index or the effect of the present invention may not be obtained, on the other hand, when the used amount is too much, the deterioration of the film strength may occur.

The electro-conductive particles are supplied to a coating liquid, which forms a layer of high refractive index, in a state of dispersion being dispersed in a medium. As a dispersion medium of electro-conductive particles, preferable is a liquid having a boiling point of 60 to 170° C. Practical examples of a dispersion medium include water, alcohol (such as methanol, ethanol, isopropanol, butanol and benzyl alcohol), ketone (such as acetone, methylethyl ketone, methylisobutyl ketone and cyclohexanone), ketone alcohol (such as diacetone alcohol), ester (such as methyl acetate, ethyl acetate, propyl acetate, butyl acetate, methyl formate, ethyl formate, propyl formate and butyl formate), aliphatic hydrocarbon (such as hexane and cyclohexane), hydrocarbon halogenide (such as methylene chloride, chloroform and carbon tetrachloride), aromatic hydrocarbon (such as benzene, toluene and xylene), amide (such as dimethylformamide, dimethylacetamide and n-methylpyrrolidone), ether (such as diethyl ether, dioxane and tetrahydrofuran) and ether alcohol (such as 1-methoxy-2-propanol), propyleneglycol monomethyl ether, and propyleneglycol monomethyl ether acetate. Among them, toluene, xylene, methyl ethyl ketone, methyl isobutyl ketone, cyclohexanone and methanol, ethanol and isopropanol are specifically preferable.

A homogenizer can be used to disperse electro-conductive particles in a medium. Examples of the homogenizer include a sand grinder mill (for example, a beads mill equipped with a pin), a high speed impeller mill, a pebble mill, a roller mill, ATTRITOR mill and a colloidal mill. A sand grinder mill and a high speed impeller mill are specifically preferable. Further, a preliminary dispersion may be performed. Examples of a homogenizer utilized in a preliminary dispersion include a ball mill, a three-roll mill, a kneader and an extruder.

Metal oxide particles having a core/shell structure may be incorporated further. One layer of a shell may be formed on the circumference of a core or plural layers of shells may be formed to further improve light resistance. It is preferable to completely cover the core with a shell. An actinic radiation curable resin may preferably be incorporated in the layer of high refractive index as a binder of the electro-conductive particles to improve a film forming property pr physical property.

An energy ray curable type resin is preferably a UV ray curable resin, and an alkoxylated UV ray curable resin having 1 to 3 carbon atoms and/or a UV ray curable resin having a dioxane structure are particularly preferable. Practical examples are those having methylene oxide, ethylene oxide, propylene oxide and/or 1,3-dioxane or 1,4-dioxane structure in a structure of UV ray curable resin.

Preferable examples of the UV ray curable resin include methoxy polyethyleneglycol acrylate, methoxy polyethyleneglycol methacrylate, ethoxylated phenyl acrylate, ethoxylated phenyl methacrylate, ethoxylated 2-methyl-1,3propanediol diacrylate, ethoxylated 2-methyl1,3propanediol dimethacrylate, ethoxylated bisphenol A diacrylate, ethoxylated propoxylated bisphenol A dimethacrylate, ethoxylated trimethylol propane triacrylate, ethoxylated trimethylol propane trimethacrylate, ethoxylated pentaerythritol tetraacrylate, propoxylated ditrimethylol propane tetraacrylate, propoxy pentaerythritol tetraacrylate, dioxane glycoldiacrylate and dioxane glycoldimethacrylate.

Particularly preferable are those having one or two functional group causing polymerization reaction directly by irradiation of an energy ray such as UV ray or electron beam, or indirectly by an action of a light polymerization initiator.

The alkoxylated UV ray curable resin having 1 to 3 carbon atoms and/or the UV ray curable resin having a dioxane structure may be used singly or in mixture, respectively. The mixing ratio by weight is preferably 1:99 to 99:1, more preferably 20:80 to 80:20, and more preferably 30:70 to 70:30. In the preferable range anti-solvent property and tight adhesion property are improved particularly after wet heat durability test. A monomer or oligomer having one or two functional group causing polymerization reaction directly by irradiation of an energy ray such as UV ray or electron beam, or indirectly by an action of a light polymerization initiator may be used. The functional group includes a group having an unsaturated double bond such as (meth)acryloyloxy group, an epoxy group and a silanol group. A radical polymerizable or oligomer having two or more unsaturated double bond is used preferably among them. A light polymerization initiator may used in combination if necessary. The UV ray curable resin includes polyol acrylate, epoxy acrylate, urethane acrylate, polyester acrylate or mixture thereof. The example includes polyfunctional acrylate compounds, and preferably selected a group of pentaerythritol polyfunctional acrylate, dipentaerythritol polyfunctional acrylate, pentaerythritol polyfunctional methacrylate and dipentaerythritol polyfunctional methacrylate. The polyfunctional acrylate compound is a compound having two or more acryloyloxy groups and/or methacryloyloxy groups in a molecule.

Preferably usable monomer of the polyfunctional acrylate compound include for example, ethyleneglycol diacrylate, diethyleneglycol diacrylate, 1,6-hexane diol diacrylate, neopentylglycol diacrylate, trimethylol propane triacrylate, trimethylol ethanetriacrylate, tetramethylol methane triacrylate, tetramethylol methane tetraacrylate, pentaglycerol triacrylate, pentaerythritol diacrylate, pentaerythritol triacrylate, pentaerythritol tetraacrylate, glycerin triacrylate, dipentaerythritol triacrylate, dipentaerythritol tetraacrylate, dipentaerythritol pentaacrylate, dipentaerythritol hexaacrylate, tris (acryloyloxy ethylisocyanurate, ethyleneglycol dimethacrylate, diethyleneglycol dimethacrylate, 1,6-hexane diol dimethacrylate, neopentylglycol dimethacrylate, trimethylol propane trimethacrylate, trimethylol ethanetrimethacrylate, tetramethylol methane trimethacrylate, tetramethylol methane tetramethacrylate, pentaglycerol trimethacrylate, pentaerythritol dimethacrylate, pentaerythritol trimethacrylate, pentaerythritol tetramethacrylate, glycerin trimethacrylate, dipentaerythritol trimethacrylate, dipentaerythritol tetramethacrylate, dipentaerythritol pentamethacrylate and dipentaerythritol hexamethacrylate. These compounds may be used singly or in mixing, respectively. These may be an oligomer such as a dimer, trimer etc., of the above mentioned monomer.

It is preferable to use a light polymerization initiator and an acryl type compound having two or more unsaturated double bonds capable of polymerization in a molecule in a ratio by weight of 1:2 to 1:10 for acceleration of curing. An amount of the energy ray curable type resin is preferably not less than 15 percent and not more than 50 percent by weight of a solid component in case of high refractive index composition. Mixing ratio of the energy ray curable type resin to electro-conductive particles is preferably 1:3 to 5:3, more preferably 1:1.5 to 1.6:1, and particularly preferably 1.5:1.2 to 1.5:1 of a solid component solid component. Otherwise, an tight adhesion property is insufficient and an anti-static property deteriorates, for example, when electro-conductive particles are too few. It is not preferable that the electro-conductive particles are too much, because microparticles releases and adhere to a film surface during coating in a production process of anti-reflection film to cause an appearance deficiency.

The photoinitiator include practically acetophenone, benzophenone, hydroxy benzophenone, Michler's ketone, α-amyloxime ester, thioxanthone or their derivative but not restricted to these.

The layer of high refractive index may contain an organic silicon compound represented by following Formula (a) or its hydrolysis product or its polycondensation compound to improve film forming property or physical property of a coating film.

R′ₙSi(OR)₄₋ₙ (α)

In the formula, R′ is a substituting group having at least one functional group such as a vinyl group, an amino group, an epoxy group, a chlorine group, a methacryloxy group, an acryloxy group and an isocyanate group, R is an alkyl group, n is a number of substitution.

Practical examples of the organic silicon compound represented by the Formula (1) or its hydrolysis product or its polycondensation compound include methyltriethoxysilane, methyltriethoxysilane, methyltrimethoxy ethoxysilane, methyltriacetoxysilane, methyltributoxysilane, ethyltrimethoxysilane, ethyltriethoxysilane, vinyl methoxysilane, vinyltriethoxysilane, vinyltriacetoxysilane, vinyltrimethoxy ethoxysilane, phenyltrimethoxysilane, phenyltriethoxysilane, phenyl triacetoxysilane, γ-chloropropyltrimethoxysilane, γ-chloropropyltriethoxysilane, γ-chloropropyltriacetoxysilane, 3,3,3-trifluoropropyltrimethoxysilane, γ-glycidyloxypropyltrimethoxysilane, γ-glycidyloxypropyltriethoxysilane, γ-(β-glycidyloxyethoxy)propyltrimethoxysilane, β-(3,4-epoxycyclohexyl)ethyltrimethoxysilane, β-(3,4-epoxycyclohexyl)ethyltriethoxysilane, γ-acryloyloxy propyltrimethoxysilane, γ-methacryloyloxypropyltrimethoxysilane, γ-aminopropyltrimethoxysilane, γ-aminopropyltriethoxysilane, γ-mercaptopropyltrimethoxysilane, γ-mercaptopropyltriethoxysilane, N-β-(aminoethyl)-γ-aminopropyltrimethoxysilane, and β-cyanoethyltriethoxysilane, dimethyldimethoxysilane, phenylmethyldimethoxysilane, dimethyldiethoxysilane, phenylmethyldimethoxysilane, dimethyldiethoxysilane, phenylmethyldiethoxysilane, γ-glycidyloxypropylmethyldiethoxysilane, γ-glycidyloxypropylmethyldimethoxysilane, γ-glycidyloxypropylphenyldiethoxysilane, γ-chloropropylmethyldiethoxysilane, dimethyldiacethoxysilane, γ-acryloyloxy propylmethyldimethoxysilane, γ-acryloyloxy propylmethyldiethoxysilane, γ-methacryloyloxypropylmethyldimethoxysilane, γ-methacryloyloxypropylmethyldiethoxysilane, γ-mercaptopropylmethyldimethoxysilane, γ-mercaptopropylmethyldiethoxysilane, γ-aminopropylmethyldimethoxysilane, γ-aminopropylmethyldiethoxysilane, methylvinyldimethoxysilane and methylvinyldiethoxysilane.

Preferable examples among these include those having a double bond in a molecule such as vinyl methoxysilane, vinyltriethoxysilane, vinyltriacetoxysilane, vinyltrimethoxy ethoxysilane, γ-acryloyloxy propyltrimethoxysilane, and γ-methacryloyloxypropyltrimethoxysilane; those having 2 substituting alkyl groups with silicon atom such as γ-acryloyloxy propylmethyldimethoxysilane, γ-acryloyloxy propylmethyldiethoxysilane, γ-methacryloyloxypropylmethyldimethoxysilane, γ-methacryloyloxypropylmethyldiethoxysilane, methylvinyldimethoxysilane, and methylvinyldiethoxysilane. And γ-acryloyloxy propyltrimethoxysilane, γ-methacryloyloxypropyltrimethoxysilane, γ-acryloyloxy propylmethyldimethoxysilane, γ-acryloyloxy propylmethyldiethoxysilane, γ-methacryloyloxypropylmethyldimethoxysilane and γ-methacryloyloxypropylmethyldiethoxysilane are particularly preferable among them.

Two kinds or more of the organic silicon compound represented by Formula (a) or its hydrolysis product or its polycondensation compound may be used.

Another organic silicon compound or its hydrolysis product or its polycondensation compound may be used in addition to the above mentioned organic silicon compound or its hydrolysis product or it polycondensation compound. Another organic silicon compound or its hydrolysis product or its polycondensation compound includes an alkyl ester of orthosilicic acid such as methyl orthosilicate, ethylorthosilicate, n-propylorthosilicate, i-propylorthosilicate, n-butyl orthosilicate, sec-butyl orthosilicate and t-butyl orthosilicate, and hydrolysis product thereof.

It is preferable to use an organic solvent applying a layer of high refractive index. The preferable organic solvent includes, for example, alcohols such as methanol, ethanol, propanol, isopropanol, butanol, iso-butanol, sec-butanol, tert-butanol, pentanol, hexanol, cyclohexanol and benzyl alcohol; polyhydric alcohols such as ethyleneglycol, diethyleneglycol, triethyleneglycol, polyethyleneglycol, propylene glycol-di-propylene glycol, polypropylene glycol, butylene glycol, hexane diol, pentane diol, glycerin, hexane triol and thiodiglycol; thiodiglycol ethers such as ethyleneglycol monomethylether, ethyleneglycol monomethylether, ethyleneglycol monobutylether, diethyleneglycol monomethyl ether, diethyleneglycol monomethyl ether, diethyleneglycol monobutylether, propyleneglycol monomethyl ether, propyleneglycol monobutylether, ethyleneglycol monomethyl ether acetate, triethyleneglycol monomethyl ether, triethyleneglycol monomethylether, ethyleneglycol monophenylether, and propyleneglycol monophenylether), amines such as ethanolamine, diethanol amine, triethanolamine, N-methyldiethanolamine, N-ethyldiethanolamine, morpholine, N-ethyl morpholine, ethylenediamine, diethylenediamine, triethylenetetramine, tetraethylenepentamine, polyethyleneimine, pentamethyldiethylenetriamine and tetramethylpropylenediamine; amides such as formamide, N,N-dimethylformamide and N,N-dimethylacetoamide; heterocycles such as 2-pyrolidone, N-methyl-2-pyrolidone, cyclohexylpyrrolidone, 2-oxazolidone, and 1,3-dimethyl-2-imidazolidinone; sulfoxides such as dimethylsulfoxide, sulfones such as sulfolane; urea, acetonitrile and acetone, and, alcohols, polyhydric alcohols, thiodiglycol ethers are particularly preferable.

The layer of high refractive index is formed by that a coating composition for forming the layer of high refractive index is applied on a surface of the hard coat layer by employing a gravure coater, a dip coater, a reverse coater, a wire bar coater and a die coater, or spray coating, inkjet coating etc., so as to have wet thickness of 0.1 to 100 μm, drying by heat after coating and further being subjected to curing processing, if necessary. The curing process can be conducted by employing the same way as the layer of low refractive index mentioned later. The dry thickness is adjusted to have above mentioned thickness by controlling concentration of solid component of the coating composition.

### (Layer of Low Refractive Index)

The layer of low refractive index is described. The layer of low refractive index is a layer having lower refractive index than a transparent film substrate. Practically preferable refractive index is 1.30 to 1.45 at a temperature of 23° C., and wave length of 550 nm. A thickness of the layer of low refractive index is preferably 5 nm to 0.5 μm, more preferably 10 nm to 0.3 μm, and further preferably 30 nm to 0.2 μm in view of property of an optical interference layer. It is preferable that hollow silica particles are incorporated in the layer of low refractive index in view of tight adhesion property after durability test and a property of an optical interference layer such as lowering refractive index. The hollow silica particles (referred as hollow particles later) include (1) composite particles composed of porous particles and a cover layer provided on a surface of the porous particles, and (2) hollow particles having voids inside which is filled with solvent, gas or porous substance.

The hollow particles are particles having voids inside, and the voids are surrounded by particle walls. Contents such as solvent used in the preparation process, gas or porous substance fills in the voids. An average particle diameter of the hollow particles is 5 to 200 nm, and preferably 10 to 70 nm. The hollow particles are preferably monodispersion having coefficient of variation particle diameter being 1 to 40%.

An average particle diameter of the hollow particles can be measured by an electron microscope picture via a scanning electron microscope (SEM). It may be measured by particle size distribution meter and so on employing a dynamic light-scattering method, a static light-scattering method and so on.

The average particle diameter of the hollow particles is optionally selected according to thickness of transparent layer of layer of low refractive index as formed. Thickness 3/2 to 1/10, preferably 2/3 to 1/10 of the transparent layer is preferable. It is preferable that the hollow particles are used in a state dispersed in a suitable solvent to form a layer of low refractive index.

As dispersing medium, water, alcohols (such as methanol, ethanol, isopropyl alcohol) ketone (such as methylethyl ketone and methylisobutyl ketone), and ketone alcohol (such as diacetone alcohol), propylenemonomethyl ether and propyleneglycol monomethyl ether acetate are preferable.

A thickness of the cover layer of a composite particle or the thickness of the particle wall of a hollow particle is preferably in a range of 1 to 40 nm and more preferably in a range of 1 to 20 nm, and 2 to 15 nm particularly. In the case of a composite particle, when a thickness of the cover layer is less than 1 nm, a particle may not be completely covered to allow such as silicate monomer or oligomer having a low polymerization degree as a coating component described later to immerse into the interior of the composite particle resulting in decrease of porousness (volume of pore), whereby an effect of a low refractive index may not be sufficiently obtained.

The hollow particles may not maintain the shape of particles when thickness of the walls of the particles is not more than 1 nm, and an effect of a low refractive index may not be sufficiently obtained when the thickness exceeds 20 nm.

The cover layer of a composite particle or the particle wall of a hollow particle is preferably composed of silica as a primary component. Further, components other than silica may be incorporated, and practical examples include such as Al₂O₃, B₂O₃, TiO₂, ZrO₂, SnO₂, CeO₂, F₂O₃, Sb₂O₃, MoO₃, ZnO₂, and WO₃. A porous particle to constitute a composite particle includes those composed of silica, those composed of silica and an inorganic compound other than silica and those composed of such as CaF₂, NaF, NaAlF₆ and MgF. Among them, specifically preferable is a porous particle comprised of a composite oxide of silica and an inorganic compound other than silica.

An inorganic compound other than silica includes one type or at least two types of such as Al₂O₃, B₂O₃, TiO₂, ZrO₂, SnO₂, CeO₂, P₂O₃, Sb₂O₃, MoO₃, ZnO₂ and WO₃. In such a porous particle, mole ratio MOₓ/SiO₂ is preferably in a range of 0.0001 to 1.0 and more preferably of 0.001 to 0.3 when silica is represented by SiO₂ and an inorganic compound other than silica is represented by an equivalent oxide (MOₓ).

A porous particle having mole ratio MOₓ/SiO₂ of less than 0.0001 is difficult to be prepared and the pore volume is small to unable preparation of a particle having a low refractive index. Further, when mole ratio MOₓ/SiO₂ of a porous particle is over 1.0, the pore volume becomes large due to a small ratio of silica and it may be further difficult to prepare a particle having a low refractive index.

The pore volume of the porous particles is 0.1 to 1.5 ml/g, and preferably 0.2 to 1.5 ml/g. In case of pore volume being not more than 0.1 ml/g, particles having sufficiently low refractive index are not obtained and, in case of exceeding 1.5 ml/g, strength of microparticles lowers and strength of obtained film may be liable to lower.

Herein, the pore volume of such a porous particle can be determined by a mercury pressurized impregnation method. Further, a content of a hollow particle includes such as a solvent, a gas and a porous substance which have been utilized at preparation of the particle. In a solvent, such as a non-reacted substance of a particle precursor which is utilized at hollow particle preparation and a utilized catalyst may be contained.

Further, a porous substance includes those comprising compounds exemplified in the porous particle. These contents may be those containing single component or mixture of plural components.

As a manufacturing method of such hollow particles, a preparation method of composite oxide colloidal particles, disclosed in paragraph Nos. [0010] to [0033] of JP-A H07-133105, is suitably applied. Specifically, in the case of a composite particle being comprised of silica and an inorganic compound other than silica, the hollow particle is manufactured according to the following first to third processes.

### First Process: Preparation of Porous Particle Precursor

In the first process, alkaline aqueous solutions of a silica raw material and of an inorganic compound raw material other than silica are independently prepared or a mixed aqueous solution of a silica raw material and an inorganic compound raw material other than silica is prepared, in advance, and this aqueous solution is gradually added into an alkaline aqueous solution having a pH of not less than 10 while stirring depending on the complex ratio of the aimed composite oxide, whereby a porous particle precursor is prepared.

As a silica raw material, silicate of alkali metal, ammonium or organic base is used. As silicate of alkali metal, utilized are sodium silicate (water glass) and potassium silicate. Organic base includes quaternary ammonium salt such as tetraethylammonium salt; and amines such as monoethanolamine, diethanolamine and triethanolamine. Herein, an alkaline solution, in which such as ammonia, quaternary ammonium hydroxide or an amine compound is added to a silicic acid solution, is also included in silicate of ammonium or silicate of organic base.

Further, as a raw material of an inorganic compound other than silica, utilized is an alkali-soluble inorganic compound. Practical examples include oxoacid of an element selected from such as Al, B, Ti, Zr, Sn, Ce, P, Sb, Mo, Zn and W; alkali metal salt, alkaline earth metal salt, ammonium salt and quaternary ammonium salt of the oxoacid. More specifically, sodium aluminate, sodium tetraborate, ammonium zirconyl carbonate, potassium antimonite, potassium stannate, sodium aluminosilicate, sodium molybdate, cerium ammonium nitrate and sodium phosphate are suitable.

The pH value of a mixed aqueous solution changes simultaneously with addition of these aqueous solutions, however, operation to control the pH value into a specific range is not necessary. The aqueous solution finally takes a pH value determined by the types and the mixing ratio of inorganic oxide. The addition rate of an aqueous solution is not specifically limited in this instance. Further, dispersion of a seed particle may be also utilized as a starting material at the time of manufacturing of composite oxide particles.

Said seed particles are not specifically limited. Particles of inorganic oxide such as SiO₂, Al₂O₂, TiO₂ or ZrO₂ or composite oxide thereof are utilized, and generally sol thereof can be utilized. Further, a porous particle precursor dispersion prepared by the manufacturing method may be utilized as seed particle dispersion.

In the case of utilizing seed particle dispersion, after the pH of the seed particle dispersion is adjusted to not lower than 10, an aqueous solution of the compound is added into said seed particle dispersion while stirring. In this case pH control of dispersion is not necessarily required. By utilizing seed particles in this manner, it is easy to control the particle diameter of prepared porous particles and particles having a uniform particle size distribution can be obtained.

A silica raw material and an inorganic compound raw material, as described above, have a high solubility at alkaline area. However, when the both are mixed in pH range having this high solubility, the solubility of an oxoacid ion such as a silicic acid ion and an aluminic acid ion will decrease, resulting in precipitation of these complex products to form particles or to be precipitated on a seed particle causing particle growth. Therefore, pH control in a conventional method is not necessarily required at the time of precipitation and growth of particles.

In the first process, a complex ratio of silica and an inorganic compound other than silica is preferably in a range of 0.05 to 2.0 and more preferably of 0.2 to 2.0, based on mole ratio MOₓ/SiO₂, when an inorganic compound other than silica is converted to oxide (MOₓ). In this range, the smaller is the ratio of silica, increases the pore volume of porous particles. However, a pore volume of porous particles barely increases even when the mole ratio is over 2.0. On the other hand, a pore volume becomes small when the mole ratio is less than 0.05. In the case of preparing hollow particles, mole ratio of MOₓ/SiO₂ is preferably in a range of 0.25 to 2.0.

Second Process: Removal of Inorganic Compounds Other than Silica from Porous Particles

In the second process, at least a part of inorganic compounds other than silica (elements other than silica and oxygen) is selectively removed from the porous particle precursor prepared in the first process. As a specific removal method, inorganic compounds in a porous particle precursor are removed by dissolving them using such as mineral acid and organic acid, or by ion-exchanging being contacted with cationic ion-exchange resin.

A porous particle precursor prepared in the first process is a particle having a network structure in which silica and an inorganic compound element bond via oxygen. In this manner, by removing inorganic compounds (elements other than silica and oxygen) from a porous particle precursor, porous particles, which are more porous and have a large pore volume, can be prepared. Further, hollow particles can be prepared by increasing the removal amount of inorganic compound (elements other than silica and oxygen) from a porous particle precursor.

Further, in advance to removal of inorganic compounds other than silica from a porous particle precursor, it is preferable to form a silica protective membrane by adding a silicic acid solution which contains a silane compound having a fluorine substituted alkyl group, and is prepared by dealkalization of alkali metal salt of silica; or a hydrolyzable organosilicon compound, in a porous particle precursor dispersion prepared in the first process. The thickness of a silica protective membrane is 0.5 to 40 nm, preferably 0.5 to 15 nm. Herein, even when a silica protective membrane is formed, since the protective membrane in this process is porous and has a thin thickness, the inorganic compounds other than silica can be removed from a porous particle precursor.

By forming such a silica protective membrane, the inorganic compounds other than silica can be removed from a porous particle precursor while keeping the particle shape as it is. Further, at the time of forming a silica cover layer described later, the pore of porous particles is not sealed by a cover layer, and thereby the silica cover layer described later can be formed without decreasing the pore volume. When the amount of inorganic compound to be removed is small, it is not necessary to form a protective membrane because the particles will not be broken.

It is preferable to form this silica protective membrane in the case of preparation of hollow particles. At the time of preparation of hollow particles, a hollow particle precursor comprising a silica protective membrane, a solvent and insoluble porous solid within said silica protective membrane, is obtained when inorganic compounds are removed. The hollow particles are formed by forming cover layer described later is formed on said hollow particle precursor, then the formed cover layer becomes particle wall.

The amount of a silica source added to form the silica protective membrane is preferably in a range so small as to maintain the particle shape. When the amount of a silica source is excessively large, it may become difficult to remove inorganic compounds other than silica from a porous particle precursor because a silica protective membrane becomes excessively thick.

As a hydrolizable organosilicon compound utilized to form a silica protective membrane, alkoxysilane represented by Formula utilized preferably.

RₙSi(OR′)₄₋ₙ (β)

In the Formula R and R′: each is a hydrocarbon group such as an alkyl group, an aryl group, a vinyl group or an acryl group; n is 0, 1, 2 or 3. Fluorine-substituted tetraalkoxysilane, such as tetramethoxysilane, tetraethoxysilane and tetraisopropoxysilane, is particularly preferably utilized.

As an addition method, a solution, in which a small amount of alkali or acid as a catalyst is added into a mixed solution of these alkoxysilane, pure water and alcohol, is added into the dispersion of porous particles, and silicic acid polymer formed by hydrolysis of alkoxysilane is precipitated on the surface of inorganic oxide particles.

Alkoxysilane, alcohol and a catalyst may be simultaneously added into the dispersion, in this instance. As an alkali catalyst, ammonia, hydroxide of alkali metal and amines can be utilized. Further, as an acid catalyst, various types of inorganic acid and organic acid can be utilized.

In the case that a dispersion medium of a porous particle precursor is water alone or has a high ratio of water to an organic solvent, it is also possible to form a silica protective membrane by use of a silicic acid solution. In the case of utilizing a silicic acid solution, a predetermined amount of a silicic acid solution is added into the dispersion and alkali is added simultaneously, to precipitate silicic acid solution on the porous particle surface. Herein, a silica protective membrane may also be formed by utilizing a silicic acid solution and the alkoxysilane in combination.

### Third Process: Formation of Silica Cover Layer

In the third process, by addition of such as a hydrolyzable organosilicon compound containing a silane compound provided with a fluorine substituted alkyl group, or a silicic acid solution, into a porous particle dispersion (into a hollow particle dispersion in the case of hollow particles), which is prepared in the second process, the surface of particles is covered with a polymer substance of such as a hydrolyzable organosilicon compound or a silicic acid solution to form a silica cover layer. A silicic acid solution is an aqueous solution of lower polymer of silicic acid which is formed by ion-exchange and dealkalization of an aqueous solution of alkali metal silicate such as water glass.

The addition amount of an organosilicon compound or a silicic acid solution, which is utilized for cover layer formation, is as much as to sufficiently cover the surface of colloidal particles and the solution is added into a dispersion of porous particles (a hollow particle precursor in the case of hollow particles) at an amount to make a thickness of the finally obtained silica cover layer of 1 to 40 nm, preferably 1 to 20 nm. An organosilicon compound or a silicic acid solution is added at an amount to make a thickness of the total of a silica protective membrane and a silica cover layer of 1 to 40 nm, preferably 1 to 20 nm, in the case that the silica protective membrane is formed.

Next, a dispersion of particles provided with a cover layer is subjected to an aging treatment. By an aging treatment, in the case of porous particles, a silica cover layer, which covers the surface of porous particles, becomes minute to prepare a dispersion of composite particles comprising porous particles covered with a silica cover layer. Further, in the case of a hollow particle precursor, the formed cover layer becomes minute to form a hollow particle wall, whereby a dispersion of hollow particles provided with a hollow, the interior of which is filled with a solvent, a gas or a porous solid, is prepared.

Thermal treatment temperature at this time is not specifically limited provided being so as to seal micro-pores of a silica cover layer, and is preferably in a range of 80 to 300° C. At a aging treatment temperature of lower than 80° C., a silica cover layer may not become minute to completely seal the micro-pores or the treatment time may become long. Further, when a prolonged treatment at a aging treatment temperature of higher than 300° C. is performed, particles may become minute and an effect of a low refractive index may not be obtained.

A refractive index of inorganic particles prepared in this manner is as low as less than 1.42. It is assumed that the refractive index becomes low because such inorganic particles maintain porous property in the interior of porous particles or the interior is hollow. The hollow particles preferably those having a polymer having hydrocarbon backbone co-valent bond to the surface, in view of stability when added into the coating composition.

The hollow microparticles to which a polymer having a hydrocarbon backbone is bonding is described. The polymer having a hydrocarbon backbone includes direct covalent bond, and those bonding agent is inserted between silica at a surface of the hollow silica particles and a polymer having a hydrocarbon backbone, whereby silica and bonding agent is covalent bonded and the bonding agent and the polymer is covalent bonded. A coupling agent is preferably employed as the bonding agent.

The hollow microparticles to which a polymer having a hydrocarbon backbone is bonding is prepared by a method, (1) reacting a polymer having a functional group capable of forming covalent bond with hollow silica particles surface in a state of the surface of the hollow silica particles being untreated or treated with a coupling agent, whereby polymer is grafted to the surface of the hollow silica particles, or (2) polymerizing monomers from the surface of the hollow silica particles to grow polymer chains in a state of the surface of the hollow silica particles being untreated or treated with a coupling agent, whereby the surface is grafted. Practical preparation method described in JP-A 2006-257308 may be employed.

The preferable method is that in which surface is grafted by polymerizing monomers from the surface of the hollow silica particles in view of improving surface modification ratio among the method described above. Further a method of surface graft is preferable in which hollow silica particles surface is treated with a coupling agent containing functional group having chain transfer performance, and monomers are polymerized from the surface and polymer chain is grown. An alkoxy metal compound such as a titanium coupling agent, alkoxysilane compound such as a silane coupling agent are preferably employed as a surface treatment agent (a coupling agent) to introduce a functional group having polymerization initiating performance or chain transfer performance into the hollow silica particles.

The hollow silica particles may comprises two or more species of hollow silica microparticles having different average particle diameter.

A coating composition for forming the layer of low refractive index at least other than hollow silica particles inside of which is porous or void is described.

It is preferable that pH of surface (layer) of the layer of low refractive index is control to 2 to 7, whereby a reaction within a layer of low refractive index is inhibited, and durability of anti-reflection film in a high temperature, high humidity condition is improved. Surface (layer) pH of the layer of low refractive index is more preferably 2 to 4. It is preferable to add at least one compound having pKa of 2 to 7 in a composition for forming the layer of low refractive index for controlling surface (layer) pH of layer of low refractive index. Here, pKa is a logarithm value of an acid dissociation constant Ka in the acid dissociation reaction mentioned below, that is, a value represented by pKa=−log₁₀ Ka.

HA [symbol] [H⁺][A⁻]

Ka=[H⁺][A⁻]/[HA]

Here, H⁺ is an acid, A⁻ is conjugate base.

Practical examples of a compound having at least one pKa value in a pKa range of 2 to 7 include an aliphatic dibasic acid and imidazole or derivative. Examples of imidazole or its derivative include 1-methylimidazole, 2-methylimidazole, 4-methylimidazole, 4-(2-hydroxy-ethyl)imidazole, 4-(2-aminoethyl)imidazole, 2-(2-hydroxy-ethyl)imidazole, 2-ethylimidazole, 2-vinylimidazole, 4-propylimidazole, 2,4-dimethylimidazole, 2-chloroimidazole, 4,5-di-(2-hydroxy-ethyl)imidazole and imidazole.

Examples of aliphatic dibasic acid include formic acid, propionic acid, malonic acid, succinic acid, tartaric acid, malic acid, maleic acid, fumaric acid, glutaric acid, adipic acid and acetic acid, and acetic acid is preferable among them.

An amount of aliphatic dibasic acid, imidazole or its derivative is preferably 0.05 to 10.0 percent by weight in the layer of low refractive index coating composition, from the view points of stability of a coating composition etc.

It is preferable that a coating composition forming the layer of low refractive index contains an organic solvent. Practical examples of the organic solvent include alcohols (such as methanol, ethanol, isopropanol, butanol, benzyl alcohol), ketone (such as acetone, methylethyl ketone, methylisobutyl ketone, cyclohexanone), esters (such as methyl acetate, ethyl acetate, propyl acetate, butyl acetate, methyl formate, ethyl formate, propyl formate, butyl formate), aliphatichydrocarbon (such as hexane, cyclohexane), chlorinated hydrocarbon (such as methylene chloride, chloroform, carbon tetrachloride), aromatic hydrocarbon (such as benzene, toluene, xylene), amides (such as dimethylformamide, dimethylacetoamide, n-methylpyrrolidone), ether (such as diethylether, dioxane, tetrahydrofuran), ether alcohols (such as 1-methoxy2-propanol), propyleneglycol monomethyl ether and propyleneglycol monomethyl ether acetate. Among them, toluene, xylene, methyl ethyl ketone, methyl isobutyl ketone, cyclohexanone, and butanol are particularly preferable.

Concentration of solid component part in a coating composition for forming the layer of low refractive index is preferably 1 to 4 percent by weight. When the concentration of solid component part is not less than 4 percent by weight it is difficult to concur uneven coating, and when 1 percent by weight or more, drying load is reduced.

It is preferable to incorporate a fluorine type or silicone type surfactant in a coating composition for forming the layer of low refractive index. It is effective to reduce coat unevenness or to improve anti-stain property of film surface by incorporating the above mentioned surfactant.

Examples of fluorine type surfactant include those having a mother structure of monomer, oligomer or polymer containing a perfluoro alkyl group, and concretely, polyoxyethylene alkylether, polyoxyethylene alkylarylether and polyoxyethylene their derivatives.

Fluorine type surfactant in the market may also be used, whose example includes, SURFLON S-381, S-382, SC-101, SC-102, SC-103 and C-104 (manufactured by ASAHI GLASS CO., LTD.), FLUORAD FC-430, FC-431 and FC-173 (manufactured by Fluoro Chemical-Sumitomo 3M), F-top EF352, EF301 and EF303 (manufactured by Shin Akita Kasei), Schwegofluor 8035 and 8036 (manufactured by Schwegman), BM1000, BM1100 (manufactured by BYM Japan KK), and MEGAFAC F-171 and F-470 (manufactured by DIC Corporation).

Ratio of fluorine content in fluorine type surfactant is 0.05 to 2 percent by weight, and preferably 0.1 to 1 percent by weight. One or two or more kinds of the above mentioned fluorine type surfactant may be used.

Next, silicone oil will be described.

The silicone oil is roughly divided into straight silicone oil and modified silicone oil, depending on the type of an organic group bonding to a silicon atom.

Straight silicone oil refers one to which a methyl group, a phenyl group and a hydrogen atom are bonded as a substituent. Modified silicone oil refers one having a constituent portion which is secondarily derived from straight silicone oil. From the other view point, classification can be made according to reactivity of silicone oil. These will be summarized as follows.

### Silicone Oil

### 1. Straight Silicone Oil

1-1. Non-reactive silicone oil: such as dimethyl, methyl or phenyl substituted
1-2. Reactive silicone oil: such as methyl or hydrogen substituted

### 2. Modified Silicone Oil

Modified silicone oil is one formed by introducing various organic groups into dimethyl silicone oil.

2-1. Non-reactive silicone oil: such as alkyl, alkyl/aralkyl, alkyl/polyether, polyether or higher aliphatic acid ester substituted

Alkyl/aralkyl modified silicone oil is silicon oil in which a part of methyl groups of dimethyl silicone oil is substituted by a long-chain alkyl group or a phenylalkyl group.

Polyether modified silicone oil is a surfactant in which a hydrophilic polyoxyalkylene is introduced into hydrophobic dimethylsilicone.

Higher fatty acid modified silicone oil is silicone oil in which a part of methyl groups of dimethylsilicone oil is substituted with higher aliphatic acid ester.

Amino modified silicone oil is silicone oil having a structure in which a part of methyl groups of the silicone oil is substituted by an amino alkyl group.

Epoxy modified silicone oil is silicone oil having a structure in which a part of methyl groups of the silicone oil is substituted by an alkyl group containing an epoxy group.

Carboxyl modified or alcohol modified silicone oil is silicone oil having a structure in which a part of methyl groups of the silicone oil is substituted by a carboxyl group or an alkyl group containing a hydroxide group.

Among them, preferably added is polyether modified silicone oil. The number average molecular weight of polyether modified silicone oil is, for example, 1,000 to 100,000 and preferably 2,000 to 50,000. Drying characteristics of the coated layer is not sufficient when the number average molecular weight is not more than 1,000, and it is hard to bleed out on the surface when number average molecular weight is more than 100,000.

Examples of specific commercial products include; L-45, L-9300, FZ-3704, FZ-3703, FZ-3720, FZ-3786, FZ-3501, FZ-3504, FZ-3508, FZ-3705, FZ-3707, FZ-3710, FZ-3750, FZ-3760, FZ-3785, FZ-3785 and Y-7499 (manufactured by Nippon Unicar Company Limited), KF96L, KF96, KF96H, KF99, KF54, KF965, KF968, KF56, KF995, KF351, KF351A, KF352, KF353, KF354, KF355, KF615, KF618, KF945, KF6004 and FL100 (manufactured by Shin-Etsu Chemical Co., Ltd.), surfactants BYK series, BYK-300/302, BYK-306, BYK-307, BYK-310, BYK-315, BYK-320, BYK-322, BYK-323, BYK-325, BYK-330, BYK-331, BYK-333, BYK-337, BYK-340, BYK-344, BYK-370, BYK-375, BYK-377, BYK-352, BYK-354, BYK-355/356, BYK-358N/361N, BYK-357, BYK-390, BYK-392, BYK-UV3500, BYK-UV3510, BYK-UV3570 and BYK-SILCLEAN 3700 (manufactured by BYK Japan KK), and XC96-723, YF3800, XF3905, YF3057, YF3807, YF3802 and YF3897 (manufactured by GE Toshiba Silicone).

The silicone surfactant is a surfactant in which a part of methyl groups of silicone oil is substituted by a hydrophilic group. The positions of substitution are such as a side chain, the both ends, one end and the both terminal side chains. As a hydrophilic group, utilized are such as polyether, polyglycerin, pyrrolidone, betaine, sulfate, phosphate and quaternary salt.

A nonionic surfactant in which a hydrophobic group is constituted of dimethylpolysiloxane and a hydrophilic group is constituted of polyoxyalkylene.

The nonionic surfactant generally refers to a surfactant not provided with a group which dissociates into ion in an aqueous solution, however, is provided with a hydroxyl group of polyhydric alcohols as a hydrophilic group in addition to a hydrophobic group or a hydrophilic group such as a polyalkylene chain (polyoxyethylene). Hydrophilic property becomes stronger as the number of an alcoholic hydroxyl group becomes larger or as the polyoxyalkylene chain (polyoxyethylene chain) becomes longer. When a nonionic surfactant constituted of dimethylpolysiloxane as a hydrophobic group and polyoxyalkylene as a hydrophilic group is used, unevenness in the layer of low refractive index is decreased and anti-staining property of the film surface is improved. It is considered that a hydrophobic group constituted of polysiloxane is oriented on the surface to form a film surface being hardly stained.

Practical examples of these nonionic surfactants include such as silicone surfactants SILWETL-77, L-720, L-7001, L-7002, L-7604, Y-7006, FZ-2101, FZ-2104, FZ-2105, FZ-2110, FZ-2118, FZ-2120, FZ-2122, FZ-2123, FZ-2130, FZ-2154, FZ-2161, FZ-2162, FZ-2163, FZ-2164, FZ-2166, FZ-2191, SUPERSILWET SS-2801, SS-2802, SS-2803, SS-2804 and SS-2805 (manufactured by Nippon Unicar Company Limited).

Further, a structure of a nonionic type surfactant, which is constituted of dimethylpolysiloxane as a hydrophobic group and polyoxyalkylene as a hydrophilic group, is preferably block copolymer of a straight chain form in which a dimethylpolysiloxane portion and a polyoxyethylene chain are alternately and repeatedly bonded. It is preferred in view of inhibiting non-uniformity when a coating composition forming a layer of low refractive index is applied or leveling property. Practical examples thereof include such as silicone surfactants ABN SILWET FZ-2203, FZ-2207 and FZ-2208, manufactured by Nippon Unicar Co., Ltd.

The coating composition to form a low refractive index may contain a reactive modified silicone resin (referred as reactive modified silicone oil) as described later.

2-2. Reactive Modified Silicone Oil: Substituted by Amino, Epoxy, Carboxyl, and Alcohol.

The reactive modified silicone resin is a reactive type modified silicone resin in which side chain, single end or both ends of polysiloxane is substituted with amino, epoxy, carboxyl, a hydroxy group, methacryl, mercapto, phenol and so on. Examples of amino-modified silicone resin include practically KF-860, KF-861, X-22-161A and X-22-161B (all manufactured by Shin-Etsu Chemical Co., Ltd.) and FM-3311 and FM-3325 (both manufactured by Chisso Corporation); epoxy modified silicone resin includes KF-105, X-22-163A, X-22-163B, KF-101 and KF-1001 (all manufactured by Shin-Etsu Chemical Co., Ltd.); polyether-modified silicone resin includes X-22-4272 and X-22-4952; carboxyl-modified silicone resin includes X-22-3701E and X-22-3710 (all manufactured by Shin-Etsu Chemical Co., Ltd.); carbinol-modified silicone resin includes KF-6001 and KF-6003 (all manufactured by Shin-Etsu Chemical Co., Ltd.); methacryl-modified silicone resin includes X-22-164C (all Shin-Etsu Chemical Co., Ltd. manufactured by), mercaptomodified silicone resin includes KF-2001 (manufactured by Shin-Etsu Chemical Co., Ltd.); and phenolmodified silicone resin includes X-22-1821 (manufactured by Shin-Etsu Chemical Co., Ltd.). Example of a hydroxy group modified silicone resin includes FM-4411, FM-4421, FM-DA21 and FM-DA26 (all manufactured by Chisso Corporation). In addition thereto single end reaction type silicone resins, X-22-170DX, X-22-2426 and X-22-176F (manufactured by Shin-Etsu Chemical Co., Ltd.) are included.

The surfactant mentioned above can be used in combination with another surfactant, or anionic surfactant such as sulfonate type, sulfuric acid ester salt type, phosphoric acid ester salt type, or ether type having polyoxyethylene chain hydrophilic group, etherester type, and a nonionic surfactant, optionally. Amount of the surfactant mentioned above is preferably 0.05 to 3.0 percent by weight in the coating composition of the layer of low refractive index, from the view points of enhancing repellency to water or oil and anti-stain property of the film and displaying anti-abrasion performance.

Other types of silica particles can be incorporated in a coating composition for forming the layer of low refractive index. The other types of silica particles are not particularly limited, and include colloidal silica and so on. Practical example of colloidal silica is a dispersion of silicon dioxide as a colloid state in water or an organic solvent, in a shape of sphere needle or necklace, but not particularly limited.

An average particle diameter of the colloidal silica is preferably 50 to 300 nm, and monodispersion having coefficient of variation of 1 to 40% is preferable. The average particle diameter can be measured by electron microscope picture via a scanning electron microscope (SEM) etc. It can be measured via particle size distribution meter and so on employing dynamic light-scattering method or static light-scattering method.

Colloidal silica is put in the market, for example, SNOWTEX series from Nissan Chemical Industries, Ltd., CATALOID-S series from JGC Catalysts and Chemicals Ltd., and LEVASIL series from Bayer. Further, colloidal silica cationic modified by alumina sol or aluminum hydroxide, and necklace shaped colloidal silica prepared by linking primary particles of silica via bonding between particles with two or more valent metal ion connecting in necklace shape, are preferably employed. The necklace shaped colloidal silica includes, for example, SNOWTEX AK series, SNOWTEX PS series and SNOWTEX UP series from Nissan Chemical Industries, Ltd., concretely includes IPS-ST-L (isopropanol dispersion, particle diameter of 40 to 50 nm, silica concentration of 30%), MEK-ST-MS (methylethyl ketone dispersion, particle diameter of 17 to 23 nm, silica concentration of 35%). In case of incorporating the colloidal silica in the coating composition for forming the layer of low refractive index, the amount is preferably 10 to 60 percent by weight, further 30 to 60 percent by weight with respect to solid component part of the layer of low refractive index, from a view point of film strength.

The other inorganic microparticles may be incorporated, for example, MgF₂. Practically, MFS-10P (magnesium fluoride sol dispersed in isopropyl alcohol, particle diameter of 100 nm) and NF-10P manufactured by Nissan Chemical Industries, Ltd. etc., are mentioned.

The coating composition for forming the layer of low refractive index preferably contains a binder in an amount of 5 to 80 percent by weight with respect to solid component part in the layer of low refractive index. The binder has a function to adhere particles such as hollow silica particles and maintains structure of layer of low refractive index having voids. Amount of the binder is adjusted so as to maintaining strength of the layer of low refractive index without filling the voids.

The binder includes an alkoxymetal compound and hydrolysis product or its polycondensation compound, and, polyvinyl alcohol, polyoxy ethylene, polymethylmethacrylate, polymethylacrylate diacetyl cellulose, triacetylcellulose, nitrocellulose, polyester, alkyd resin, fluoroacrylate, a fluorine containing polymer, and so on. The fluorine polymer includes, for example, fluoro olefins such as fluoro ethylene, vinylidene fluoride, tetrafluoro ethylene, perfluorooctyl ethylene, hexafluoropropylene and perfluoro-2,2-dimethyl-1,3-dioxole, and a partial or complete fluorinated alkyl ester derivatives of(meth)acrylic acid such as VISCOAT 6FM (manufactured by Osaka Organic Chemical Industry Ltd.) and M-2020 (manufactured by Daikin Industries, Ltd.), and partial or complete fluorinated vinylethers. The preferable are perfluoro olefins, and hexafluoropropylene is particularly preferable from the view points of refractive index, solubility, transparency and availability.

An organic silicon compound or its hydrolysis product or its polycondensation compound, which is described in an item of layer of high refractive index, is particularly preferable as the alkoxymetal compound from the view points of an excellent property of binding hollow silica particles.

The layer of low refractive index may be incorporated with a compound represented by following Formula (γ), or its chelate compound, whereby material property such as hardness can be improved.

AₙMBₓ₋ₙ (γ)

In the formula, M is a metal atom, A is a hydrocarbon group having a hydrolyzable functional group or a hydrolyzable functional group, B is an atomic group metal covalent bonded or ion bonded to the atom M. Symbol x is a valence of metal atom M, n is an integer not more than x; and 2 or more.

Examples of hydrolyzable functional group A include, for example, alkoxyl group, halogen such as chlorine atom, an ester group and an amido group.

The metal compound belonging to above mentioned Formula (γ) includes alkoxide having two or more alkoxyl groups bonded directly to the metal atom, or its chelate compound. The preferable metal compound includes titanium alkoxide, zirconium alkoxide, and aluminum alkoxide or its chelate compound.

A chelating agent coordinating a free metal compound to form a chelate compound is preferably alkanol amines such as diethanol amine and triethanolamine, glycols such as ethyleneglycol, diethyleneglycol and propylene glycol, acetyl acetone and ethyl acetoacetate, having molecular weight of not more than 10,000. By employing the chelating agents, a chelate compound can be formed, which is stable against contamination with water and excellent in reinforcement of coating layer. An amount of the above mentioned chelate compound is preferably adjusted to be 0.3 to 5 percent by weight in the layer of low refractive index. When the amount of the chelate compound is not more than 0.3 percent by weight, anti-abrasion properties is insufficient and when exceeding 5 percent by weight, there is a tendency that stability against light deteriorates.

The layer of low refractive index may be formed by coating above mentioned coating composition to form the layer of low refractive index employing a conventional method such as a gravure coater, a dip coater, a reverse coater, a wire bar coater, a die coater, and an inkjet method, heat drying after coating and, curing processing, if necessary.

The coating amount is suitably 0.05 to 100 μm in terms of wet thickness, and preferably, 0.1 to 50 μm. Concentration of solid component part of the coating composition is adjusted so that the dry thickness satisfies the above mentioned layer thickness.

After forming the layer of low refractive index, a process conducting heat treatment at a temperature of 50 to 160° C. may be included. Terms for heat treatment can be determined according to the temperature applied optionally, for example, preferably from 3 days to 30 days, at 50° C., and 10 minutes to 1 day at 160° C. The curing methods include a method applying heat, a method by light irradiation such as UV ray. Heat temperature is preferably 50 to 300° C., and more preferably 60 to 250° C., particularly preferably 80 to 150° C. in case of heat curing. Light exposure of the light irradiation is from 10 mJ/cm² to 10 J/cm², and more preferably 100 mJ/cm² to 500 mJ/cm², in case of curing by light irradiation.

Wave length region of the irradiation light is not particularly limited, and light having UV ray region wave length is preferably employed. Practically, a low-pressure mercury vapor lamp, a medium-pressure mercury vapor lamp, a high-pressure mercury vapor lamp, an ultrahigh-pressure mercury vapor lamp, a carbon arc lamp, a metal halide lamp and a xenon lamp may be employed. The preferable irradiation quantity of light may be changed depending on the type of lamps, however, it is preferably from 5 to 150 mJ/cm², and more preferably from 20 to 100 mJ/cm².

It is preferable that a transparent film substrate having width of 1.4 to 4 m is unwound from wound state as roll shape, and each layer is formed by coating, and it is wound in roll shape after drying-curing processing. It is preferable to manufacture by conducting thermal processing at 50 to 160° C. in a wound state in a roll shape in view of efficiency of long film coating of an anti-reflection film or stability. Terms for heat treatment can be determined according to the temperature applied optionally, for example, preferably from 3 days to 30 days, at 50° C., and 10 minutes to 1 day at 160° C. It is preferable to set as relatively low temperature so that the effect of the aging treatment is not be unbalances at the outer part, middle part and core part of the roll, and it is preferable to conduct around 50 to 60° C. for 7 days, usually.

Aging treatment is preferably performed at a place capable of controlling temperature and humidity for stable treatment, for example, a thermal processing clean room.

A winding core, on which a hard coat film or an anti-reflection film is wound in a roll shape, is not particularly limited, as far as cylindrical core, and is preferably a hollow plastic core, and the plastic material is heat resistance plastic to endure thermal processing is preferable, example of which includes resins such as a phenol resin, a xylene resin, a melamine resin, a polyester resin and an epoxy resin. Further thermocurable resin reinforced by fillers such as glass fiber is preferable. A number of winding on the core is preferably 100 windings or more, and more preferably 500 windings or more, and thickness of winding is preferably 5 cm or more.

### (Reflectance of Anti-Reflection Film)

Reflectance of the above mentioned anti-reflection film can be measured via spectrophotometer. After roughening the side opposite to measuring surface of the sample, light absorbing process is conducted by black paint spray, reflected light of visible light region (400 to 700 nm) is measured, in this instance. The reflectance is lower, the more preferable film is. Average value visible light region in the visible light wave length is preferably not more than 2.5%, and minimum reflectance is preferably not more than 1.5%. It is preferable to have a flat reflection spectrum in wave length region of visible light.

The reflected color of a surface of a display device having subjected to anti-reflection treatment is liable to have red or blue color because reflectance in short wave length region or long wave length region within visible light region due to arrangement of anti-reflection layer is higher. Hue of reflected light varies depending on the use, and neutral color is favoritely acceptable used in the uppermost layer of thin television etc.

Favoritely acceptable reflected color area is, in general, on the XYZ colorimetric system (CIE 1931 colorimetric system)

0.17≦x≦0.27, and

0.07≦y≦0.17.

Thickness each of the layer of high refractive index and the layer of low refractive index is obtained by calculation according to common method considering reflectance and color of reflected light from refractive index of each layer.

### (Surface Treatment)

Surface treatment may be conducted before applying the above mentioned each layer. The surface treatment method includes a washing method, an alkali treatment method, a flame plasma treatment method, a high-frequency discharge plasma method, an electron beam method, an ion beam method, a spattering method, an acid treatment method, a corona treatment method and an atmospheric glow discharge plasma method.

The corona treatment is a treatment in which high voltage of 1 kV or higher is applied between electrodes at atmospheric pressure to discharge. Apparatus in the market, for example, those manufactured by Kasugai Electric Works, Ltd and Toyo Electric Co., Ltd. can be employed. Intensity of corona discharge depends on distance between the electrodes, power per unit area and frequency of generator.

As for one electrodes (electrode A), those obtained from market can be used, and the material thereof is selected from aluminum, stainless steel etc. The other electrode is an electrode holding the plastic film and is a roll electrode provided at a position of predetermined distance from the aforementioned electrode A so that the corona treatment is conducted stably and uniformly. This electrode is also obtained from the market. The rolls having a core roll of materials such as aluminum and stainless steel which is lining processed with ceramics, silicone, EPT rubber, hyperons rubber etc. are preferably employed. Frequency used in the corona treatment is 20 kHz to 100 kH, and is preferably 30 kHz to 60 kHz. When the frequency is low, uniformity of corona treatment is deteriorated, non-uniformity of corona treatment occurs. When the frequency is high, though there is no problem in case of high out put power corona treatment particularly, it is difficult to conduct stable treatment and non-uniformity occurs in case of low power corona treatment. Output power of corona treatment is 1 to 5 W min/m² and preferably 2 to 4 W min/m². Distance between the electrode and film is 5 mm to 50 mm, and preferably 10 mm to 35 mm. When the gapping is wide, high voltage is necessary to maintain constant output and non-uniformity is apt to generate. When the gapping is too narrow, applying voltage is too low and non-uniformity is apt to generate. In addition thereto, defects occur during conveyance of continuous processing.

An alkali aqueous solution useable for the alkali treatment method includes sodium hydroxide aqueous solution, potassium hydroxide aqueous solution, ammonia aqueous solution etc., among those, sodium hydroxide aqueous solution is preferable.

As for alkali concentration of the alkali aqueous solution, for example, sodium hydroxide concentration of is preferably 0.1 to 25 percent by weight, and 0.5 to 15 percent by weight is more preferable. Temperature of alkali treatment is usually 10 to 80° C., and preferably 20 to 60° C.

Time for alkali treatment is 5 seconds to 5 minutes, and preferably 30 seconds to 3 minutes. The film is preferably neutralized with acid solution and washed sufficiently after alkali treatment.

(Transparent Film Substrate)

Next, a transparent film substrate used in the present invention is described.

As a requirement for a transparent film substrate to be easy in a production, to have a good adhesive property with a hard coat layer, to be optically isotropy and to be transparent optically are listed.

Transparency refers to visible light transmittance of 60 percent or more, preferably 80 percent or more, and most preferably 90 percent or more.

The transparent film substrate is not particularly limited as long as the films exhibit the properties described above. Examples include cellulose ester based film such as cellulose diacetate film, cellulose triacetate film, cellulose acetate propionate film, and cellulose acetate butylate film, polyester based film, polycarbonate based film, polyallylate based film, polysulfone (including polyester sulfone) based film, polyester film such as polyethylene terephthalate or polyethylene naphthalate, polyethylene film, polypropylene film, cellophane, polyvinylidene chloride film, polyvinyl alcohol film, ethylene vinyl alcohol film, cyndioctatic polystyrene based film, cycloolefin polymer film such as ARTON (manufactured by JSR Co.), ZEONEX and ZEONARE (both manufactured by Zeon Corp.), polyvinyl acetal, polymethylpentane film, polyether ketone film, polyether ketone imide film, polyamide film, fluorine resin film, nylon film, polymethyl methacrylate film, acryl film, or glass plates. Of these, preferred are cellulose ester based film, polycarbonate based film, and polysulfone (including polyethersulfone) based film. In the present invention, from the viewpoint of production, cost, transparency, and adhesion property, preferably employed is cellulose ester film (e.g., Konica Minolta TAC, a trade name of KC8UX, KC4UX, KC5UX, KC8UCR3, KC8UCR4, KC8UCR5, KC8UY, KC4UY, KC4UE and KC12UR manufactured by Konica Minolta Opto, Inc.).

These films may be film produced by melt-casting type film formation or film produced by solution-casting type film formation.

Cellulose ester based film is preferably used as a transparent film substrate. As cellulose ester, preferably used are cellulose acetate, cellulose acetate butyrate and cellulose acetate propionate, cellulose acetate butyrate film, of them, more preferably used are cellulose acetate butyrate, cellulose acetate phthalate and cellulose acetate propionate.

Specifically, a transparent substrate film containing a mixed aliphatic acid ester of cellulose having X and Y in the below ranges can be preferably employed, wherein X represents a degree of substitution of an acetyl group, while Y represent a degree of substitution of a propionyl group or a butyryl group,

2.3≦X+Y≦3.0

0.1≦Y≦2.0

Especially, 2.5≦X+Y≦2.9, and 0.3≦Y≦1.2 are more preferable.

The cellulose ester film, as a preferable transparent resin film, is described in detail.

The cellulose ester film preferably has free volume radius by a positron annihilation life time method of 0.250 to 0.310 nm to obtain an excellent anti-reflection film having little deformation of substrate by heat treatment and excellent flatness. It is further preferable the cellulose ester film has a total free volume parameter of 1.0 to 2.0.

The free volume mentioned above represents a void part which is not occupied by a molecular chain of the transparent resin film. This can be measured by a positron annihilation life time method practically. Time from injection of positron into a sample to annihilation is measured and information such as concerning atomic hole, size of free volume, number concentration are obtained by nondestructively observation from the annihilation life time. (Measurement of free volume radius free volume radius and total free volume parameter by positron annihilation life time method)

The positron annihilation life time and relative intensity is measured by the following condition.

### (Measurement Condition)

Positron beam source: 22 NaCl (Intensity: 1.85 MBq)
Gamma ray detector: Plastic scintillator in combination of photomultiplier
Apparatus time resolution: 290 ps
Measuring temperature: 23° C.
Total count number: 10,000,000 counts
Sample size: 20 mm×15 mm

Twenty pieces of samples cut into a size of 20 mm×15 mm are compiled to have a thickness of 2 mm. The sample is subjected to vacuum drying for 24 hours.

Irradiation area: Around 10 mm□

Time per channel: 23.3 ps/channel
Positron annihilation life time is measured by the above mentioned condition, 3 components analysis by non-linear least square method is conducted to set as τ1, τ2 and τ3 from short annihilation life time and corresponding intensity of I1, I2, I3 (I1+I2+I3=100%).

Free volume radius R³ (nm) is measured by the following formulas from an average annihilation life time τ3 having longest life time. τ3 corresponds to positron annihilation in the voids, and it is considered that the τ3 is larger, the void size is larger.

τ3=(½)[1−{R³/(R³+0.166)}+(½π)sin {2πR³/(R³+0.166)}]⁻¹

Here, 0.166 (nm) corresponds to thickness of electron layers leached out from wall of the void.

The total free volume parameter Vp is obtained by the following formulas.

V3={4/3)π(R³)³}(nm³)

Vp=I3(%)×V3(nm³)

Here I3 (%) corresponds to a relative number concentration of the voids, and Vp corresponds to relative void volume.

The above mentioned measurement was conducted twice and the average value was obtained.

As for the positron annihilation life time method “Evaluation of free volume of polymer by for positron annihilation” is described in MATERIAL STAGE vol. 4, No. 5, 2004, p 21-25, Toray Research Center, Inc., THE TRCNEWS, No. 80 (Jul. 2002) p 20-22, and “BUNSEKI (Analysis)” (1988, pp. 11-20), for example, and these may be referred.

Free volume radius of the cellulose ester film is 0.250 to 0.315 nm, preferably 0.250 to 0.310 nm, and more preferably 0.285 to 0.305 nm. The free volume radius is not more than 0.250 nm. When the free volume radius is 0.250 to 0.315 nm, substrate deformation by heat treatment is little and clear hard coat film and anti-reflection film having excellent flatness are obtained.

Cellulose as a starting material of cellulose ester utilized in this invention is not specifically limited, and includes such as cotton linter, wood pulp (obtained from acicular trees or from broad leaf trees) and kenaf. Further, cellulose ester prepared from them can be utilized by mixing each of them at an arbitrary ratio. Cellulose ester, in the case that an acylation agent as a cellulose starting material is acid anhydride (such as acetic anhydride, propionic anhydride, and butyric anhydride), is prepared by a reaction utilizing a proton type catalyst such as sulfuric acid in an organic acid such as acetic acid or in an organic solvent such as methylene chloride.

In the case that an acylation agent is acid chloride (CH₃COCl, C₂H₅COCl or C₃H₇COCl), the reaction is performed utilizing a basic compound such as amine as a catalyst. Specifically, the synthesis can be performed referring to a method described in JP-A H10-45804.

The cellulose ester used in the present invention is obtained through a reaction using in combination of the above acylation agents depending on the acylation degree. In an acylation reaction to form a cellulose ester, an acyl group reacts with the hydroxyl group of a cellulose molecule. A cellulose molecule is made up of many glucose units connected each other, and a glucose unit contains three hydroxyl groups. The number of hydroxyl groups substituted by acyl groups in a glucose unit is referred to as a degree of acetyl substitution (in mol %). For example, in the case of cellulose triacetate, all the three hydroxyl groups in one glucose unit are substituted by acetyl groups (practically: 2.6 to 3.0).

Measurement of a degree of substitution of an acyl group can be performed based on ASTM-D817-96.

The number average molecular weight of cellulose ester is preferably 50,000-250,000, because a mechanical strength at the time of film forming becomes strong, and a dope solution becomes proper viscosity, and more preferably 80,000-150,000.

The cellulose ester is preferably produced by a method generally called as a solution casting film forming method in which a cellulose ester solution (dope) is cast (Casting) onto a casting supporter such as an endless metal belt transported infinitely or a rotating metal drum casting) of the dope solution, and carrying out film production through a pressure die.

As an organic solvent used for preparing the dope solutions, it is preferred for the organic solvent to be able to dissolve cellulose ester and to have a moderate boiling point, for example, methylene chloride, methyl acetate, ethyl acetate, amyl acetate, methyl acetoacetate, acetone, tetrahydrofuran, 1,3-dioxolane, 1,4-dioxane, cyclohexanone, ethyl formate, 2,2,2-trifluoro ethanol, 2,2,3,3-tetrafluoro-1-propanol, 1,3-difluoro-2-propanol, 1,1,1,3,3,3-hexafluoro-2-methyl-2-propanol, 1,1,1,3,3,3-hexafluoro-2-propanol, 2,2,3,3,3-pentafluoro-1-propanol, nitroethane, 1,3-simethyl-2-imidazolidinone, and organic solvent such as methylene chloride, dioxolan derivatives, methyl acetate, ethyl acetate, acetone, methyl acetoacetate and so on are mentioned as a preferable organic solvents (i.e., good solvent).

Further, as shown in the following film-production process, when drying a solvent from the web (dope film) formed on a casting support in a solvent evaporation process, from a viewpoint of preventing foaming in the web, as a boiling point of the organic solvent used, 30 to 80° C. is preferable, for example, the boiling point of the above-mentioned good solvents are methylene chloride (40.4° C. of boiling points), methyl acetate (56.32° C. of boiling points), acetone (56.3° C. of boiling points), an ethylacetate (76.82° C. of boiling points), etc.

Among the above-mentioned good solvents, methylene chloride or methyl acetate which is excellent in solubility may be used preferably.

In a dope used in the present invention, 0.1 to 40 percent by weight of alcohol having a carbon number of 1 to 4 is preferably added in addition to the above described organic solvent. In particular, the above alcohol is preferably contained in an amount of 5 to 30 percent by weight.

The solvent starts to evaporate from the web after casting a dope on a support, the relative concentration of alcohol becomes higher and the web begins to gelate. The gelation increases the mechanical strength of the web and makes it easier to peel the web from the support. A smaller concentration of alcohol in a dope may contribute to increase a solubility of cellulose ester in a non-chlorine based organic solvent. Typical alcohols of 1 to 4 carbon atoms are methanol, ethanol, n-propanol, iso-propanol, n-butanol, sec-butanol, and tert-butanol.

Among these solvents, ethanol is preferable, because the stability of a dope solution is preferable, a boiling point is also comparatively low, drying characteristics are also preferable, and there is no toxicity. It is preferable to use a solvent which contains ethanol 5% to 30% by mass to 70% to 95% by mass of methylene chloride. Methyl acetate can also be used instead of methylene chloride. The dope solution may be prepares with a cooling solution process in this instance.

The cellulose ester film is preferably to contain the following plasticizers. As the plasticizers, for example, a phosphate type plasticizer, a polyhydric alcohol ester type plasticizer, a phthalate ester type plasticizer, a trimellitic acid ester type plasticizer, a pyromellitic acid type plasticizer, a glycolate type plasticizer, a citrate ester type plasticizer, a polyester type plasticizer, a fatty acid ester type plasticizer, a polycarboxylic-acid ester type plasticizer, etc. can be used preferably.

Among them, a polyhydric alcohol ester type plasticizer, a phthalate ester type plasticizer, a citrate ester type plasticizer, a fatty acid ester type plasticizer, a glycolate type plasticizer, a polycarboxylic-acids ester type plasticizer, etc. are preferable. Particularly, a polyhydric alcohol ester type plasticizer is preferably used, because the pencil hardness of 4H or more can be obtained stably for a hard coat layer.

A polyhydric alcohol ester type plasticizer is a plasticizer composed of an ester of an aliphatic polyhydric alcohol having a valence of two or more and monocarboxylic acid, and preferably contains an aromatic ring or a cycloalkyl ring in a molecule. It is preferably an aliphatic polyhydric alcohol ester of 2 to 20 valent.

A polyhydric alcohol used in the present invention is represented by Formula (1)

R₁—(OH)ₙ Formula (1)

(R₁ represents an organic acid having a valence of n, n is a positive integer of 2 or more, and an OH group represents an alcoholic and/or phenolic hydroxyl group.)

Examples of a preferable polyhydric alcohol are listed below, however, the present invention is not limited thereto.

Adonitol, arabitol, ethylene glycol, diethylene glycol, triethylene glycol, tetraethylene glycol, 1,2-propanediol, 1,3-propanediol, dipropylene glycol, tripropylene glycol, 1,2-butanediol, 1,3-butanediol, 1,4-butanediol, dibutylene glycol, 1,2,4-butanetriol, 1,5-pentanediol, 1,6-hexanediol, hexanetriol, galactitol, mannitol, 3-methylpentane-1,3,5-triol, pinacol, sorbitol, trimethylolpropane, trimethylolethane, xylitol, etc. can be listed. In particular, triethylene glycol, tetraethylene glycol, dipropylene glycol, tripropylene glycol, sorbitol, trimethylolpropane, and xylitol are preferable.

A mono carboxylic acid to be used for the polyhydric alcohol ester is not specifically limited, and known compounds such as aliphatic monocarboxylic acid, alicyclic monocarboxylic acid and aromatic monocarboxylic acid may be used. Alicyclic monocarboxylic acid or aromatic monocarboxylic acid is preferably used with respect to improving moisture permeability and retention of additives.

Examples of preferable monocarboxylic acids are listed below, however, the present invention is not limited thereto.

As fatty acid monocarboxylic acid, fatty acid having a straight chain or a branched chain of carbon number of 1 to 32 can be preferably utilized. The carbon number is more preferably 1 to 20 and specifically preferably 1 to 10. It is preferable to incorporate acetic acid because of increasing compatibility with cellulose ester, and it is also preferable to utilize acetic acid and other monocarboxylic acid by mixing.

Preferable monocarboxylic acid includes saturated fatty acid such as acetic acid, propionic acid, butyric acid, valeric acid, caproic acid, enanthic acid, caprylic acid, pelargonic acid, capric acid, 2-ethyl-hexanoic acid, undecylic acid, lauric acid, tridecylic acid, myristic acid, pentadecylic acid, palmitic acid, heptadecylic acid, stearic acid, noandecanoic acid, arachic acid, behenic acid, lignoceric acid, cerotic acid, heptacosanoic acid, montanic acid, melissic acid and lacceric acid; and unsaturated fatty acid such as undecylenic acid, oleic acid, sorbic acid, linoleic acid, linolenic acid and arachidonic acid.

Examples of preferable alicyclic monocarboxylic acids include: cyclopentanecarboxylic acid, cyclohexanecarboxylic acid, cyclooctanecarboxylic acid, and derivatives thereof.

Examples of preferable aromatic monocarboxylic acid include those in which 1 to 3 of alkoxy groups such as an alkyl group, a methoxy group or an ethoxy group are introduced into a benzene ring of such as benzoic acid and toluic acid, aromatic carboxylic acid having at least two benzene ring such as biphenyl carboxylic acid, naphthalene carboxylic acid and tetralin carboxylic acid, or derivatives thereof. Benzoic acid is specifically preferable.

The molecular weight of the polyhydric alcohol ester is not limited, however, the molecular weight is preferably from 300 to 1,500 and more preferably from 350 to 750. A higher molecular weight is preferable in that the volatility of the polyhydric alcohol is reduced, while a lower molecular weight is preferable with respect to moisture permeability, or to compatibility with cellulose ester.

The carboxylic acid can be used singly or mixture of two or more in combination. Hydroxy groups in the polyhydric alcohol may be esterified all or partly remaining in a form of OH.

In the following, practical examples of polyhydric alcohol are exemplified.

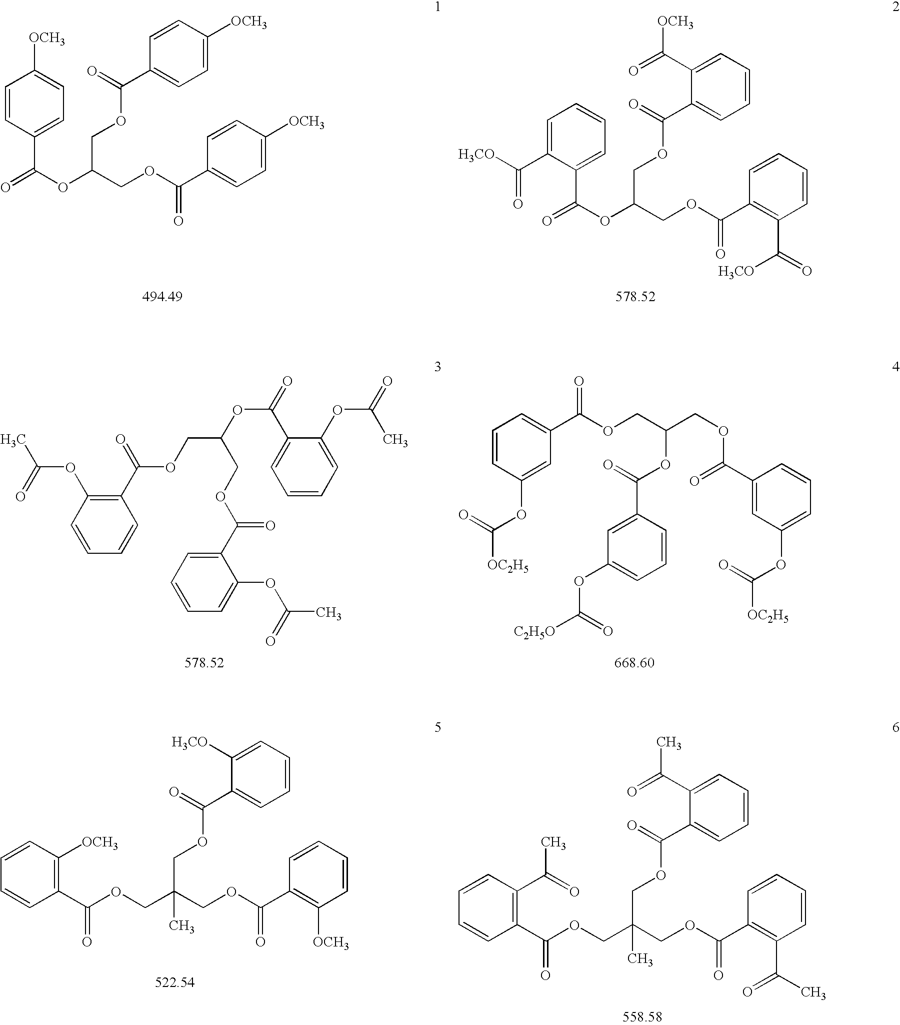

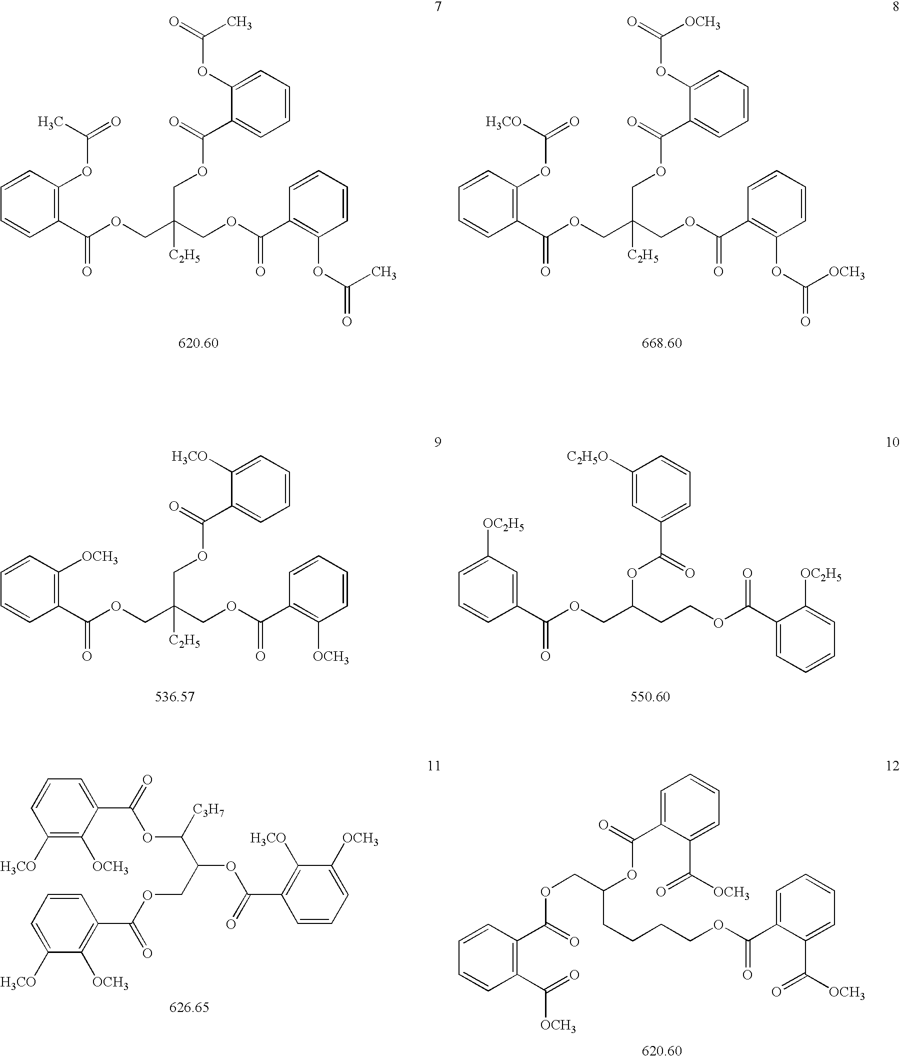

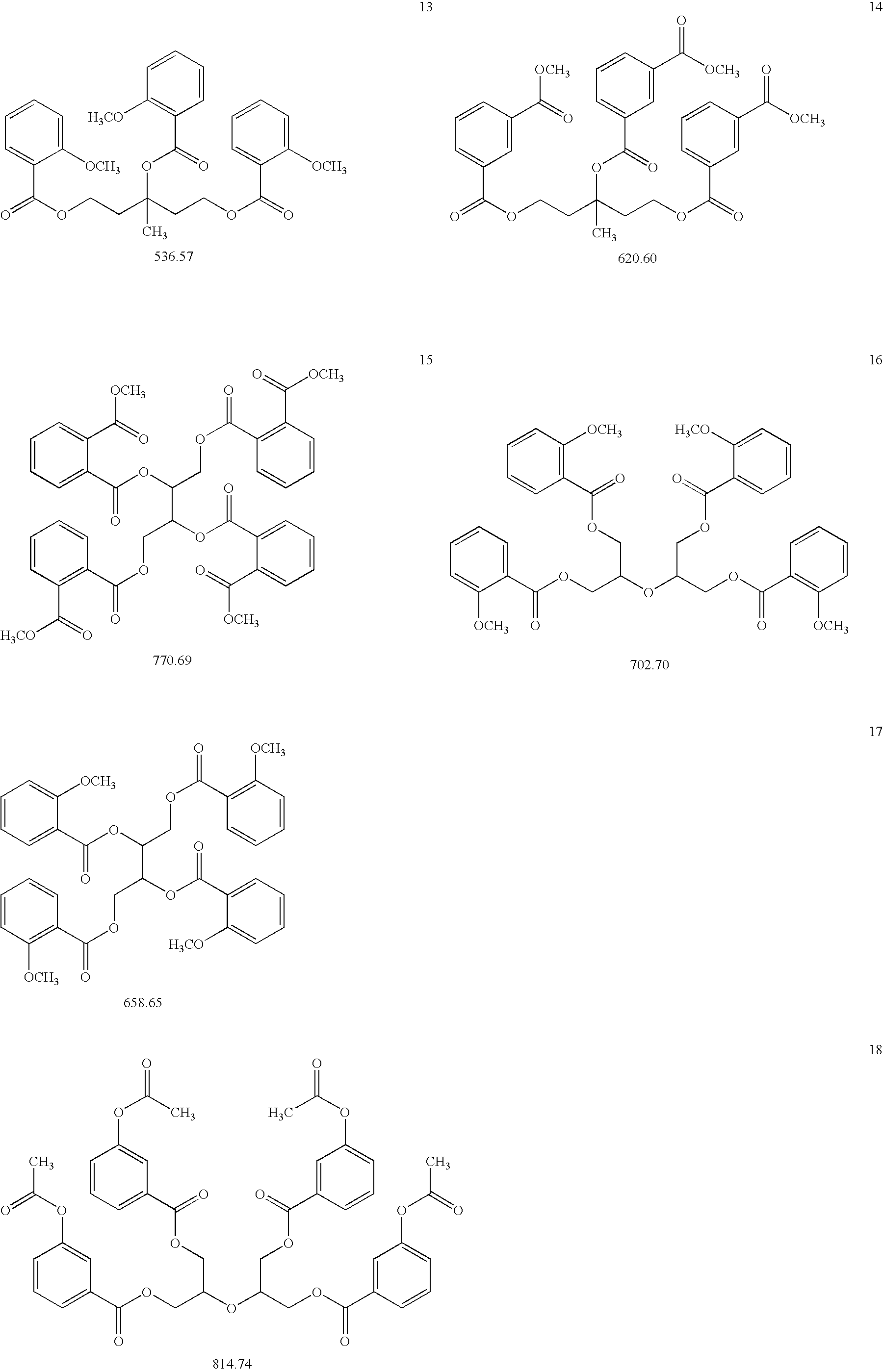

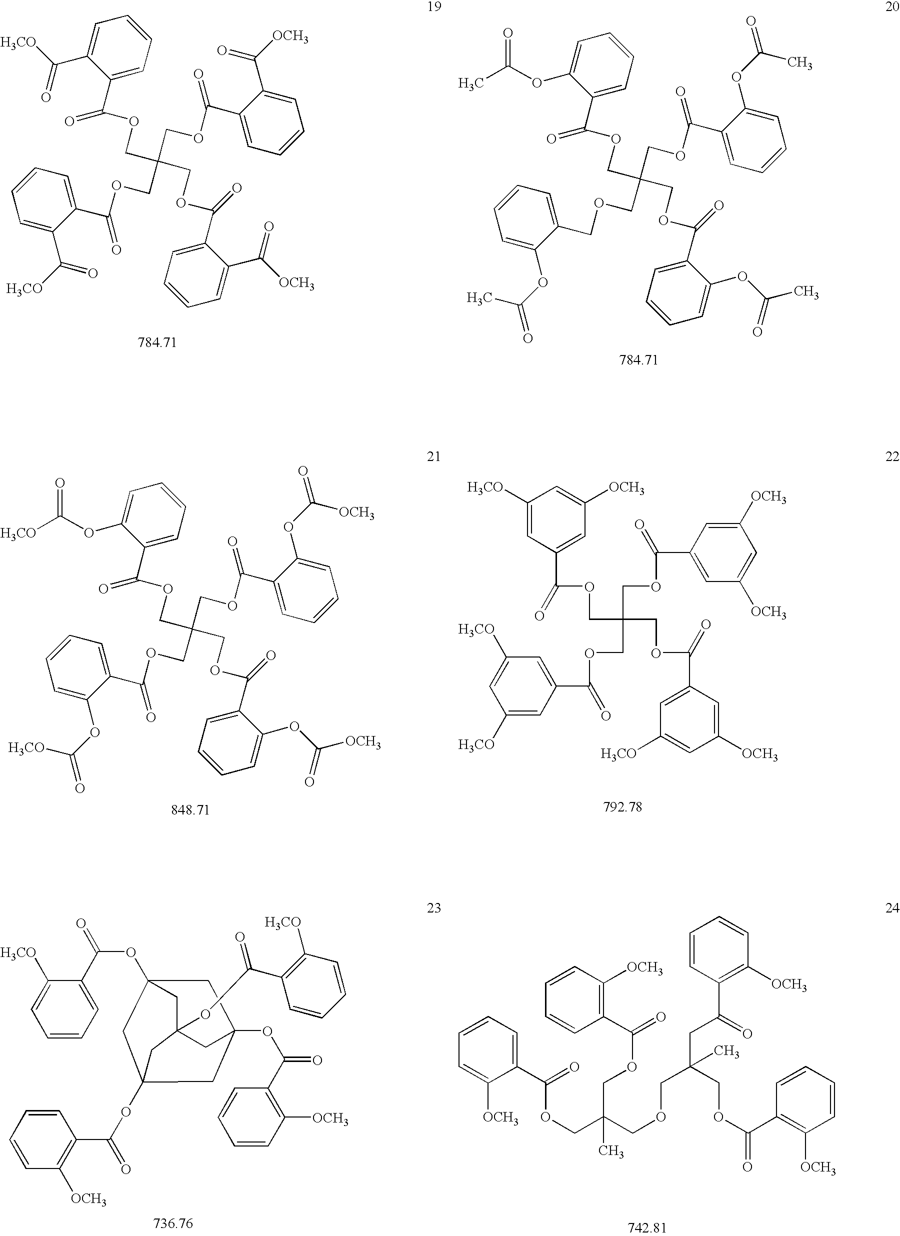

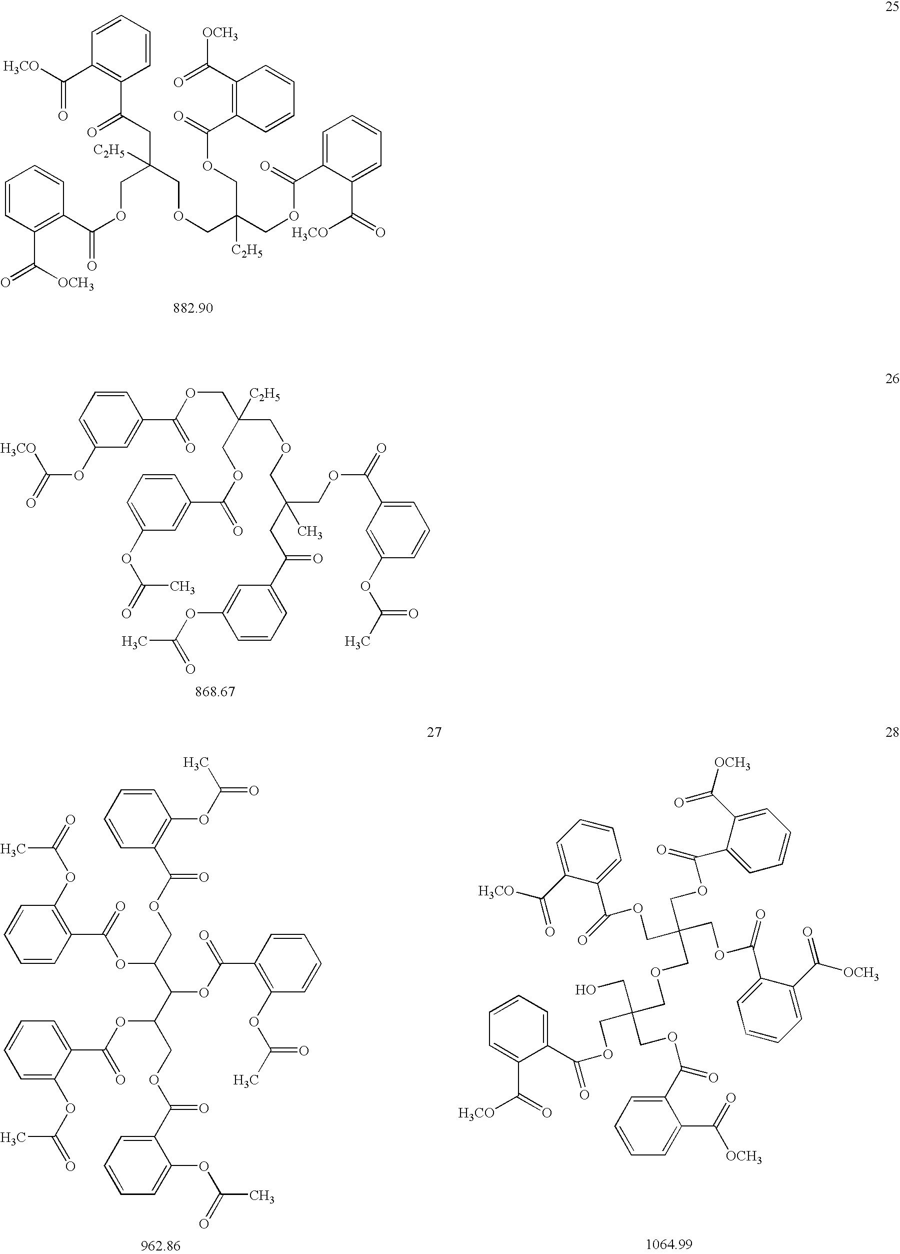

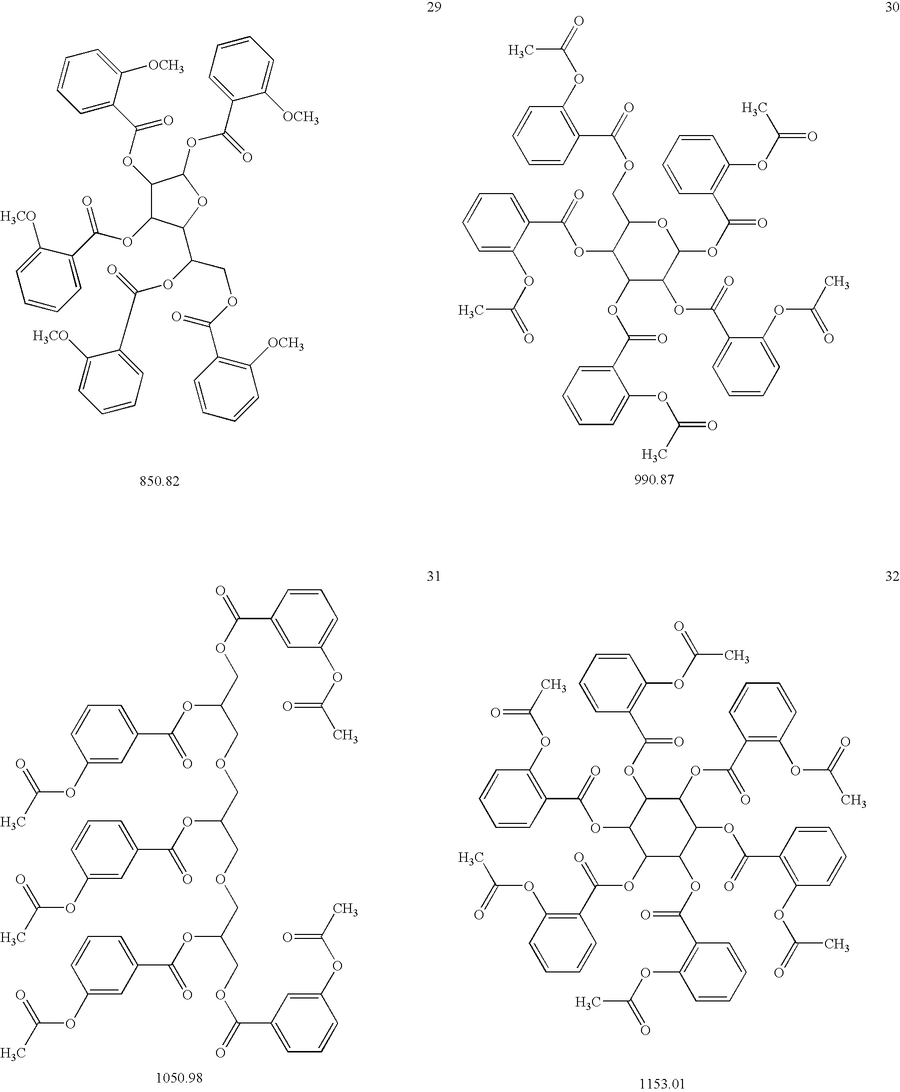

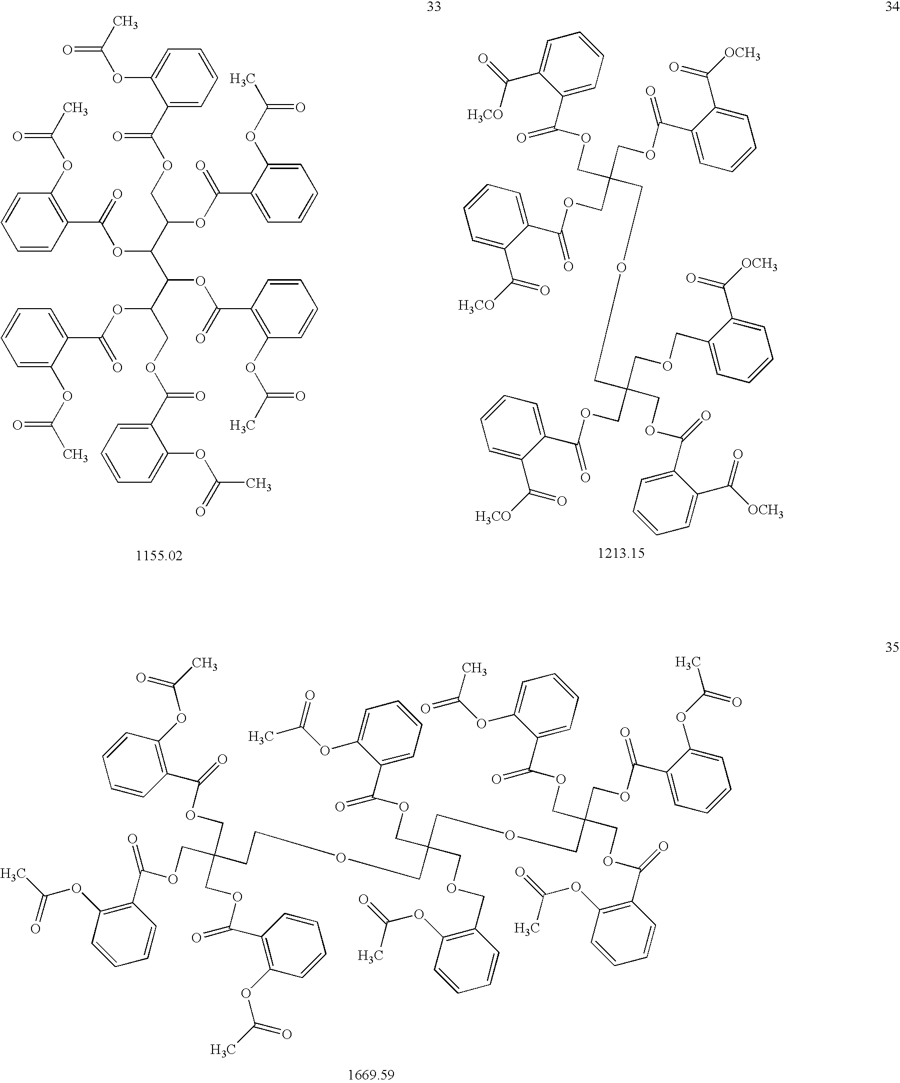

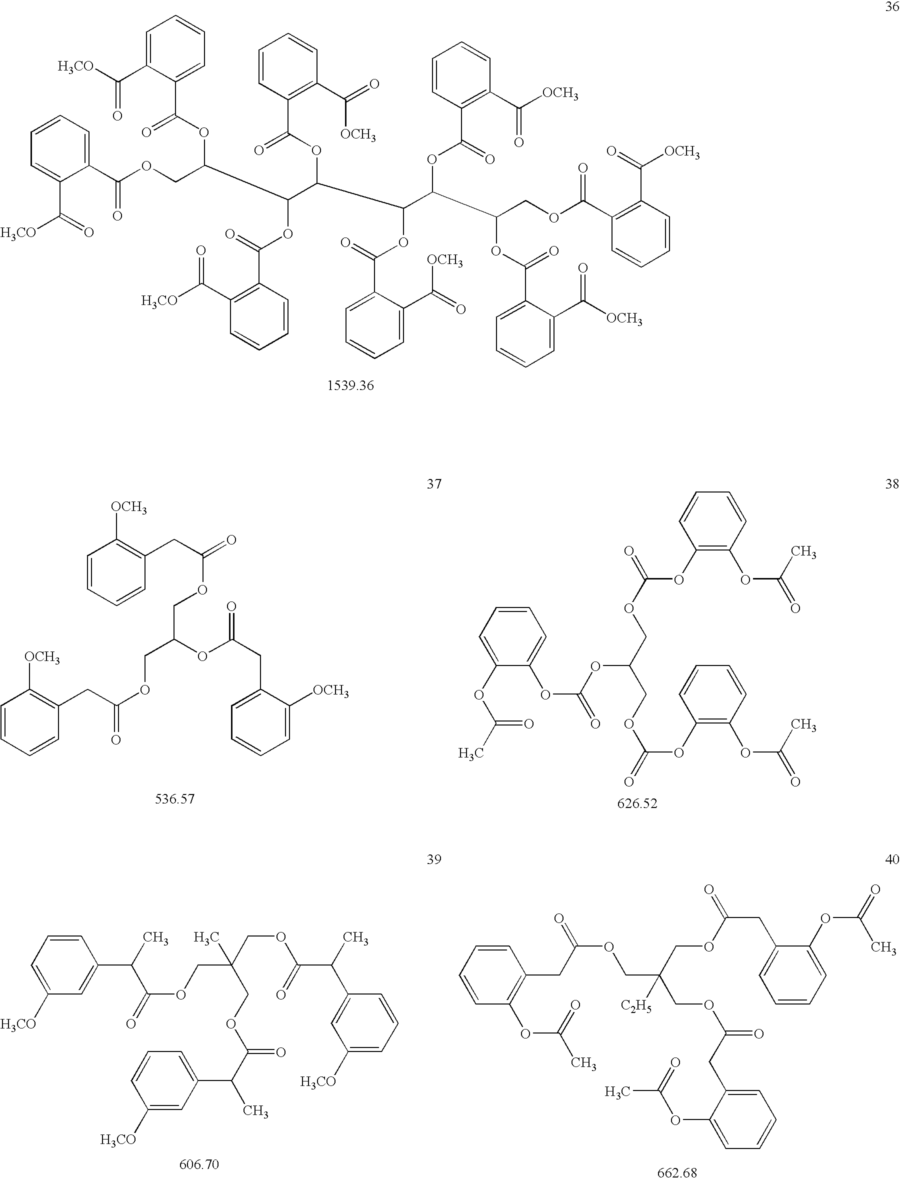

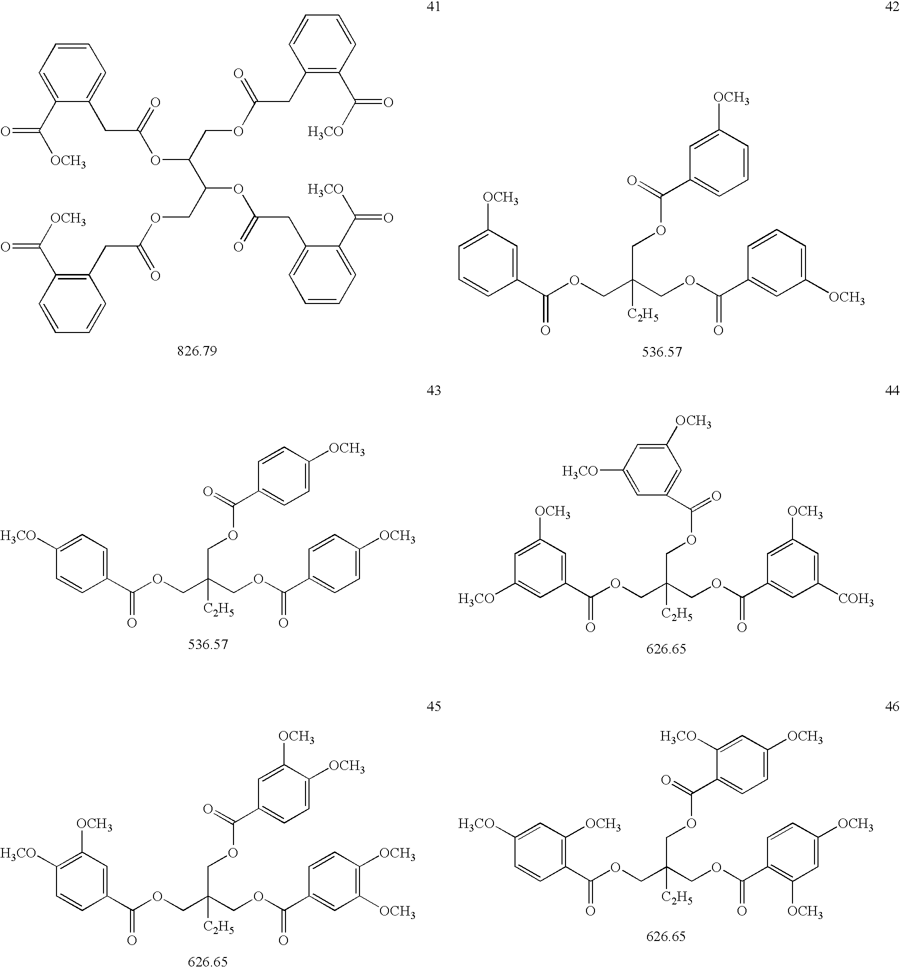

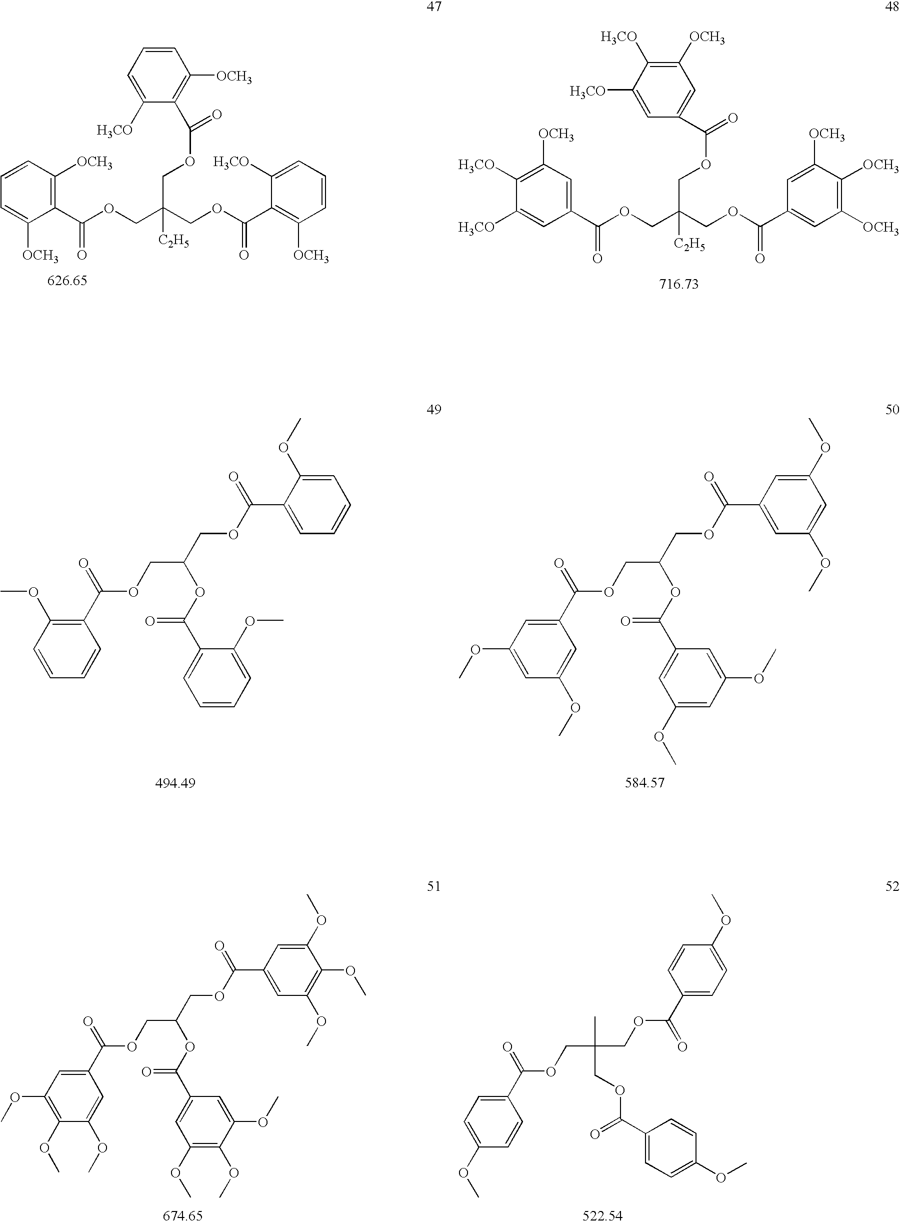

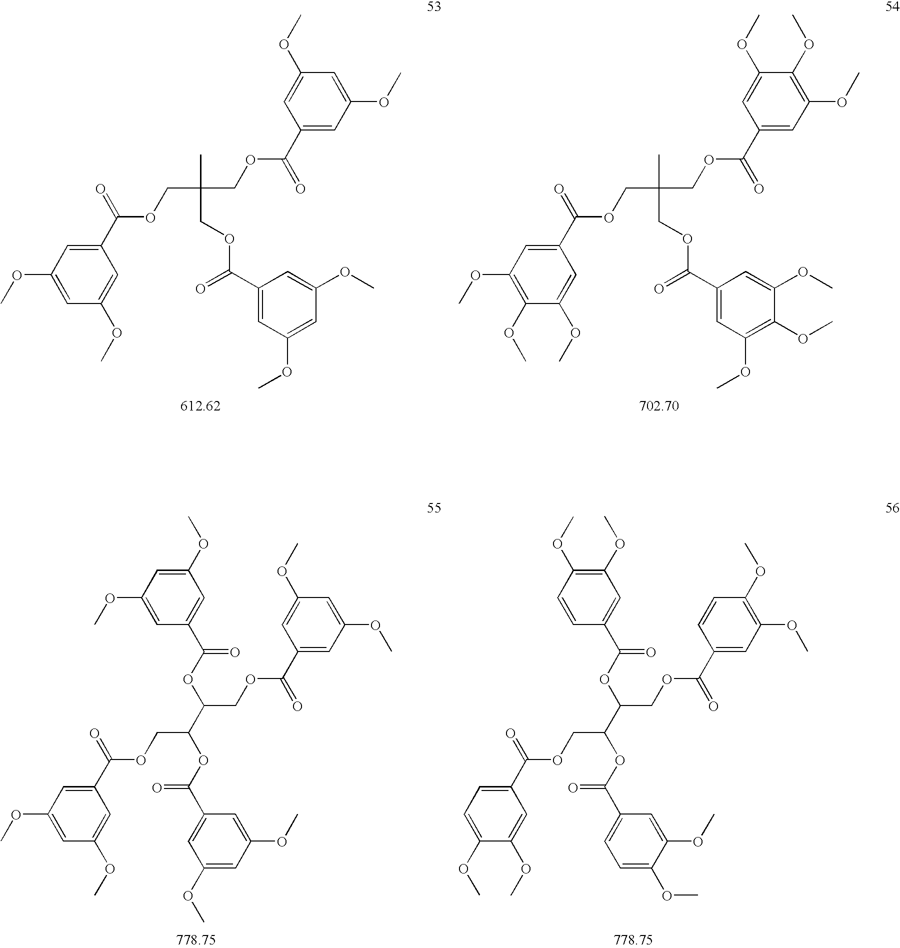

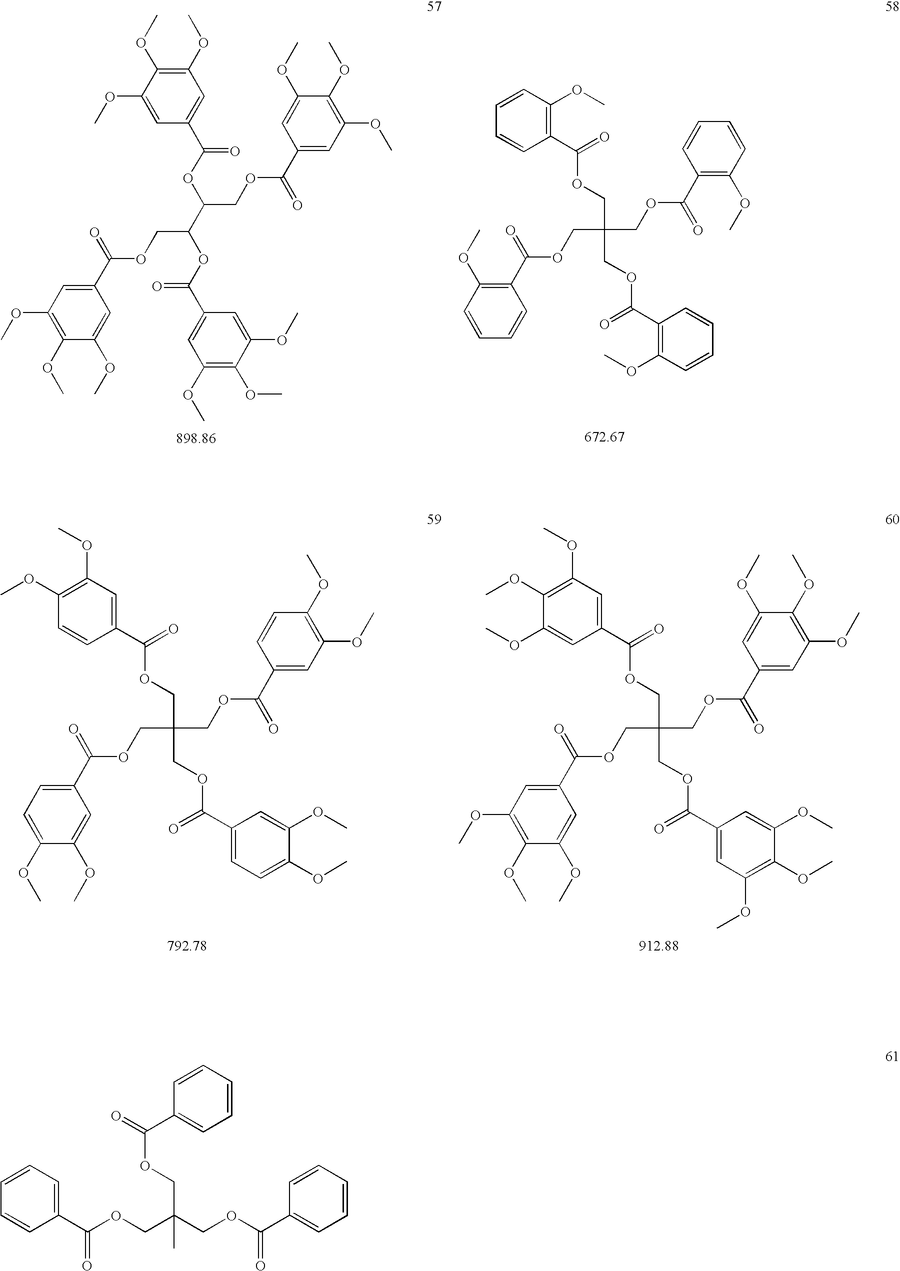

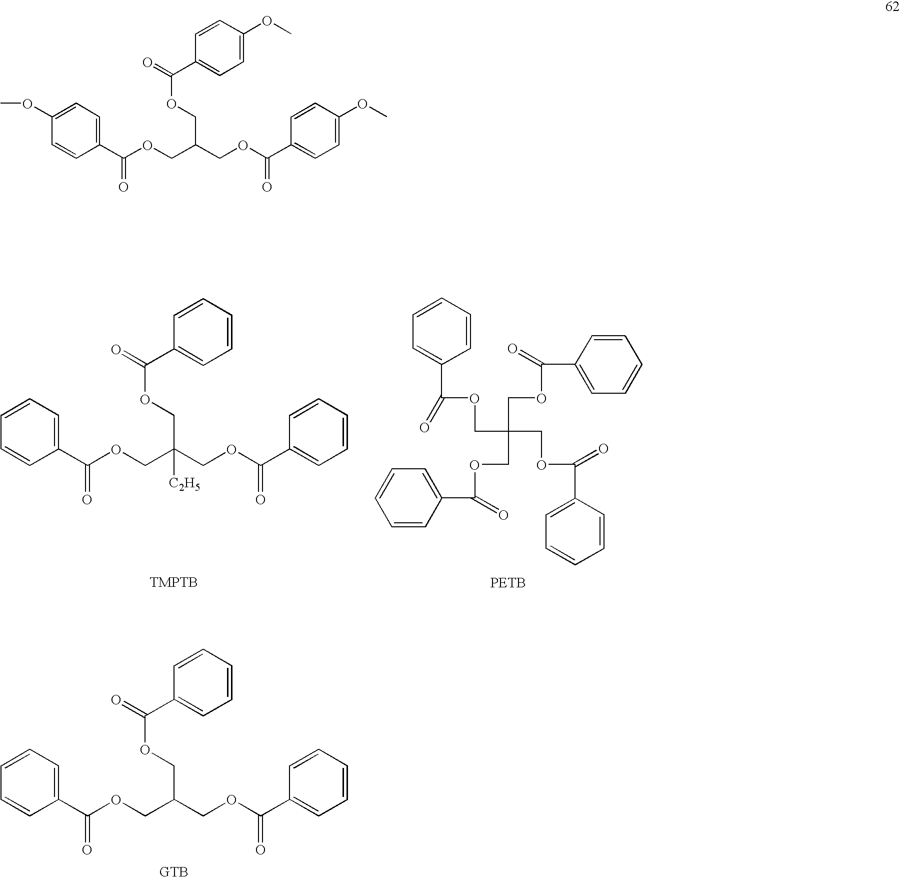

A glycolate type plasticizer is not specifically limited, however, alkylphthalylalkyl glycolates are preferably utilized. Alkylphthalylalkyl glycolates include such as methylphthalylmethyl glycolate, ethylphthalylethyl glycolate, propylphthalylpropyl glycolate, butylphthalylbutyl glycolate, octylphthalyloctyl glycolate, methylphthalylethyl glycolate, ethylphthalylmethyl glycolate, ethylphthalylpropyl glycolate, methylphthalylbutyl glycolate, ethylphthalylbutyl glycolate, butylphthalylmethyl glycolate, butylphthlylethyl glycolate, propylphthalylbutyl glycolate, butylphthalylpropyl glycolate, methylphthalyloctyl glycolate, ethylphthalyloctyl glycolate, octylphthalylmethyl glycolate and octylphthalylethyl glycolate.

A phthalate ester type plasticizer includes such as diethyl phthalate, dimethoxyethyl phthalate, dimethyl phthalate, dioctyl phthalate, dibutyl phthalate, di-2-ethylhexyl phthalate, dicyclohexyl phthalate and dicyclohexyl terephthalate.

A citric ester type plasticizer includes such as acetyltrimethyl citrate, acetyltriethyl citrate and acetyltributyl citrate.

An aliphatic ester type plasticizer includes such as butyl oleate, methylacetyl licinolate and dibutyl cebaciate.

Polycarboxylic acid ester based plasticizer may be used preferably. Practically, the polycarboxylic acid ester described in paragraphs [0015] to [0020] of JPA-2002-265639 is preferably added as one of the plasticizer.

A phosphoric ester type plasticizer includes such as triphenyl phosphate, tricresyl phosphate, cresyldiphenyl phosphate, octyldiphenyl phosphate, diphenylbiphenyl phosphate, trioctyl phosphate and tributyl phosphate.

It is also preferred to add an acrylic polymer described in JP-A-2003-12859.

### (Acrylic Polymer)

The cellulose ester film preferably contains acrylic polymer showing negative orientation birefringence against stretching direction and having a weight average molecular weight of not less than 500 and not more than 30,000.

Good compatibility of the cellulose ester and the polymer can be obtained by controlling the polymer component so that the polymer has a weight average molecular weight of not less than 500 and not more than 30,000.

An acryl polymer, particularly, having aromatic ring having in a side chain or a cyclohexyl group having in a side chain acrylic polymer, and preferably having a weight average molecular weight of more 500 and not more than 30,000, shows, in addition to those described above, good transparency and very low moisture permeability of cellulose ester film after film formation, and shows an excellent performance as an anti-reflection film.

The polymer is considered to be composed of oligomers and low molecular weight polymer since it has a weight average molecular weight of not less than 500 and not more than 30,000. Control of molecular weight is difficult in synthesizing such polymer, and it is preferable to employ a method by which polymer having a molecular weight of not so high and as uniform as possible is obtained.

The following methods can be cited as such the method; a method using a peroxide compound such as cumene peroxide and t-butyl hydroperoxide as the polymerization initiator, a method using a chain-transfer agent such as a mercapto compound or carbon tetra chloride additionally to the polymerization initiator, a method using a polymerization terminator such as benzoquinone and nitrobenzene, and a method described in JP-A 2000-128911 or 2000-344823 in which bulk polymerization is performed by using a polymerization catalyser such as a compound having one thiol group and a secondary hydroxyl group or a combination of such the compound and an organic metal compound is used as a polymerization catalyst. These methods are preferably employed and the methods described in the patent publications are preferable.

The acrylic polymer is a homopolymer or copolymer of an alkyl ester of acrylic acid or methacrylic acid having no monomer unit containing an aromatic ring or a cyclohexyl group. Acrylic polymer having an aromatic ring in a side chain is acrylic polymer containing an acrylic acid or methacrylic acid ester monomer unit necessarily having an aromatic ring.

The acrylic polymer having a cyclohexyl group as a side chain is acrylic polymer containing an acrylic acid or methacrylic acid ester monomer unit having a cyclohexyl group.

Acrylic acid ester monomer having no aromatic ring nor cyclohexyl group includes such as methyl acrylate, (i-, n-)propyl acrylate, (n-, s-, t-)butyl acrylate, (n-, i-, s-)pentyl acrylate, (n-, i-)hexyl acrylate, (n-, i-)heptyl acrylate, (n-, i-)octyl acrylate, (n-, i-)nonyl acrylate, (n-, i-)myristyl acrylate, 2-ethylhexyl acrylate, ε-caprolactone acrylate, 2-hydroxyethyl acrylate, 2-hydroxylpropyl acrylate, 3-hydroxypropyl acrylate, 4-hydroxybutyl acrylate, 2-hydroxybutyl acrylate, 2-methoxyethyl acrylate and 2-ethoxyethyl acrylate as acrylic acid ester; or those in which the above-described acrylic acid ester is changed into methacrylic acid ester.

Acrylic polymer, which is homopolymer or copolymer of the above-described monomer, preferably contains not less than 30 percent by weight of an acrylic acid ester monomer unit, and is preferably provided with not less than 40 percent by weight of a methacrylic acid ester monomer unit. Homopolymer of methyl acrylate or methyl methacrylate is specifically preferable.

Acrylic acid or methacrylic acid ester monomer having an aromatic ring includes such as phenyl acrylate, phenyl methacrylate, (2 or 4-chlorophenyl)acrylate, (2 or 4-chlorophenyl)methacrylate, (2, 3 or 4-ethoxycarbonylphenyl)acrylate, (2, 3 or 4-ethoxycarbonylphenyl)methacrylate, (o, m, or p-tolyl)acrylate, (o, -m or p-tolyl)methacrylate, benzyl acrylate, benzyl methacrylate, phenetyl acrylate, phenetyl methacrylate and 2-naphthyl acrylate. Benzyl acrylate, benzyl methacrylate, phenetyl acrylate and phenetyl methacrylate are preferably utilized.

Among acrylic polymer having an aromatic ring in a side chain, it is preferable that an acrylic acid or methacrylic acid ester monomer unit occupies 20 to 40 percent by weight and an acrylic acid or methacrylic acid methylester monomer unit occupies 50 to 80 percent by weight. The polymer preferably contains 2 to 20 percent by weight of an acrylic acid or methacrylic acid ester monomer unit having a hydroxyl group.

Acrylic acid ester monomer having a cyclohexyl group includes such as cyclohexyl acrylate, cyclohexyl methacrylate, 4-methylcyclohexyl acrylate, 4-methylcyclohexyl methacrylate, 4-ethylcyclohexyl acrylate and 4-ethylcyclohexyl methacrylate; however, cyclohexyl acrylate and cyclohexyl methacrylate can be preferably utilized.

Acrylic polymer having a cyclohexyl group in a side chain is preferably provided with 20 to 40 percent by weight of an acrylic acid or methacrylic acid ester monomer unit having a cyclohexyl group and 50 to 80 percent by weight of an acrylic acid or methacrylic acid methylester monomer unit. The polymer preferably contains 2 to 20 percent by weight of an acrylic acid or methacrylic acid ester monomer unit having a hydroxyl group.

The polymer obtained by polymerization of ethylenically unsaturated monomer, the acrylic polymer, the acrylic polymer having an aromatic ring in a side chain acrylic polymer, and the acrylic polymer having cyclohexyl group in a side chain described above are all excellent in compatibility with cellulose ester resin.

A constituting unit the acrylic acid or methacrylic acid ester monomer having a hydroxyl group is not of homopolymer but of copolymer. In this case, preferably 2 to 20 percent by weight of an acrylic acid or methacrylic acid ester monomer unit having a hydroxyl group is contained in acrylic polymer.

Polymer having a hydroxyl group in a side chain can be also preferably utilized. A monomer unit having a hydroxyl group is similar to a monomer unit described before. It includes preferably an acrylic acid or methacrylic acid ester, which includes such as 2-hydroxyethyl acrylate, 2-hydroxypropyl acrylate, 3-hydroxypropyl acrylate, 4-hydroxypropyl acrylate, 2-hydroxybutyl acrylate, p-hydroxymethylphenyl acrylate and p-(2-hydroxyethyl)phenyl acrylate; or those in which these acrylic acid are substituted by methacrylic acid; and 2-hydroxyethyl acrylate and 2-hydroxyethyl methacrylate are preferable. It is preferable to contain 2 to 20 percent by weight of an acrylic acid or methacrylic acid ester monomer unit having a hydroxyl group in polymer and more preferably 2 to 10 percent by weight.

The polymer as described before containing 2 to 20 percent by weight of a monomer unit having the above-described hydroxyl group is excellent in compatibility with cellulose ester, retention property and dimension stability as well as in adhesion with a polarizer as a protective film for polarizing plate in addition to low moisture permeability, and is provided with an improvement effect of durability of a polarizing plate.

A method to provide at least one end of the main chain of acrylic polymer with a hydroxyl group is not specifically limited provided being a method to provide the end of the main chain with a hydroxyl group; and includes such as a method to utilize a radical polymerization initiator having a hydroxyl group such as azobis (2-hydroxyethylbutyrate), a method to utilize a chain transfer agent having a hydroxyl group such as 2-mercaptoethanol, a method to utilize a polymerization terminator having a hydroxyl group, a method to provide the end with a hydroxyl group by living ion polymerization, a method to perform block polymerization by use of a polymerization catalyst comprising a compound having one thiol group and a secondary hydroxyl group or a combination of said compound and an organometallic compound, which is described in JP-A 2000-128911 or 2000-344823; and specifically preferable is a method described in said patent publications.

Polymer prepared by a method related to the description of the patent publications is available on the market as ACTFLOW SERIES manufactured by Soken Chemical & Engineering Co., Ltd., which can be preferably utilized. The above-described polymer having a hydroxyl group on the end and/or polymer having a hydroxyl group on the side chain in this invention has an effect to significantly improve compatibility and transparency of polymer.

Polymers using styrenes as an ethylenically unsaturated monomer which displays negative orientation birefringence properties against stretching direction are preferable to perform negative refraction properties. The styrenes include, for example, styrene, methylstyrene, dimethylstyrene, trimethylstyrene, ethylstyrene, isopropylstyrene, chloromethylstyrene, methoxy styrene, acetoxystyrene, chlorostyrene, dichlorostyrene, bromostyrene, and ethyl vinylbenzoate, but are not limited to these.

These may be copolymerized with the exemplified monomers as the ethylenically unsaturated monomers described above, and may be mixed compatibly in cellulose ester by employing two or more polymers described above for the purpose of control birefringence properties.

The cellulose ester film is preferably polymer X having a weight average molecular weight of 5,000 to 30,000 which is prepared by copolymerization of an ethylenic unsaturated monomer Xa having no aromatic ring in a molecule and an ethylenic unsaturated monomer Xb having a hydrophilic group, or polymer Y having a weight average molecular weight of 500 to 3,000 which is prepared by polymerization of an ethylenic unsaturated monomer having no aromatic ring Ya.

<Polymer X, Polymer Y>

Polymer X employed in this invention is a polymer having a weight average molecular weight of not less than 5,000 and not more than 30,000, which is prepared by copolymerization of ethylenically unsaturated monomer Xa which contains no aromatic ring nor a hydrophilic group in a molecule and ethylenically unsaturated monomer Xb which contains no aromatic ring but contains a hydrophilic group in a molecule.

Xa is preferably an acryl or methacryl monomer having no aromatic ring and no hydrophilic group in a molecule, and Xb is preferably an acryl or methacryl monomer having no aromatic ring but having a hydrophilic group, in a molecule.

Polymer X is represented by following Formula (X):

-(Xa)ₘ-(Xb)ₙ-(Xc)ₚ- Formula (X)

And Polymer X is more preferably a polymer represented by following Formula (R).

—[CH₂—C(—R¹)(—CO₂R²)]ₘ—[CH₂C(—R³)(—CO₂R⁴—OH]—]ₙ-[Xc]ₚ Formula (R)

In the Formula, R¹ and R³ is H or CH₃. R² is an alkyl group or a cycloalkyl group having a carbon number of 1 to 12. R⁴ is —CH₂—, —C₂H₄— or —C₃H₆—. Xc is a monomer unit polymerizable with Xa and Xb. m, n and p are a mole composition ratio. Herein, m≠0, n≠0, and k≠0; and m+n+p=100.

Monomer as a monomer unit constituting Polymer X will be listed below; however, this invention is not limited thereto.

In the acrylic polymer X, a hydrophilic group refers to a hydroxide group and a group having an ethylene oxide chain.

Ethylenically unsaturated monomer Xa which has no aromatic ring nor hydrophilic group in a molecule includes such as methylacrylate, ethyl acrylate, n-)propyl acrylate, (n-, s-, t-)butyl acrylate, (n-, s-)pentyl acrylate, (n-, i-)hexyl acrylate, (n-, i-)heptyl acrylate, (n-, i-)octyl acrylate, (n-, i-)nonyl acrylate, (n-, i-) myristyl acrylate, (2-ethylhexyl)acrylate and (s-caprolactone) acrylate; or those in which acrylic ester described above are converted to methacrylic ester.

Among them, methyl acrylate, ethyl acrylate, methyl methacrylate, ethyl methacrylate and (n-, i-)propyl acrylate are preferable.

Ethylenically unsaturated monomer Xb, which has no aromatic ring but has a hydrophilic group, is preferably an acrylic ester or methacrylic ester as a monomer unit having a hydroxyl group, and includes (2-hydroxyethyl)acrylate, (2-hydroxypropyl)acrylate, (3-hydroxypropyl)acrylate, (4-hydroxybutyl)acrylate and (2-hydroxybutyl)acrylate; or those in which these acrylic acid is replaced by methacrylic acid; and preferably (2-hydroxyethyl)acrylate, (2-hydroxyethyl)methacrylate, (2-hydroxypropyl)acrylate and (3-hydroxypropyl)acrylate.

Xc is not specifically limited provided being ethylenically unsaturated monomer other than Xa and Xb, and capable of copolymerization with Xa and Xb, and is preferably those having no aromatic ring.

The mole composition ratio m/n of Xa, Xb and Xc is preferably in a range of 99/1 to 65/35, and more preferably in a range of 95/5 to 75/25. p of Xc is 0 to 10. Xc may be plural monomer units.

When a mole composition ratio of Xa is large, compatibility with cellulose ester is improved; however, retardation value in the film thickness direction Rt is increased. When a mole composition ratio of Xb is large, the above-described compatibility is deteriorated; however, an effect to decrease Rt is high. Further, when a mole composition ratio of Xb is over the above-described range, there is a tendency of causing haze at the time of casting, and it is preferable to determine mole composition ratios of Xa and Xb so as to optimize these effects.

The molecular weight of Polymer X is not less than 5,000 and not more than 30,000, more preferably not less than 8,000 and not more than 25,000.

By setting the weight average molecular weight to not less than 5,000, it is preferable that obtained can be advantages such as small dimension variation of cellulose ester film under high temperature and high humidity and small curl as polarizing plate protective film. When the weight average molecular weigh is not more than 30,000, compatibility with cellulose ester is more improved, and bleeds out under high temperature and high humidity as well as generation of haze immediately after casting will be restrained.

The weight average molecular weight of polymer X can be controlled by a molecular weight controlling method known in the art. Such a molecular weight controlling method includes a method to incorporate a chain transfer agent such as carbon tetrachloride, lauryl mercaptan and octyl thioglycolate. Polymerization temperature is usually from room temperature to 130° C., preferably 50 to 100° C., and it is also possible to adjust the temperature or polymerization reaction time.

Polymer Y is a polymer which is prepared by polymerization of an ethylenically unsaturated monomer Ya and has a weight molecular weight of not less than 500 and not more than 3,000.

When a weight average molecular weight is not less than 500, it is preferable that residual monomer in polymer is decreased. Further, to set the molecular weight of not more than 3,000, it is preferable that retardation value Rt decreasing capability is maintained. Ya is preferably acryl or methacryl monomer having no aromatic rings.

Polymer Y of this invention is represented by following Formula (S).

(Ya)ₖ-(Yb)_{q}- Formula (S)

Further, Polymer Y of this invention is more preferably polymer represented by following Formula (T).

—[CH₂—C(—R⁵)(—CO₂R⁶)]ₖ-[Yb]_{q}- Formula (T)

In the Formula, R⁵ is H or CH₃. R₆ is an alkyl group having a carbon number of 1 to 12 or a cycloalkyl group. Yb is a monomer unit polymerizable with Ya. k and q are a mole composition ratio, wherein, k≠0, and k+p=100.)

Yb is not specifically limited provided being ethylenically unsaturated monomer which is copolymerizable with Ya. Yb may be plural monomer. k q=100, and q is preferably 0 to 30.

Ethylenically unsaturated monomer Ya, which constitutes Polymer Y prepared by polymerizing ethylenically unsaturated monomer having no aromatic ring, includes acrylic ester such as methyl acrylate, ethyl acrylate, (i-, n-)propyl acrylate, (n-, s-, t-)butyl acrylate, (n-, s-)pentyl acrylate, (n-, i-)hexyl acrylate, (n-, i-)heptyl acrylate, (n-, i-)octyl acrylate, (n-, i-)nonyl acrylate, (n-, i-)myristyl acrylate, cyclohexyl acrylate, (2-ethylhexyl)acrylate, ε-caprolactone) acrylate, (2-hydroxypropyl)acrylate, (3-hydroxypropyl)acrylate, (4-hydroxybutyl)acrylate and (2-hydroxybutyl)acrylate; those in which the above-described acrylic ester is changed into methacrylic ester such as methacrylic ester; and unsaturated acid such as acrylic acid, methacrylic acid, maleic acid anhydride, crotonic acid, and itaconic acid.

Yb is not specifically limited provided being ethylenically unsaturated monomer copolymerizable with Ya, however, is preferably vinyl ester such as vinyl acetate, vinyl propionate, vinyl butyrate, vinyl valerate, vinyl pivalate, vinyl caproate, vinyl capriate, vinyl laurate, vinyl myristate, vinyl palmitate, vinyl stearate, vinyl cyclohexane carboxylate, vinyl octylate, vinyl methacrylate, vinyl crotonate, vinyl sorbate and vinyl cinnamate. Yb may be plural monomer.

Control of molecular weight is difficult in synthesizing such polymers X and Y, and it is preferable to employ a method by which polymer having a molecular weight of not so high and as uniform as possible is obtained.

The following methods can be cited as such the method of polymerizing polymers X and Y, method using a peroxide compound such as cumene peroxide and t-butyl hydroperoxide as the polymerization initiator, a method using a chain-transfer agent such as a mercapto compound or carbon tetra chloride additionally to the polymerization initiator, a method using a polymerization terminator such as benzoquinone and nitrobenzene, and a method described in JP-A 2000-128911 or 2000-344823 in which bulk polymerization is performed by using a polymerization catalyser such as a compound having one thiol group and a secondary hydroxyl group or a combination of such the compound and an organic metal compound is used as a polymerization catalyst.

Polymer. Y is preferably polymerized by a method in which a compound having one thiol group and a secondary hydroxyl group is used as a chain transfer agent. The polymer Y has a hydroxy group and a thioether group at polymer terminal resulted from the polymerization catalyser and chain transfer agent in this case. Compatibility of the polymer Y with the cellulose ester can be controlled by the terminal residues. The hydroxyl value of polymer X and Y is preferably 30 to 150 mg KOH/g.

The measurement of the hydroxyl value is based on JIS K 0070 (1992). This Hydroxyl value is defined as mg number of potassium hydroxide which is required to neutralize acetic acid bonding to a hydroxyl group when 1 g of a sample is acetylated.

Practically, X g (approximately 1 g) of a sample is precisely weighed in a flask, which is added with exactly 20 ml of an acetylation agent (20 ml of acetic acid anhydride is added with pyridine to make 400 ml). The flask is equipped with an air condenser at the mouth and heated in a glycerin bath of 95 to 100° C. After 1 hour and 30 minutes, the system is cooled and added with 1 ml of purified water through the air condenser to decompose acetic acid anhydride into acetic acid. Next titration with a 0.5 mol/L ethanol solution of potassium hydroxide was performed by use of a potentiometric titrator to determine the inflection point of the obtained titration curve as an end point. Further, as a blank test, titration without a sample is performed to determine the inflection point of a titration curve. A Hydroxyl value is calculated by the following Formula.

Hydroxyl value={(B−C)×f×28.05/X}+D In the Formula, B is quantity (ml) of a 0.5 mol/L ethanol solution of potassium hydroxide utilized for a blank test, C is quantity (ml) of a 0.5 mol/L ethanol solution of potassium hydroxide utilized for titration, f is a factor of a 0.5 mol/L ethanol solution of potassium hydroxide, D is an acid value, and 28.05 is 1/2 of molar quantity 56.11 of potassium hydroxide.

The content of polymer X and Polymer Y in cellulose ester film is preferably in a range to satisfy following Formulas (i) and (ii). When a content of polymer X is xp (percent by weight=(weight of polymer X/weight of cellulose ester)×100),

and a content of Polymer Y is yp (percent by weight),

5≦xp+yp≦35(percent by weight) Formula (i)

0.05≦yp/(xp+yp)≦0.4 Formula (ii)

Preferable range of Formula (i) is 10 to 25 percent by weight.

The weight average molecular weight Mw of the polymer can be measured by employing gel permeation chromatography.

The measurement condition was as follows.

Solvent: methylene chloride

Column: Shodex K806, K805, K803G (3 columns manufactured by Showa Denko K. K. were utilized in connection.)

Column temperature: 25° C.

Sample concentration: 0.1 percent by weight

Detector: RI Model 504 (manufactured by GL Sciences Inc.)

Pump: L6000 (manufactured by Hitachi, Ltd.)

Flow rate: 1.0 ml/min

Calibration curve: A calibration curve by 13 samples of standard polystyrene STK (manufactured by Toso Co. Ltd.) having Mw=1,000,000 to 500 was utilized. Thirteen samples were utilized in an approximately equal interval.

A sufficient effect to decrease retardation value Rt can be achieved when the total amount of polymer X and Polymer Y is not less than 5 percent by weight. Further adhesion with a polyvinyl alcohol type polarizer is good when the total amount is not more than 35 percent by weight.

Polymer X and polymer Y may be added directly to a dope described below as its component and is dissolved to form the dope, or may be added to a dope after it is preliminary dissolved in an organic solvent which dissolves cellulose ester.

Total content of the plasticizer in the cellulose ester film is preferably 5 to 20 percent by weight, more preferably 6 to 16 percent by weight, and particularly preferably 8 to 13 percent by weight with respect to the total amount of the solid component. Content of the two plasticizers is at least 1 percent by weight in each and preferably 2 percent by weight or more in each.

Polyalcohol ester type plasticizer is contained preferably 1 to 15 percent by weight, more preferably 3 to 11 percent by weight. When an amount of the polyalcohol ester type plasticizer is small, deterioration of the plainness is observed. When the amount is in excess, the plasticizer is apt to bleed out. Content ratio of the polyalcohol ester type plasticizer to other type of plasticizer is preferably 1:4 to 4:1, and more preferably 1:3 to 3:1. It is not preferable that the amount is in excess or in short because film deformation is liable to occur.

(Solution Casting Film Forming Method)

Manufacturing method of the cellulose ester film by a solution casting film forming method is conducted by the following steps; preparation of dope by dissolving cellulose ester and an additive in a solvent, casing the dope on a belt shaped or drum shaped metal substrate, drying the cast dope as a web, peeling the web from the metal substrate, stretching or width maintaining, drying again, and winding out.

In the dope preparing step, a higher content of cellulose ester in the dope is preferable since duration of the drying step following the flow-casting step is shortened, however, a too high content may result in loss of filtration accuracy. Preferable content of cellulose ester is from 10 to 35 percent by weight and more preferably from 15 to 25 percent by weight.

A solvent may be used alone, however, two or more solvents may also be used together. A mixture of a good solvent and a poor solvent is more preferably used to increase manufacturing efficiency. A mixed solvent being rich in a good solvent is preferable to increase solubility of the cellulose ester. The preferable mixing ratios are from 70 to 98 percent by weight of a good solvent, and from 2 to 30 percent of a poor solvent. Herein, a good solvent is described as being capable of dissolving cellulose ester with a single use, and a poor solvent as being incapable of neither dissolving nor swelling cellulose ester even. Sometimes, a solvent works as a good solvent of a cellulose ester, and sometimes as a poor solvent depending on the degree of acyl substitution of the cellulose ester. For example, acetone is a good solvent for an acetic ester of a cellulose ester of which the degree of acetyl substitution is 2.4, as well as for an acetatepropionate of a cellulose ester, however, it is a poor solvent for an acetic ester of cellulose of which the degree of acetyl substitution is 2.8.

Good solvents are not limited particularly, and include, for example, organic halogen compounds (such as methylene chloride), dioxolanes, acetone, methyl acetate and methyl acetoacetate, of which methylene chloride and methyl acetate are specifically preferable. However, the present invention is not specifically limited thereto.

Poor solvents are not limited particularly, and include, for example, methanol, ethanol, n-butanol, cyclohexane and cyclohexanone, however, the present invention is not specifically limited thereto. A dope may preferably contain from 0.01 to 0.2 percent by weight of water.

In the step of preparing a dope, a cellulose ester is dissolved in a mixture of solvents using a usual method. Dissolving a cellulose ester at a higher temperature is possible when the heating is carried out under a higher pressure. Formation of a gel or an insoluble agglomerate known as gel or insoluble residue may be avoided when the dissolving temperatures is higher than the ambient pressure boiling point of the mixed solvents, and simultaneously the temperature is in the range where the mixed solvents do not boil under the applied higher pressure. The following dissolving method is also preferable, in which a cellulose ester is swollen in a mixture of good and poor solvents followed by adding good solvents to dissolve the swollen cellulose ester.

Pressure may be applied by injecting an inert gas such as nitrogen or by increasing the vapor pressure of the solvents by heating. Heating is preferably carried out from the outside of the container. A jacket type heater is preferable because the temperature is easily controlled.

A higher dissolving temperature is preferable with respect to the solubility of the cellulose ester, however, too high a temperature may lower the productivity because the pressure also becomes too high. The dissolving temperature is preferably from 45 to 120° C., more preferably from 60 to 110° C. and still more preferably from 70 to 105° C. The pressure should be controlled not to allow boiling at the set temperature.

A low temperature dissolution method is also preferably utilized, by which cellulose ester is successfully dissolved in solvents such as methyl acetate.

In the next step, the cellulose ester solution thus prepared is filtered using an appropriate filter material. A filter material with smaller absolute filtration accuracy is more preferable for removing impurities, however, too small a filtration accuracy easily causes clogging up of the filter. The absolute filtration accuracy of the filter is preferably not larger than 0.008 mm, more preferably from 0.001 to 0.008 mm and still more preferably from 0.003 to 0.006 mm.

The filter material used in the present invention is not specifically limited, and plastic filters (such as polypropylene and Teflon (R)) as well as metal (alloy) filters (such as stainless steel) are preferable, since these materials are free from peeling of a fiber, which may occur when fibrous material is used. Impurities and, particularly, luminescent foreign materials contained in the cellulose ester are preferably diminished or entirely removed by filtering.

Luminescent foreign materials denote impurities which are observed as bright spots when a cellulose ester film is placed between two polarizing plates arranged in a crossed Nicol state, illuminated with a light from one side and observed from the other. The number of luminescent foreign materials having a diameter of 0.01 mm or more is preferably 200 per cm² or less, more preferably 100 per cm² or less, still more preferably 50 per cm² or less and further more preferably from 0 to 10 per cm². The number of luminescent foreign materials having a diameter of 0.01 mm or less is preferably minimal.

The dope may be filtered by any usual method. One of these preferable filtering methods is to filter the dope at temperatures which are higher than the ambient pressure boiling point of the mixed solvents, and simultaneously in the range where the mixed solvents do not boil under a higher pressure. This method is preferable because the pressure difference between before and after filtering is reduced. The filtering temperature is preferably from 45 to 120° C., more preferably from 45 to 70° C. and still more preferably from 45 to 55° C.

The filtering pressure is preferably low, being preferably 1.6 MPa or less, more preferably 1.2 MPa or less and still more preferably 1.0 MPa or less.

Flow-casting of a dope will be explained below:

A metal support polished to a mirror finished surface is used in the flow-casting step. A polished stainless steel belt or a plated cast drum is used as a metal support.

The width of the support is preferably from 1 to 4 m. The surface temperature of the metal support is preferably from minus 50° C. to a temperature just below the boiling point of the solvent. A relatively high temperature of the support is more preferable because the web is more quickly dried, however, too high a temperature may cause foaming or loss of flatness of the web. The temperature of the support is preferably from 0 to 40° C. and more preferably from 5 to 30° C. Another preferable method is that a web is gelated by cooling the drum followed by peeling the web from the drum while the web still contains much solvent.

The method to control the temperature of the support is not specifically limited and a method of blowing warm or cool air onto the support or to apply warm water on the rear side of the support is acceptable. The warm water method is more preferable because the temperature of the metal support becomes stable in a shorter time due to more efficient thermal conduction. In the case when warm air is used, the air temperature should be higher than the desired temperature of the support by employing warm air higher than the boiling point of the solvent considering the lowering web temperature by evaporation latent heat with preventing generating forms. It is preferable to changing the temperature of the substrate and temperature of drying air between the casting and peeling to conduct drying efficiently.

The residual solvent amount at the time of peeling off a web from a metal support is preferably 10 to 150 percent by weight, more preferably 20 to 40 percent by weight or 60 to 130 percent by weight and specifically preferably 20 to 30 percent by weight or 70 to 120 percent by weight to provide a good flatness of polarizing plate protective film.

In this invention, a residual solvent amount is defined by the following Formula.

Residual solvent amount(percent by weight)={(M−N)/N}×100

Herein, M is a weight of a sample picked at an arbitrary time during or after manufacturing of a web or film and N is a weight after heating at 115° C. for 1 hour.

Further, in a drying process of cellulose ester film, a web is preferably peeled off from a metal support and further dried to make a residual solvent amount of not more than 1 percent by weight, more preferably not more than 0.1 percent by weight and specifically preferably 0 to 0.01 percent by weight.

A roll drying method (in which a web is dried while being alternately passed through many rolls which are arranged up and down) or a method to dry a web while being transported by a tenter method will be applied in a film drying process.

It is specifically preferable to manufacture the cellulose ester film for the clear hard coat film or the anti-reflection film according to the present invention that a cellulose ester film is peeled from a metal support and is immediately stretched in the transport direction while the film still contains much residual solvent. The film is then preferably stretched in the lateral direction using a tenter method in which the both sides of the web are griped by clips. The stretching ratios in both the longitudinal and the lateral directions are preferably in the range from 1.05 to 1.3 and more preferably from 1.05 to 1.15. The area of the film is preferably from 1.12 to 1.44 times larger and more preferably from 1.15 to 1.32 times larger, after the film is stretched in both the longitudinal and the lateral directions. The ratio of the stretched film area is a product of the stretch ratio s in both the longitudinal and the lateral directions. When one of the two stretching ratios is lower than 1.01, the flatness of the film may be degraded by the irradiation of the UV rays in the hard coat layer forming step.

A film is preferably peeled from the support with a tension of 210 N/m or more and more preferably with a tension from 220 to 300 N/m in order to stretch the film in the longitudinal direction just after peeling.

The method to dry the web is not specifically limited; however, generally, hot air, IR ray, heated rollers or microwave irradiation is used. Hot air is preferably used with respect to ease of cure and low cost.

Drying temperature in a drying process of a web is preferably 30 to 200° C. and stepwise raised and more preferably in a range of 50 to 180° C. to improve dimension stability.

The layer thickness of cellulose ester film is not specifically limited; however, a layer thickness of 10 to 200 μm may be applied. It was difficult to obtain a thin film having 10 to 70 μm thickness having excellent flatness and anti-abrasion properties, however, the thickness of the cellulose ester is preferably 10 to 70 μm in particular since thin anti-reflection film having a good flatness and anti-abrasion propertied is obtained and has good produce ability. More preferably is 20 to 60 μm, and most preferably 35 to 60 μm. The layer thickness is specifically preferably 30 to 100 μm, more preferably 40 to 80 μm, and furthermore preferably 50 to 70 μm. A multiple layered cellulose ester film manufactured by co-extrusion cast method is also used preferably. The cellulose ester film has a layer containing a UV ray absorbing agent and a plasticizer which layer may be a core layer or skin layer or both, in case it has multiple layers.

The center line average roughness (Ra) of the cellulose ester film can be 0.001 to 1 μm.

(Melt Casting Film Forming Method)

The cellulose ester film is preferably to manufactured by a melt casting film forming method.

The melt casting film forming method, employing heat melt without using solvent such as methylene chloride includes a melt extrusion forming method, press forming method, inflation forming method, injection forming method, blow forming method, stretch forming method and so on. The melt extrusion forming method is excellent among them to obtain the cellulose ester film with excellent mechanical strength and accuracy of surface.

Unstretched film is obtained by a method in which a mixture of cellulose ester and an additive is processed by hot air drying or vacuum drying, then, it is melted and extruded in a form of film through T-die, and is made contact with cooling drum via applying static electricity to solidify by cooling. Temperature of the cooling drum is preferably maintained at 90 to 150° C.

The cellulose ester and the additives such as a stabilizer to be added as required are mixed preferably before melting, and the cellulose resin and stabilizer are more preferably mixed before heating. A mixer may be used for mixing. Alternatively, mixing may be done in the cellulose ester preparation process. When the mixer is used, it is possible to use a general mixer such as a V-type mixer, conical screw type mixer, horizontal cylindrical type mixer, Henschel mixer and ribbon mixer.

After the film composing material has been mixed, the mixture can be directly melted by the extruder, thereby forming a film, as described above. It is also possible to make such arrangements that, after the film composing material has been pelletized, the pellets are melted by the extruder, thereby forming a film. Further, when the film composing material contains a plurality of materials having different melting points, melting is performed at the temperature where only the material of lower melting point can be melted, thereby producing a patchy or spongy half-melt. This half-melt is put into the extruder, whereby a film is formed. When the film composing material contains the material that is apt to thermal decomposition, it is preferred to use the method of creating a film directly without producing pellets for the purpose of reducing the number of melting, or the method of producing a patchy half-melt followed by the step of forming a film, as described above.

Various types of extruders sold on the market can be used as the extruder 1, and a melting and kneading extruder is preferably used. Either the single-screw extruder or double-screw extruder may be utilized. If a film is produced directly from the film composing material without manufacturing the pellet, an adequate degree of kneading is required. Accordingly, use of the double-screw extruder is preferred. However, the single-screw extruder can be used when the form of the screw is modified into that of the kneading type screw such as a Madoc type, Unimelt type and Dulmadge type, because this modification provides adequate kneading. When the pellet and patchy half-melt is used as a film composing material, either the single-screw extruder or double-screw extruder can be used.

In the process of cooling inside the extruder or subsequent to extrusion, the concentration of oxygen is preferably reduced by replacement with such an inert gas as nitrogen gas or by pressure reduction.

The preferable conditions for the melting temperature of the film composing material inside the extruder vary depending on the viscosity of the film composing material and the discharge rate or the thickness of the sheet to be produced. Generally, the melting temperature is Tg or higher without exceeding Tg+100° C. with respect to the glass transition temperature Tg of the film, preferably Tg+10° C. or higher without exceeding Tg+90° C. Practically temperature at the extrusion is preferably 150 to 300° C. and particularly 180 to 270° C. is preferable. Further 200 to 250° C. is preferable. The melting viscosity at the time of extrusion is 10 through 100,000 poises, preferably 100 through 10,000 poises.

Further, the film composing material retention time in the extruder is preferably shorter. This time is within 5 minutes, preferably within 3 minutes, more preferably within 2 minutes. The retention time depends on the type of the extruder 1 and conditions for extrusion, but can be reduced by adjusting the amount of the material supplied, and L/D, screw speed, and depth of the screw groove.

Unstretched film is obtained by extruding in a form of film via an extruder, and is made contact with cooling drum via applying static electricity to solidify by cooling. Temperature of the cooling drum is preferably maintained at 90 to 150° C.

The cellulose ester film of stretched in a width direction or film forming direction is particularly preferable.

It is preferable that the obtained unstretched film peeled from the cooling drum is heated at Tg+100° C. with respect to the glass transition temperature Tg of cellulose ester via a plurality of rolls and/or infrared heater etc., then, single- or multi-step longitudinal stretched.

Subsequently the cellulose ester film stretched in longitudinal direction obtained as described above, is stretched in width direction, and then is preferably subjected to thermal processing.

The thermal process is preferably conducted at temperature between Tg−20° C. and temperature of stretching and for 0.5 to 300 seconds while the film is conveyed.

The thermally processed film is usually cooled down to the glass transition temperature Tg or lower, and is wind up after holding portion by clips on both sides is cut off. The film is cooled down to the glass transition temperature Tg slowly, preferably, at a rate of 100° C./sec or less.

Cooling means are not limited particularly, and conventional method can be utilized. It is preferable that these processes are conducted during cooling in a plurality temperature ranges in sequence. The cooling rate is defined by (T1−Tg)/t, wherein T1 is terminal temperature of thermal process and t is a time required to reach Tg from T1.

UV ray absorbing agents are preferably used in a cellulose ester film. The preferably usable UV ray absorbing agents are those having good UV absorbance at wavelength of 370 nm or less and small absorption of visible light at wavelength of 400 nm or longer in view of good liquid crystal display performance.

An ultraviolet absorbent utilized in this invention is not specifically limited, however, includes such as an oxybenzophenone type compound, a benzotriazole type compound, a salicylic ester type compound, a benzophenone type compound, a cyano acrylate type compound, a triazine type compound, and a nickel complex type compound.

In the following, practical examples of a benzotriazole type ultraviolet absorbent utilized in this invention will be listed.
UV-1: 2-(2′-hydroxy-5′-methylphenyl)benzotriazole
UV-2: 2-(2′-hydroxy-3′,5′-di-tert-butylphenyl)benzotriazole
UV-3: 2-(2′-hydroxy-3′-tert-5′-methylphenyl)benzotriazole
UV-4: 2-(2′-hydroxy-3′,5′-di-tert-butylphenyl)-chlorobenzotriazole
UV-5: 2-(2′-hydroxy-3′-(3″,4″,5″,6″-tetrahydrophthalimidomethyl)-5′-methylphenyl)-benzotriazole
UV-6: 2,2-methylenebis-(4-(1,1,3,3-tetramethylbutyl)-6-(2H-benzotriazole-2-yl)phenol)
UV-7: 2-(2′-hydroxy-3′-di-tert-butyl-5′-methylphenyl)-5-chlorobenzotriazole
UV-8: 2-(2H-benzotriazole-2-yl)-6-(straight chain and branched dodecyl)-4-methylphenol (TINUVIN 171, manufactured by Ciba)
UV-9: A mixture of octyl-3-[3-tert-butyl-4-hydroxy-5-(Chloro-2H-benzotriazole-2-yl)phenyl]propionate and 2-ethylhexyl-3-[3-tert-butyl-4-hydroxy-5-(5-chloro-2H-benzotriazole-2-yl)phenyl]propionate (TINUVIN 109, manufactured by Ciba).

In the following, practical examples of a benzophenone type ultraviolet absorbent represented by Formula (E).
UV-10: 2,4-dihydroxybenzophenone
UV-11: 2,2′-dihydroxy-4-methoxybenzophenone
UV-12: 2-hydroxy-4-methoxy-5-sulfobenzophenone
UV-13: bis(2-methoxy-4-hydroxy-5-benzoylphenylmethane)

Examples of preferably usable UV ray absorbing agents are benzotriazole type UV ray absorbing agents and benzophenone type UV ray absorbing agents, which have high transparency and high effect in preventing deterioration of polarizing plate or crystal liquid. Benzophenone type UV ray absorbing agents with less color are used particularly preferably. Examples obtained in the market include TINUVIN 326, TINUVIN 109, TINUVIN 171, TINUVIN 900, TINUVIN 928 and TINUVIN 360 (all manufactured by Ciba Specialty Chemicals), LA31 (manufactured by Asahi Denka Co., Ltd.), Sumisorb250 (manufactured by Sumitomo Chemical Co., Ltd), and RUVA-100 (manufactured by Otsuka Chemical Co., Ltd)

The UV ray absorbing agents having distribution coefficient of 9.02 or more, described in JP A-2001-187825 improve surface quality of long film and excellent in coatability. Particularly it is preferable to use UV ray absorbing agents having distribution coefficient of 10.1 or more

Micro-particles may be employed to endow sliding property in the cellulose ester film.

As inorganic micro-particles, examples of an inorganic compound include silicon dioxide, titanium dioxide, aluminum oxide, zirconium oxide, calcium carbonate, talc, clay, calcined kaolin, calcined calcium silicate, hydrated calcium silicate, aluminum silicate, magnesium silicate and calcium phosphate.

Micro-particles are preferably those containing silicon because turbidity is decreased, and silicon dioxide is specifically preferred.

The mean particle size of a primary particle of micro-particles is preferably 5 to 50 nm and more preferably 7 to 20 nm. These may be contained as secondary aggregate having a particle size of 0.05 to 0.3 μm. The content of these micro-particles is preferably 0.01 to 1 percent by weight and specifically preferably 0.05 to 0.5 percent by weight.

As micro-particles of silicon dioxide, for example, products under the names of AEROSIL R972, R972V, R974, R812, 200, 200V, 300, R202, OX50 and TT600 (produced by Nippon Aerosil Co., Ltd.) are available on the market and can be utilized.

As micro-particles of zirconium oxide, for example, products under the names of AEROSIL R976 and R811 (produced by Nippon Aerosil Co., Ltd.) are available on the market and can be utilized.

Examples of polymer include silicone resin, fluorine-containing resin and acrylic resin. Silicone resin is preferred and those, having a three dimensional net structure, are specifically preferable; for example, products under the name of TOSPEARL 103, 105, 108, 120, 145, 3120 and 240 (produced by Toshiba Silicones Co., Ltd.) are available on the market and can be utilized.

Among these, Aerosil 200V and Aerosil R972 are specifically preferably utilized because of a large effect to decrease a friction coefficient while keeping turbidity of protective film to be low.

It is preferable that the cellulose ester film contains an anti-degradation agent described below.

The anti-degradation agent is described.

(Anti-Degradation Agent)

The anti-degradation agent is a material to inhibit decomposition of polymer by heat, oxygen, moisture, acid and so on via chemical action. The transparent substrate film, in particular manufactured by melt casting method, is formed at high temperature of 200° C. or higher, wherein a polymer is liable to decompose and degrade, and therefore it is preferable to incorporate the anti-degradation agent in a film composing material.

The anti-degradation agent is employed to inhibit deterioration such as coloration or molecular weight decrease or generation of volatile component cased by decomposition of materials, such as anti-oxidation of film forming material, scavenge of acid generated by decomposition, retarding or inhibiting a decomposition reaction caused by radicals due to light or heat, and further including unresolved decomposition reaction.

Although the stabilizer can be, for example, an anti-oxidant, hindered amine light stabilizer, acid capturing agent, metal deactivating agent, etc., but it is not necessary to limit to these. These have been mentioned in JP A H03-199201, JP A H05-1907073, JP A H05-194789, JP A H05-271471, and JP A H06-107854. It is preferable that an anti-oxidant among these is contained in the film forming material as an anti-degradation agent, and it is preferred to contain the anti-oxidant represented by Formula (Z) in view of the advantage of the present invention. The anti-degradation agent can be selected at least one species, and the its amount to incorporate is 0.01 percent by weight or more and not more than 10 percent by weight, more preferably 0.1 percent by weight or more and not more than 5.0 percent by weight, and further preferably 0.2 percent by weight or more and not more than 2.0 percent by weight, with respect to 100 percent by weight transparent substrate resin to form the transparent substrate film in view of transparency of the film.

The film forming materials may be preserved in which one or plurality kinds of materials are divided in pellets to avoid the deterioration or moisture absorption. Mixing performance or compatibility of melting material at heating can be improved, or optical uniformity of the obtained film can be ensured by making pellets.

It is preferred to incorporate a compound containing an acryloyl group represented by Formula (Z) in the transparent film substrate for the purpose of displaying the advantage of the present invention. A clear hard coat film or an anti-reflection film, which is manufactured by applying a hard coat layer on the transparent film substrate such as cellulose ester film, is prevented from deterioration even it is subjected to severe durability test of exposing to ozone. The compound containing an acryloyl group represented by Formula (Z) is described below.

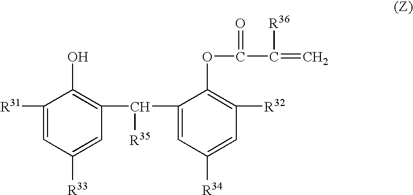

In the Formula, R³¹ through R³⁵ are, same or different, a hydrogen atom or an alkyl group having 1 to 10 carbon atoms, preferably 1 to 5 carbon atoms. The alkyl group is selected by considering the performance as the stabilizer and produce ability. Practical examples of an alkyl group represented by R³¹ through R³⁵ include a methyl group, ethyl group, n-propyl group, isopropyl group, n-butyl group, sec-butyl group, isobutyl group, tert-butyl group and 1,1-dimethyl propyl group. Steric hindrance bulky alkyl group such as isopropyl group, sec-butyl group, tert-butyl group, and 1,1-dimethyl propyl group is preferable in view of stabilization performance and easy produce ability for R³¹ and R³². Among them, tert-butyl group and 1,1-dimethyl propyl group are preferable. For R³³ and R³⁴, methyl group, ethyl group, n-propyl group, isopropyl group, n-butyl group, sec-butyl group, isobutyl group, tert-butyl group and 1,1-dimethyl propyl group are used, and tert-butyl group and 1,1-dimethyl propyl group are preferable considering reaction generating quinoide structure accompanying hydrogen drawing. For R³⁵, alkyl groups difficult to function of steric hindrance such as a methyl group, ethyl group, propyl group and n-butyl group are preferable in view of easy production. R³⁶ is a hydrogen atom or a methyl group.

The acryloyl compound represented by Formula (Z) used in the present invention is a compound containing an acrylate group or methacrylate group as well as phenolic hydroxy group in a molecule.

Practical examples of a compound containing an acryloyl group represented by Formula (Z) include a compound containing an acryloyl group represented by (Z-1) and (Z-2), but not limitative.

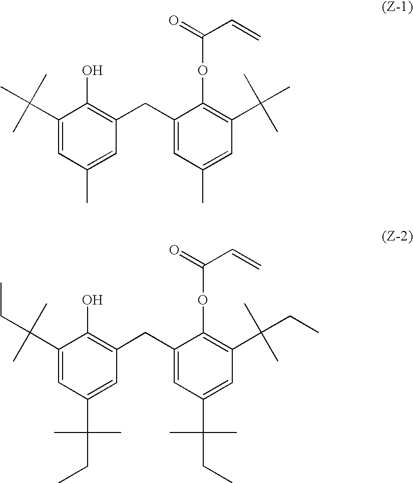

Typical examples of compounds represented by (Z-1) and (Z-2) include “SUMILIZSER GS” (trade name), “SUMILIZSER GM” (trade name), each being available from Sumitomo Chemical Co., Ltd.

The compound represented by Formula (Z) including an acryloyl group is preferably used in an amount of 0.01 to 5 parts by weight for 100 parts by weight of cellulose ester. It is preferably contained in an amount of 0.1 to 3 parts by weight in the composition, more preferably 0.5 to 1 parts by weight.

(Anti-Oxidant)

It is preferable that the cellulose ester film contains anti-oxidant shown below. Compounds inhibiting deterioration of film forming material due to oxygen can be used for the anti-oxidant without limitation.

Examples include phenol type anti-oxidant, phosphorous anti-oxidant, sulfur anti-oxidant, alkyl radical scavenger, peroxide decomposing agent, oxygen scavenger and so on. Among them, phenol type anti-oxidant, phosphorous anti-oxidant, alkyl radical scavenger are preferably employed, and combination of phenol type anti-oxidant with phosphorous anti-oxidant is more preferable, and further, combination of three components of phenol type anti-oxidant, phosphorous anti-oxidant and alkyl radical scavenger is most preferable. Coloration or mechanical strength due to heat or heat oxidation during the melt film forming process is inhibited without reducing transparency anti-heat Performance. The anti-oxidants may be used singly or two or more in combination. The amount is preferably 0.01 percent by weight to 10 percent by weight, more preferably 0.1 percent by weight to 5.0 percent by weight, and further preferably 0.2 percent by weight to 2.0 percent by weight based on 100 parts by weight of the cellulose ester.

(Phenol Anti-oxidant)

The phenol type anti-oxidants are a known compounds and examples include an alkyl group substituted phenol such as p-tert-butylphenol, p-(1,1,3,3-tetramethylbutyl)phenol, and further, 2,6-dialkyl phenol derivatives, and so called hindered phenol compounds described in columns 12-14 of U.S. Pat. No. 4,839,405 are listed. Hindered phenol compounds are preferable among them.

Practical examples of the phenol compound include: n-octadecyl-3-(3,5-di-t-butyl-4-hydroxyphenyl)propionate, n-octadecyl-3-(3,5-di-t-butyl-4-hydroxyphenyl)acetate, n-octadecyl-3,5-di-t-butyl-4-hydroxybenzoate, n-hexyl-3,5-di-t-butyl-4-hydroxyphenylbenzoate, n-dodecyl-3,5-di-t-butyl-4-hydroxyphenylbenzoate, neo-dodecyl-3-(3,5-di-t-butyl-4-hydroxyphenyl)propionate, dodecyl-β-(3,5-di-t-butyl-4-hydroxyphenyl)propionate, ethyl-α-(4-hydroxy-3,5-di-t-butylphenyl)isobutyrate, octadecyl-α-(4-hydroxy-3,5-di-t-butylphenyl)isobutyrate, octadecyl-α-(4-hydroxy-3,5-di-t-butyl-4-hydroxyphenyl)propionate, 2-(n-octylthio)ethyl-3,5-di-t-butyl-4-hydroxy-benzoate, 2-(n-octylthio)ethyl-3,5-di-t-butyl-4-hydroxyphenylacetate, 2-(n-octadecylthio)ethyl-3,5-di-t-butyl-4-hydroxyphenylacetate, 2-(n-octadecylthio)ethyl-3,5-di-t-butyl-4-hydroxybenzoate, 2-(2-hydroxyethylthio)ethyl-3,5-di-t-butyl-4-hydroxybenzoate, diethylglycol-bis-(3,5-di-t-butyl-4-hydroxyphenyl)propionate, 2-(n-octadecylthio)ethyl-3,5-di-t-butyl-4-hydroxyphenyl)propionate, stearamide-N,N-bis-[ethylene-3-(3,5-di-t-butyl-4-hydroxyphenyl)propionate], N-butylimino-N,N-bis-[ethylene-3-(3,5-di-t-butyl-4-hydroxyphenyl)propionate], 2-(2-stearoyloxyethylthio)ethyl-3,5-di-t-butyl-4-hydroxybenzoate, 2-(2-stearoyloxyethylthio)ethyl-7-(3-methyl-5-t-butyl-4-hydroxyphenyl)heptanoate, 1,2-propyleneglycol-bis-[3-(3,5-di-t-butyl-4-hydroxyphenyl)propionate], ethyleneglycol-bis-[3-(3,5-di-t-butyl-4-hydroxyphenyl)propionate], neopentylglycol-bis-[3-(3,5-di-t-butyl-4-hydroxyphenyl)propionate], ethyleneglycol-bis-(3,5-di-t-butyl-4-hydroxyphenylacetate), glycerol-l-n-octadecanoate-2,3-bis-(3,5-di-t-butyl-4-hydroxyphenylacetate), pentaerythritoltetrakis[3-(3′,5′-di-t-butyl-4′-hydroxyphenyl)propionate], 1,1,1-trimethylolethane-tris-[3-(3,5-di-t-butyl-4-hydroxyphenyl)propionate], sorbitol-hexa-[3-(3,5-di-t-butyl-4-hydroxyphenyl)propionate], 2-hydroxyethyl-7-(3-methyl-5-t-butyl-4-hydroxyphenyl)propionate, 2-stearoyloxyethyl-7-(3-methyl-5-t-butyl-4-hydroxyphenyl)heptanoate, 1,6-n-hexanediol-bis-[(3′,5′-di-butyl-4-hydroxyphenyl)propionate] and pentaerythritoltetrakis (3,5-di-t-butyl-4-hydroxyhydrocinnamate). Above phenol compounds have been commercialized, for example, as “IRGANOX 1076” and “IRGANOX 1010” from Ciba Specialty Chemicals, Inc.

(Phosphorous Anti-Oxidant)

Phosphorous anti-oxidant includes phosphite compounds and phosphonite compounds. Practical examples of phosphite compounds include: monophosphite compounds such as triphenyl phosphite, diphenylisodecyl phosphite, phenyldiisodecyl phosphite, tris (nonylphenyl)phosphite, tris (dinonylphenyl)phosphite, tris (2,4-di-t-butylphenyl)phosphite, tris (2,4-di-t-butyl-5-methylphenyl)phosphite, 10-(3,5-di-t-butyl-4-hydroxybenzyl)-9,10-dihydro-9-oxa-10-phosphaphenanthrene-10-oxide, 6-[3-(3-t-butyl-4-hydroxy-5-methylphenyl)propoxy]-2,4,8,10-tetra-t-butyldibenz[d,f][1.3.2]dioxaphosphepin and tridecylphosphite; and diphosphite compounds such as 4,4′-butylidene-bis(3-methyl6-t-butylphenyl-di-tridecylphosphite) and 4,4′-isopropylidene-bis(phenyldialkyl(C12 to C15)phosphite). Examples of above-mentioned commercially available phosphorus-containing compounds include: SUMILIZER GP from Sumitomo Chemical Co., Ltd.; ADKSTAB PEP-24, ADKSTAB PEP-36, ADKSTAB 3010, ADKSTAB HP-10 and ADKSTAB 2112 from ADEKA Corp.

Practical examples of phosphonite compounds include dimethylphenylphosphonite-di-t-butyl-phenylphosphonite-di-phenyl-phenylphosphonite-di-(4-pentyl-phenyl)-phenylphosphonite-di-(2-t-butyl-phenyl)-phenylphosphonite-di-(2-methyl3-pentyl-phenyl)-phenylphosphonite-di-(2-methyl4-octyl-phenyl)-phenylphosphonite-di-(3-butyl-4-methylphenyl)-phenylphosphonite-di-(3-hexyl-4-ethyl-phenyl)-phenylphosphonite-di-(2,4,6-trimethylphenyl)-phenylphosphonite-di-(2,3-dimethyl4-ethyl-phenyl)-phenylphosphonite-di-(2,6-di-ethyl-3-butylphenyl)-phenylphosphonite-di-(2,3-di-epropyl-5-butyl-phenyl)-phenylphosphonite-di-(2,4,6-tri-t-butylphenyl)-phenylphosphonite-bis(2,4-di-t-butyl-5-methylphenyl)biphenyl-4-ylphosphonite-bis(2,4-di-t-butyl-5-methylphenyl)-4′-(bis(2,4-di-t-butyl-5-methylphenoxy)phosphino)biphenyl-4-ylphosphonite, tetrakis (2,4-di-t-butyl-phenyl)-4,4′-biphenylene diphosphonite, tetrakis (2,5-di-t-butyl-phenyl)-4,4′-biphenylene diphosphonite, tetrakis (3,5-di-t-butyl-phenyl)-4,4′-biphenylene diphosphonite, tetrakis (2,3,4-trimethylphenyl)-4,4′-biphenylene diphosphonite, tetrakis (2,3-dimethyl5-ethyl-phenyl)-4,4′-biphenylene diphosphonite, tetrakis (2,3-dimethyl4-propylphenyl)-4,4′-biphenylene diphosphonite, tetrakis (2,3-dimethyl5-t-butylphenyl)-4,4′-biphenylene diphosphonite, tetrakis (2,5-dimethyl4-t-butylphenyl)-4,4′-biphenylene diphosphonite, tetrakis (2,3-di-ethyl-5-methylphenyl)-4,4′-biphenylene diphosphonite, tetrakis (2,6-di-ethyl-4-methylphenyl)-4,4′-biphenylene diphosphonite, tetrakis (2,4,5-triethylphenyl)-4,4′-biphenylene diphosphonite, tetrakis (2,6-di-ethyl-4-propylphenyl)-4,4′-biphenylene diphosphonite, tetrakis (2,5-di-ethyl-6-butylphenyl)-4,4′-biphenylene diphosphonite, tetrakis (2,3-di-ethyl-5-t-butylphenyl)-4,4′-biphenylene diphosphonite, tetrakis (2,5-di-ethyl-6-t-butylphenyl)-4,4′-biphenylene diphosphonite, tetrakis (2,3-di-epropyl-5-methylphenyl)-4,4′-biphenylene diphosphonite, tetrakis (2,6-di-epropyl-4-methylphenyl)-4,4′-biphenylene diphosphonite, tetrakis (2,6-di-epropyl-5-ethylphenyl)-4,4′-biphenylene diphosphonite, tetrakis (2,3-di-epropyl-6-butylphenyl)-4,4′-biphenylene diphosphonite, tetrakis (2,6-di-epropyl-5-butylphenyl)-4,4′-biphenylene diphosphonite, tetrakis (2,3-di-butyl-4-methylphenyl)-4,4′-biphenylene diphosphonite, tetrakis (2,5-di-butyl-3-methylphenyl)-4,4′-biphenylene diphosphonite, tetrakis (2,6-di-butyl-4-methylphenyl)-4,4′-biphenylene diphosphonite, tetrakis (2,4-di-t-butyl-3-methylphenyl)-4,4′-biphenylene diphosphonite, tetrakis (2,4-di-t-butyl-5-methylphenyl)-4,4′-biphenylene diphosphonite, tetrakis (2,4-di-t-butyl-6-methylphenyl)-4,4′-biphenylene diphosphonite, tetrakis (2,5-di-t-butyl-3-methylphenyl)-4,4′-biphenylene diphosphonite, tetrakis (2,5-di-t-butyl-4-methylphenyl)-4,4′-biphenylene diphosphonite, tetrakis (2,5-di-t-butyl-6-methylphenyl)-4,4′-biphenylene diphosphonite, tetrakis (2,6-di-t-butyl-3-methylphenyl)-4,4′-biphenylene diphosphonite, tetrakis (2,6-di-t-butyl-4-methylphenyl)-4,4′-biphenylene diphosphonite, tetrakis (2,6-di-t-butyl-5-methylphenyl)-4,4′-biphenylene diphosphonite, tetrakis (2,3-di-butyl-4-ethylphenyl)-4,4′-biphenylene diphosphonite, tetrakis (2,4-di-butyl-3-ethylphenyl)-4,4′-biphenylene diphosphonite, tetrakis (2,5-di-butyl-4-ethylphenyl)-4,4′-biphenylene diphosphonite, tetrakis (2,4-di-t-butyl-3-ethylphenyl)-4,4′-biphenylene diphosphonite, tetrakis (2,4-di-t-butyl-5-ethylphenyl)-4,4′-biphenylene diphosphonite, tetrakis (2,4-di-t-butyl-6-ethylphenyl)-4,4′-biphenylene diphosphonite, tetrakis (2,5-di-t-butyl-3-ethylphenyl)-4,4′-biphenylene diphosphonite, tetrakis (2,5-di-t-butyl-4-ethylphenyl)-4,4′-biphenylene diphosphonite, tetrakis (2,5-di-t-butyl-6-ethylphenyl)-4,4′-biphenylene diphosphonite, tetrakis (2,6-di-t-butyl-3-ethylphenyl)-4,4′-biphenylene diphosphonite, tetrakis (2,6-di-t-butyl-4-ethylphenyl)-4,4′-biphenylene diphosphonite, tetrakis (2,6-di-t-butyl-5-ethylphenyl)-4,4′-biphenylene diphosphonite, tetrakis (2,3,4-tributylphenyl)-4,4′-biphenylene diphosphonite and tetrakis (2,4,6-tri-t-butylphenyl)-4,4′-biphenylene diphosphonite.

Examples of above-mentioned commercially available phosphorous compounds include: IRGAFOS P-EPQ from Ciba Specialty Chemicals, Inc.; and GSY-P101 from SAKAI CHEMICAL INDUSTRY CO., LTD.

The preferable examples of the phosphorous anti-oxidant is phosphonite compounds among them, and 4,4′-biphenylene diphosphonite compound such as tetrakis (2,4-di-t-butyl-phenyl)-4,4′-biphenylene diphosphonite is preferable, and in particular, tetrakis (2,4-di-t-butyl-5-methylphenyl)-4,4′-biphenylene diphosphonite is preferable.

(Alkyl Radical Scavenger)

It is preferable that the cellulose ester film contains an alkyl radical scavenger described below. The alkyl radical scavenger is a compound having a reactive group with the alkyl radical speedy and giving a stable product which does not react with the alkyl radical after the reaction.

(Hindered Amine Light Stabilizer)

It is preferable that the cellulose ester film contains hindered amine light stabilizer (HALS) compound film forming material to inhibit deterioration during heat melting, or deterioration against outer light expose a polarizer protective film after manufacture or back light of a liquid crystal display. Examples of the hindered amine light stabilizer include 2,2,6,6-tetraalkylpiperidine compound, or its acid adduct salt and its metal complex compound described in columns 5 to 11 of U.S. Pat. No. 4,619,956 and columns 3 to 5 of U.S. Pat. No. 4,839,405.

Examples of a hindered amine compound include: bis(2,2,6,6-tetramethyl-4-piperidyl)sebacate, bis(2,2,6,6-tetramethyl4-piperidyl)succinate, bis(1,2,2,6,6-pentamethyl4-piperidyl)sebacate, bis(N-octoxy-2,2,6,6-tetramethyl4-piperidyl)sebacate, bis(N-benzyloxy-2,2,6,6-tetramethyl4-piperidyl)sebacate, bis(N-cyclohexyloxy-2,2,6,6-tetramethyl-4-piperidyl)sebacate, bis(1,2,2,6,6-pentamethyl4-piperidyl)-2-(3,5-di-t-butyl-4-hydroxybenzyl)-2-butylmalonate, bis(1-acryloyl-2,2,6,6-tetramethyl4-piperidyl)2,2-bis(3,5-di-t-butyl-4-hydroxybenzyl)-2-butylmalonate, bis(1,2,2,6,6-pentamethyl4-piperidyl)decanedioate, 2,2,6,6-tetramethyl-4-piperidylmethacrylate, 4-[3-(3,5-di-t-butyl-4-hydroxy-phenyl)propionyloxy]-1-[(2-(3-(3,5-di-t-butyl-4-hydroxy-phenyl)propionyloxy)ethyl]-2,2,6,6-tetramethylpiperidine, 2-methyl-2-(2,2,6,6-tetramethyl4-piperidyl)amino-N-(2,2,6,6-tetramethyl4-piperidyl)propionamide, tetrakis (2,2,6,6-tetramethyl4-piperidyl)1,2,3,4-butanetetracarboxylate and tetrakis (1,2,2,6,6-pentamethyl4-piperidyl)1,2,3,4-butanetetracarboxylate.

Also, a polymer compound is preferable, examples of which include: N,N′,N″,N″-tetrakis[4,6-bis-[butyl(N-methyl-2,2,6,6-tetramethylpiperidine-4-yl)amino]-triazine-2-yl]-4,7-diazadecane-1,10-diamine; a polycondensation compound of dibutylamine, 1,3,5-triazine N,N′-bis(2,2,6,6-tetramethyl-4-piperidyl)-1,6-hexamethylenediamine and N-(2,2,6,6-tetramethyl-4-piperidyl) butylamine; a polycondensation compound of dibutylamine, 1,3,5-triazine and N,N′-bis(2,2,6,6-tetramethyl-4-piperidyl)butylamine; poly[{(1,1,3,3-tetramethylbutyl)amino-1,3,5-triazine-2,4-diyl}{(2,2,6,6-tetramethyl-4-piperidyl)imino}hexamethylene{(2,2,6,6-tetramethyl-4-piperidyl)imino}]; a polycondensation compound of 1,6-hexanediamine-N,N′-bis(2,2,6,6-tetramethyl-4-piperidyl) and morpholine-2,4,6-trichloro-1,3,5-triazine; a high molecular weight HALS in which plurality of piperidine rings are combined via a triazine moiety, such as poly[(6-morpholino-s-triazine-2,4-diyl)[(2,2,6,6-tetramethyl-4-piperidyl)imino]-hexamethylene[(2,2,6,6-tetramethyl-4-piperidyl)imino]]; a polymer of dimethyl succinate and 4-hydroxy-2,2,6,6-tetramethyl-1-piperidineethanol; and a compound in which a piperazine ring is combined via a ester bond, such as a mixed ester compound of 1,2,3,4-butanetetracarboxylic acid, 1,2,2,6,6-pentamethyl-4-piperizinol and 3,9-bis(2-hydroxy-1,1-dimethylethyl)-2,4,8,10-tetraoxaspiro[5,5]undecane, however, the present invention is not limited thereto.

Among these compounds, preferable are, for example, a polycondensation compound of dibutylamine, 1,3,5-triazine and N,N′-bis(2,2,6,6-tetramethyl-4-piperidyl)butylamine; poly[{(1,1,3,3-tetramethylbutyl)amino-1,3,5-triazine-2,4-diyl}{(2,2,6,6-tetramethyl-4-piperidyl)imino}hexamethylene{(2,2,6,6-tetramethyl-4-piperidyl)imino}]; and a polymer of dimethyl succinate and 4-hydroxy-2,2,6,6-tetramethyl-1-piperidine ethanol, which have a number average molecular weight (Mn) of 2,000 to 5,000.

Above hindered-phenol compounds have been commercialized, for example, as TINUVIN 144 and TINUVIN 770 from Ciba Specialty Chemicals, Inc.; and as ADKSTAB LA-52 from ADEKA Corp. The hindered amine light stabilizer is added in amount of preferably 0.1 to 10 percent by weight of cellulose ester, more preferably 0.2 to 5 percent by weight, and further preferably 0.5 to 2 percent by weight. These may be used two kinds or more. The cellulose ester film may contain a compound shown below, which is manufactured in the trade name of HP-136 by Ciba Specialty Chemicals Inc.

(Acid Scavenger)

An acid scavenger is preferably contained in the cellulose ester film since an acid scavenger inhibits decomposition due to acid under a high temperature condition. As the acid scavenger, any compound which reacts with an acid to inactivate the acid can be used without limitation in the present invention. Of these, preferable is, for example, a compound having an epoxy group as disclosed in U.S. Pat. No. 4,137,201.

Such epoxy compounds as the acid scavenger have been known in the field of the art, and examples thereof include glycidyl ether of various polyglycols, particularly a polyglycol driven by condensation of approximately 8 to 40 moles of ethylene glycol per mole of the polyglycol, diglycidyl ether of glycerol, an metal epoxy compound (for example, ones usually used in a vinyl chloride polymer composition, or one usually used together with a vinyl chloride polymer composition), an epoxide ether condensate, diglycidyl ether of bisphenol A (i.e., 4,4′-dihydroxydiphenyldimethylmethane), an epoxide unsaturated fatty acid ester (specifically, an ester of alkyl having 2 to 4 carbon atoms of a fatty acid having 2 to 22 carbon atoms such as butyl epoxystearate), and a triglyceride of one of various epoxide long chain fatty acids (for example, an epoxide soybean oil composition. The examples further include an epoxide of plant oil or another unsaturated natural oil. The epoxide oils are sometimes called as epoxide of natural glyceride or epoxide of unsaturated fatty acid and these fatty acids are each contains 12 to 22 carbon atoms. As an epoxy group-containing epoxide resin compound available on the market, EPON 815C, and an epoxide ether oligomer condensation product can be preferably employed.

The other examples of the acid scavenger than described above include oxetane compounds and oxazolidine compound, or further organic acid or acetylacetonate complex of alkaline earth metal. Further employable acid scavenger includes those disclosed in JP-A H05-194788, paragraphs 87 to 105.

The adding amount of the acid scavenger is preferably 0.1 to 10% by weight, more preferably 0.2 to 5% by weight, and still more preferably 0.5 to 2% by weight, based on the weight of cellulose ester. Two or more types of acid scavengers may be used in combination.

The acid scavenger is also referred as acid sweeper, acid capture, acid catcher, and these may be used regardless its name.

(Metal Inactivator)

It is preferable that the cellulose ester film contains an metal inactivator. The metal inactivator is a compound inactivating a metal ion which works as an initiator or a catalyser in oxidation reaction. Examples thereof include hydrazide compounds, oxalic acid diamide compounds, triazole compounds, and practical examples are N,N′-bis[3-(3,5-di-t-butyl-4-hydroxy-phenyl) propionyl] hydrazine, 2-hydroxy-ethyl oxalic acid diamide, 2-hydroxy-N-(1H-1,2,4-triazole-3-yl)benzamide, and N-(5-tert-butyl-2-ethoxyphenyl)-N′-(2-ethylphenyl)oxalic acid amide.

The metal inactivator is preferably added in an amount of 0.0002 to 2 percent by weight with respect to 100 percent by weight of resin of the transparent substrate film, more preferably 0.0005 to 2 percent by weight, and further preferably 0.001″ to 1 percent by weight. These may be used two or more in combination.

(Other Additives)

The other additives such as die, pigment, fluorescent material, dichroic dye, retardation control agent, refractive index control agent, gas permeation inhibiting agent, anti-fungus agent and biodegradability impart agent may be incorporated in the cellulose ester film

A method to incorporate these additives in the cellulose ester film in which each material is mixed in a solid state or liquid state and is melted by heating, is kneaded to prepare a uniform to prepare a molten composition which is cast to form the cellulose ester film, or a method in which all materials are dissolved by employing a solvent to prepare a uniform solution and then solvent is removed, whereby the additives are mixed with the cellulose ester film.

(Polarizing Plate)

Polarizing Plate employing the clear hard coat film of the present invention is described.

It is possible to manufacture the polarizing plate employing a usual method. It is preferable that the rear surface of the clear hard coat film according to the present invention is saponified and then is adhered to at least one surface of a polarizing film which has been prepared via alkali saponification, immersion in an iodine solution and stretching, employing an aqueous solution of completely saponified polyvinyl alcohol as an adhesive. On the other surface of the polarizing film, either the aforesaid hard coat film or another appropriate polarizing plate protective film may be employed.

A protective film for polarizing plate used on the other side of the clear hard coat film of the present invention is preferably an optical compensation film having phase difference (phase difference film) having in-plane retardation (Ro) of 20 to 70 nm and retardation in the film thickness direction (Rt) of 100 to 400 nm.

The retardation values Ro and Rt can be measured via an automatic birefringence meter, for example, at 23° C., 55% RK and wavelength of 590 nm by employing KOBRA-21ADH (Oji Scientific Instrument).

These can be prepared, for example, by the methods described in JP-A 2002-71957 and 2003-170492. Further, it is preferable to employ a protective film for polarizing plate, which works as an optical compensation film, having an optical anisotropic layer prepared by orientating a liquid crystal compound such as a discotic liquid crystal. For example, the optical anisotropic layer can be formed by a method described in JP-A-2003-98348. Otherwise a no orientation film having in-plane retardation (Ro) of 0 to 5 nm and retardation in the film thickness direction (Rt) of −20 to +20 nm is also used preferably.

A polarizing plate having excellent in flatness and stable magnifying angular field of view effect can be obtained by employing the clear hard coat film of the present invention in combination. Cellulose ester film in the market such as KC8UX2MW, KC4UX, KC5UX, KC4UY, KC8UY, KC12UR, KC4UEW, KC8UCR-3, KC8UCR-4, KC8UCR-5, KC4FR-1 and KC4FR-2—(all produced by Konica Minolta Opto, Inc.) is employed as a protective film for polarizing plate used on the rear side.

A polarizing film, which is a main component of the polarizing plate, is an element which transmits polarized light in only predetermined direction. A currently known representative polarizing film is a polyvinyl alcohol polarizing film. Two types of polyvinyl alcohol polarizing films are known, namely, one is stained with iodine and the other is stained with a dichroic dye, but is not limited to these. A polarizing film is prepared in such a manner that an aqueous polyvinyl alcohol solution is cast to form a film and then the film is monoaxially stretched, followed by dying, or the film is stained with a dye first and then monoaxially stretched, followed by carrying out a durability enhancing treatment employing a boron compound. Thickness of the polarizing is 5 to 30 μm, and preferably 8 to 15 μm. The anti-reflection film according to the present invention is adhered on the surface of the polarizing film to form a polarizing plate. It is preferable to carry out the above adhesion employing an aqueous adhesive containing a completely saponified polyvinyl alcohol as the main component.

(Display Device)

Various display devices having excellent visibility can be manufactured by arranging the clear hard coat film of the present invention in viewing side of a display device.

The clear hard coat film of the present invention is arranged in polarizing plate, which is preferably employed in an LCD such as a reflection type, a transmission type, or a semi-transmission type, or in various mode driving system LCDs such as TN mode, STN mode, OCB mode, HAN mode, VA mode (for example, a PVA type and an MVA type), or IPS mode. The hard coat film of the present invention has a hard coat layer with remarkable low color irregularity in reflection light, and has low reflectance and excellent flatness, and it is preferably used in varieties of displays such as a plasma display, a field emission display, an organic EL display, an inorganic EL display and an electronic paper.

The plasma display providing a front filter which is obtained by processing the clear hard coat film of the present invention is a display device having no light interference irregularity and excellent visibility. Specifically, in large screen display devices of at least 30 types, color irregularity and wavy unevenness are minimized, resulting in reducing eye fatigue even after long time viewing.

### EXAMPLES

Examples of the invention are described below but the invention is not limited to them.

### Example 1

### Preparation of Transparent Film Base 1 (Cellulose Ester Film 1)

### (Preparation of Dope Liquid A)

| | | |
|---|---|---|
| Cellulose triacetate | 100 | parts by weight |
| (Substitution ratio of acetyl group: 2.9) | | |
| Trimethylolpropane tribenzoate | 5 | parts by weight |
| Ethylphthalylethyl glycolate | 5 | parts by weight |
| Silicon oxide fine particle | 0.1 | parts by weight |
| (Aerosil R972V, Nippon Aerosil Co., Ltd.) | | |
| TINUVIN 109 (Chiba Specialty Chemicals Inc.) | 1 | part by weight |
| TINUVIN 171 (Chiba Specialty Chemicals Inc.) | 1 | part by weight |
| Ethylene chloride | 400 | parts by weight |
| Ethanol | 40 | parts by weight |
| Butanol | 5 | parts by weight |

The above materials were successively put into an enclosed vessel, and the temperature in the vessel was raised from 20° C. to 80° C., and then stirred for 3 hours while keeping the temperature at 80° C. to completely dissolve the cellulose ester. The silicon oxide fine particles were added, which were previously dispersed in a solution composed of the solvent to be used and a small amount of cellulose ester. The obtained dope fluid was filtered through a filter paper of Azumi Filter Paper No. 244, manufactured by Azumi Filter Paper Co., Ltd., to prepare Dope Liquid A.

Thus obtained Dope Liquid A was cast through a casting die kept at 35° C. on a support composed of a stainless steel-copper endless belt kept at 35° C. to form a web.

The web was dried on the support and peeled off from the support when the remaining solvent content became 80% by weight.

The web was further transported while drying by drying air of 90° C. and transported by plural rollers arranged on the upper lower sides in a transporting-drying process, and then the web was held at both edges by a tenter and stretched by 1.1 times of before stretching in the transverse direction. After stretching by the tenter, the web was dried by drying air at 135° C. in a transporting drying process having plural rollers arranged on the upper and lower sides. The web was thermally treated for 15 minutes in an atmosphere with an exchanging rate of 15 times per hour, and then cooled by room temperature and wound up. Thus, long length cellulose ester film 1 having a width of 1.5 m, a thickness of 80 μm, a length of 4,000 m and a refractive index of 1.49 was prepared. The stretching ratio in the web transportation direction was 1.1 which was calculated from the rotation speed of the stainless steel band support and the driving speed of the tenter. The surface roughness Ra of the film measured by an optical interference type surface roughness meter RST/PLUS, manufactured by WYKO, was 6 nm.

(Preparation of Clear Hard Coat Film)

Clear hard coat film was prepared by using the above cellulose ester film 1.

The following hard coat coating composition 1 was filtered by a polypropylene filter having a pore diameter of 0.4 μm to prepare a hard coat layer coating liquid. The hard coat layer coating liquid was coated on the above cellulose ester film 1 by a micro gravure coater, and dried at 70° C. Then the coated layer was irradiated by UV rays of a luminance of 100 mW/cm² on the irradiated area and a irradiation amount of 0.15 J/cm² using a UV lamp to cure the coated layer, while nitrogen purging so as to make the oxygen concentration in the atmosphere to 1.0% by volume, to form a hard coat layer having a dry thickness of 9 μm. Then the following back coat coating composition 1 was coated on the surface opposite to the surface on which the hard coat layer was coated by an extrusion coater to form a layer having a wet thickness of 10 μm and dried at 50° C. Thus a clear hard coat film was prepared. The surface roughness of the hard coat layer measured by an optical interference type surface roughness meter RST/PLUS, manufactured by WYKO, was 9 nm.

(Hard Coat Layer Composition 1)

Preparation of Fluorine-Siloxane Graft Polymer 1

The trade names of the materials used for preparing the fluorine-siloxane graft polymer 1 are listed below.

Radical polymerizable fluororesin (A): CEFRAL COAT CF-803 (Hydroxyl value: 60, number average molecular weight: 15,000) manufactured by Central Glass Co., ltd.

Single end radical polymerizable polysiloxane (B): SILAPLANE FM-0721 (number average molecular weight: 5,000) manufactured by Chisso Corp.

Radical polymerization initiator: PERBUTYL O (t-butylperoxy-2-ethylhexanoate) manufactured by NFO Corp.

Curing agent: SUMIDUL N3200 (biuret type prepolymer of hexamethylene diisocyanate) manufactured by Sumitomo Bayer Urethane Co., Ltd.

### [Synthesis of Radical Polymerizable Fluororesin (A)]

Into a glass vessel on which a mechanical stirrer, a thermometer were provided, a condenser and a dried nitrogen gas introducing device, 1554 parts by weight of CEFRAL COATCF-803, 233 parts by weight of xylene and 6.3 parts by weight of 2-isocyanatoethyl methacrylate were charged and heated by 80° C. under dried nitrogen atmosphere and made react for 2 hours at 80° C. The reacted mixture was taken out after confirmation of disappearance of infrared absorption of isocyanate of the infrared absorption spectrum of the sample of the reaction mixture. Thus 50% by weight of radical polymerizable fluororesin (A) was obtained through urethane bonding.

(Preparation of Fluorine-Siloxane Graft Polymer 1)

Into a glass vessel on which a mechanical stirrer, a thermometer, a condenser and a dried nitrogen gas introducing device were provided, 26.1 parts by weight of the above synthesized radical polymerizable fluororesin (A), 19.5 parts by weight of xylene, 16.3 parts by weight of n-butyl acetate, 2.4 parts by weight of methyl methacrylate, 1.8 parts by weight of n-butyl methacrylate, 1.8 parts by weight of lauryl methacrylate, 1.8 parts by weight of 2-hydroxyethyl methacrylate, 5.2 parts by weight of FM-0721 and 0.1 parts by weight of PERBUTYL O were charged and heated by 90° C. under nitrogen atmosphere and further kept at 90° C. for 5 hours to obtain a 35% by weight solution of fluorine-siloxane graft polymer 1 having a weight average molecular weight of 171,000.

The weight average molecular weight was measured by GPC. The weight percentage of the fluorine-siloxane graft polymer 1 was measured by HPLC (liquid chromatography).

The following materials were mixed by stirring to prepare hard coat layer coating composition 1

| | | |
|---|---|---|
| Pentaerythritol triacrylate | 20.0 | parts by weight |
| Pentaerythritol tetracrylate | 50.0 | parts by weight |
| Dipentaerythritol hexacrylate | 30.0 | parts by weight |
| Dipentaerythritol pentacrylate | 30.0 | parts by weight |
| IRGACURE 184 (Ciba Specialty Chemicals Inc.) | 5.0 | parts by weight |
| IRGACURE 907 (Ciba Specialty Chemicals Inc.) | 10.0 | parts by weight |
| Fluorine-siloxane graft polymer 1 | 5.0 | parts by weight |
| (35% by weight) | | |
| Pentaerythritol-tetrakis(3-mercaptobutylate) | 2.5 | parts by weight |
| Propyleneglycol monomethyl ether | 10 | parts by weight |
| Methyl acetate | 20 | parts by weight |
| Acetone | 20 | parts by weight |
| Methyl ethyl ketone | 60 | parts by weight |
| Cyclohexanone | 20 | parts by weight |

(Back Coat Layer Coating Composition 1)

| | |
|---|---|
| Diacetyl cellulose | 0.6 parts by weight |
| Acetone | 35 parts by weight |
| Methyl ethyl ketone | 35 parts by weight |
| Methanol | 35 parts by weight |
| 2%-methanol dispersion of | 16 parts by weight |
| silica particles KE-P30 | |
| (Nippon Shokubai Co., Ltd.) | |

### Example 2

Clear hard coat film was prepared in the same manner as in the clear hard coat film in Example 1 except that the fluorine-siloxane graft polymer 1 in the hart coat layer coating composition 1 was replaced by the fluorine-siloxane graft polymer 2 prepared as follows. The surface roughness of the hard coat layer measured by the optical interference type surface roughness meter RST/PLUS, manufactured by WYKO, was 9 nm.

Preparation of Fluorine-Siloxane Graft Polymer 2

Fluorine-siloxane graft polymer 2 was prepared in the same manner as in the preparation of fluorine-siloxane graft polymer 1 except that the mono-terminal radical polymerizable polysiloxane (B) was replaced by the following material and the amounts of the radical polymerizable fluororesin (A), solvents, monomers and initiator were as follows.

The trade names of the materials newly used in the fluorine-siloxane graft polymer 2 are listed below.

Single end radical polymerizable polysiloxane (B): X-22-174DX (number average molecular weight: 4,600) manufactured by Shin-Etsu Chemical Co., Ltd.

(Preparation of Fluorine-Siloxane Graft Polymer 2)

Into a glass vessel on which a mechanical stirrer, a thermometer, a condenser and a dried nitrogen gas introducing device were provided, 16.8 parts by weight of the above synthesized radical polymerizable fluororesin (A), 23.0 parts by weight of xylene, 15.0 parts by weight of n-butyl acetate, 2.5 parts by weight of methyl methacrylate, 2.0 parts by weight of n-butyl methacrylate, 1.9 parts by weight of lauryl methacrylate, 2.4 parts by weight of 2-hydroxyethyl methacrylate, 0.7 parts by weight of X-22-174DX and 0.1 parts by weight of PERBUTYL O were charged, heated by 90° C. under nitrogen atmosphere and kept for 2 hours at 90° C. Then 0.1 parts by weight of PERBUTYL O was additionally added and further kept for 5 hours at 90° C. Thus 35% by weight solution of fluorine-siloxane graft polymer 2 having a weight average molecular weight of 204,000 was obtained. The weight average molecular weight was measured by GPC. The weight percentage of the fluorine-siloxane graft polymer 2 was measured by HPLC.

### Example 3

Clear hard coat film was prepared in the same manner as in the clear hard coat film in Example 1 except that the fluorine-siloxane graft polymer 1 in the hart coat layer coating composition 1 was replaced by the fluorine-siloxane graft polymer 3 prepared as follows and the adding amount of which was changed to 4.40 parts by weight. The surface roughness Ra of the hard coat layer measured by the optical interference type surface roughness meter RST/PLUS, manufactured by WYKO, was 9 nm.

Preparation of Fluorine-Siloxane Graft Polymer 3

The trade names of the materials newly used in the fluorine-siloxane graft polymer 3 are listed below.

Radical polymerizable monomer (F) having one radical polymerizable double bond and at least one fluoroalkyl group in the molecule thereof: Light-Ester FM-108 (heptadeca fluorodecyl methacrylate) manufactured by Kyoei Chemical Co., Ltd.

Curable acryl resin: DESMOPHEN A160 (Hydroxyl value: 90) manufactured by Sumitomo Bayer Urethane Co., Ltd.

Curing agent: COLONATE HX (isocyanulate type prepolymer of hexamethylene diisocyanate) manufactured by Nippon Polyurethane Industry Co., Ltd.

(Preparation of Fluorine-Siloxane Graft Polymer 3)

Into a glass vessel on which a mechanical stirrer, a thermometer, a condenser and a nitrogen gas introducing device were provided, 36.2 parts by weight of the radical polymerizable fluororesin (A) synthesized in Example 1, 11.6 parts by weight of methyl methacrylate, 4.9 parts by weight of 2-hydroxymethyl methacrylate, 10.5 parts by weight of FM-0721, 7.7 parts by weight of FM-108, 0.4 parts by weight of methacrylic acid, 1.5 parts by weight of xylene, 60.2 parts by weight of n-butyl acetate and 0.3 parts by weight of PERBUTYL O were charged, heated by 90° C. under nitrogen atmosphere and kept for 2 hours at 90° C. Then 0.1 parts by weight of PERBUTYL O was additionally added and further kept for 5 hours at 90° C. Thus 40% by weight solution of fluorine-siloxane graft polymer 3 having a weight average molecular weight of 168,000 was obtained. The weight average molecular weight was measured by GPC. The weight percentage of the fluorine-siloxane graft polymer 3 was measured by HPLC.

### Example 4

Clear hard coat film was prepared in the same manner as in the clear hard coat film in Example 1 except that the fluorine-siloxane graft polymer 1 in the hart coat layer coating composition 1 was replaced by the fluorine-siloxane graft polymer 4 prepared as follows and the adding amount of which was changed to 4.40 parts by weight. The surface roughness of the hard coat layer measured by the optical interference type surface roughness meter RST/PLUS, manufactured by WYKO, was 9 nm.

Preparation of fluorine-siloxane graft polymer 4

The trade names of the material newly used in the fluorine siloxane graft polymer 4 are listed below.

Mono-terminal alkoxypolyalkyleneglycol (D): BLENMER PME-400 (molecular weight: 470) manufactured by NOF Corp.

(Preparation of Fluorine-Siloxane Graft Polymer 4)

Into a glass vessel on which a mechanical stirrer, a thermometer, a condenser and a dried nitrogen gas introducing device were provided, 26.7 parts by weight of the radical polymerizable fluororesin (A) synthesized in Example 1, 14.2 parts by weight of xylene, 13.7 parts by weight of n-butyl acetate, 5.4 parts by weight of methyl methacrylate, 2.7 parts by weight of n-butyl methacrylate, 0.9 parts by weight of lauryl methacrylate, 1.8 parts by weight of 2-hydroxymethyl methacrylate, 1.3 parts by weight of FM-0721, 1.3 parts by weight of Blenmer-400, and 0.1 parts by weight of PERBUTYL O were charged, heated by 90° C. under nitrogen atmosphere and kept for 2 hours at 90° C. Then 0.1 parts by weight of PERBUTYL O was additionally added and further kept for 5 hours at 90° C. Thus 40% by weight solution of fluorine-siloxane graft polymer 4 having a weight average molecular weight of 146,000 was obtained. The weight average molecular weight was measured by GPC. The weight percentage of the fluorine-siloxane graft polymer 4 was measured by HPLC.

### Example 5

Clear hard coat film was prepared in the same manner as in the clear hard coat film in Example 1 except that the fluorine-siloxane graft polymer 1 in the hart coat layer coating composition 1 was replaced by the fluorine-siloxane graft polymer 5 available on the market (ZX-049, manufactured by Fuji Kasei Kogyo Co., Ltd.) and the adding amount of which was changed to 3.90 parts by weight. The surface roughness of the hard coat layer measured by the optical interference type surface roughness meter. RST/PLUS, manufactured by WYKO, was 9 nm.

ZX-049: A mixture solution of 45% by weight of fluorine-siloxane graft polymer and 551 by weight of butyl acetate.

### Comparative Example 1

Clear hard coat film was prepared in the same manner as in the clear hard coat film in Example 1 except that the fluorine-siloxane graft polymer 1 in the hart coat layer coating composition 1 was replaced by perfluoroalkyl oligomer 1 available on the market (MEGAFACK F-478, manufactured by DIC Corp.) and the adding amount of which was changed to 5.80 parts by weight. The surface roughness of the hard coat layer measured by the optical interference type surface roughness meter RST/PLUS, manufactured by WYKO, was 9 nm.

MEGAFACK F-478: A mixture solution of 30% by weight of perfluoroalkyl oligomer and 701 by weight of methyl isobutyl ketone.

### Comparative Example 2

Clear hard coat film 7 was prepared in the same manner as in the clear hard coat film in Example 1 except that the fluorine-siloxane graft polymer 1 in the hart coat layer coating composition 1 was replaced by perfluoroalkyl oligomer 2 available on the market (MEGAFACK F-178K, manufactured by DIC Corp.) and the adding amount of which was changed to 5.80 parts by weight. The surface roughness of the hard coat layer measured by the optical interference type surface roughness meter RST/PLUS, manufactured by WYKO, was 9 nm.

MEGAFACK F-178K: A mixture solution of 30% by weight of perfluoroalkyl oligomer and 70% by weight of hydrocarbon type solvent.

### Comparative Example 3

Clear hard coat film was prepared in the same manner as in the clear hard coat film in Example 1 except that the fluorine-siloxane graft polymer 1 in the hart coat layer coating composition 1 was replaced by perfluoroalkyl oligomer 3 available on the market (DIFENSA MCF-350, 100% by weight of perfluoroalkyl oligomer, manufactured by DIC Corp.) and the adding amount of which was changed to 5.80 parts by weight. The surface roughness of the hard coat layer measured by the optical interference type surface roughness meter RST/PLUS, manufactured by WYKO, was 9 nm.

The hard coat layers of the above prepared clear hard coat films of Examples 1 to 5 and Comparative examples 1 to 3 were evaluated by the following test methods. Results of the test are listed in Table 1.

### (Evaluation of Strength of the Layer)

Saponification Treatment by Alkali

The clear hard coat films of Examples 1 to 5 and Comparative examples 1 to 3 were each cut into A4 size, and immersed in a 2 mol/L solution of potassium hydroxide for 2 minutes at 60° C., and then washed by water and dried to prepare alkali saponified clear hard coat films. The surface of the hard coat of each of the saponified films was lighted for 120 hours in a weather meter (Eye Super UV Tester, manufactured by Iwasaki Electric Co., Ltd.). These samples were conditioned for 24 hours at a temperature of 25° C. and a relative humidity of 60%, and then the strength of the layer of each of the clear hard coat films was evaluated by the following tests of adhesiveness, scratch resistivity and pencil hardness.

### (Adhesiveness)

On the hard coat layer of each of the above prepared films of Examples 1 to 5 and Comparative examples 1 to 3, eleven parallel cut lines were made by a single-edged razor blade at intervals of 1 mm and similar lines were further made in the direction making right angles to the previous lines so as to form a lattice pattern having 100 squares. A cellophane tape available on the market was pasted onto the lattice pattern and peeled off by pulling by hand with strong force in the vertical direction, and the ratio of the area of peeled thin layer to that of the tape pasted was visually observed and evaluated according to the following norms.

A: The thin layer was not peeled at all.

B: The ratio of peeled area was less than 5%.

C: The ratio of peeled area was less than 10%.

D: The ratio of peeled area was more than 10%.

(Scratch Resistivity)

The surface of the hard coat layer was scrubbed by 20 times of reciprocating motion of steel wool #0000, manufactured by Nippon Steel Wool Co., Ltd., while applying a load of 500 g/cm². Number of scratches per centimeter formed by the scrubbing was counted to evaluate the scratch resistivity. A number of scratches of not more than 5 per centimeter is preferable for practical use. The apparatus used for giving the reciprocating motion to the steel wool was a friction-wearing tester TRIBOSTATION Type 32, manufactured by Shinto Scientific Co., Ltd., and the moving speed was 1,000 mm/min.

(Pencil Hardness)

The surface of the hard coat layer was scrubbed by 5 times by the pencils described in JIS S 6006 having respective hardness with a loading of 1 Kg according to JIS K 5400 and the hardness causing one line was determined. The larger number corresponds to higher hardness and higher hardness is preferable. The hardness of 2H or more is preferable for practical use and that of 3H or more is particularly preferred.

(Preparation of Samples for Durability Test Exposing to Ozone and Evaluation of Layer Strength)

The clear hard coat films of Examples 1 to 5 and Comparative examples 1 to 3 without alkali saponification treatment were cut into A4 size and stored for 500 hours in an environment of an ozone content of 10 ppm, a temperature of 30° C. and a relative humidity of 60% to prepare samples for testing the durability under exposing to ozone.

The above samples for testing the durability under exposing to ozone were subjected to the layer strength evaluation by the above test methods. Thus obtained results are shown in Table 1.

TABLE 1

| | Clear hard coat film | | Evaluation of layer strength | | | | | |
|---|---|---|---|---|---|---|---|---|
| | | Polymer | Alkali saponification | | | Ozone exposure durability | | |
| | Surface | contained in | treatment | | | test (500 hours) | | |
| | roughness | hard coat | | Scratch | Pencil | | Scratch | Pencil |
| | (Ra) | layer | Adhesiveness | resistivity | hardness | Adhesiveness | resistivity | hardness |
| Example 1 | 9 nm | Fluorine- | A | 2 line | 3H | A | 1 line | 3H |
| | | siloxane graft | | | | | | |
| | | polymer 1 | | | | | | |
| Example 2 | 9 nm | Fluorine- | A | 1 line | 3H | A | 2 line | 3H |
| | | siloxane graft | | | | | | |
| | | polymer 2 | | | | | | |
| Example 3 | 9 nm | Fluorine- | A | 1 line | 3H | A | 1 line | 3H |
| | | siloxane graft | | | | | | |
| | | polymer 3 | | | | | | |
| Example 4 | 9 nm | Fluorine- | A | 2 line | 3H | A | 1 line | 3H |
| | | siloxane graft | | | | | | |
| | | polymer 4 | | | | | | |
| Example 5 | 9 nm | Fluorine- | A | 1 line | 3H | A | 1 line | 3H |
| | | siloxane graft | | | | | | |
| | | polymer 5 | | | | | | |
| Comp. 1 | 9 nm | Perfluoroalkyl | C | 18 line | H | C | 17 line | H |
| | | oligomer 1 | | | | | | |
| Comp. 2 | 9 nm | Perfluoroalkyl | C | 18 line | H | C | 18 line | H |
| | | oligomer 2 | | | | | | |
| Comp. 3 | 9 nm | Perfluoroalkyl | C | 19 line | H | C | 18 line | H |
| | | oligomer 3 | | | | | | |

Comp.: Comparative example

It is understood that the clear hard coat films of Examples 1 to 5 are superior to those of Comparative examples 1 to 3 in the layer strength any of after alkali saponification treatment and the durability test exposing to ozone.

### Examples 6 to 12

Clear hard coat films were prepared in the same manner as in the clear hard coat film of Example 5 except that the ratio of that the adding amount of the fluorine-siloxane graft polymer 5 (ZX-049 manufactured by Fuji Kasei Kogyo Co., Ltd.) to that the UV curable resin (pentaerythritol triacrylate, pentaerythritol tetracrylate, pentaerythritol hexacrylate and dipentaerythritol pentacrylate: total amount of them was 130.0 parts by weight) was changed as shown in table 2. The surface roughness of the hard coat layer of each of the films was measured by the optical interference type surface roughness meter RST/PLUS, manufactured by WYKO. Measured results are listed in the following Table 2.

The commercial product ZX-049 was a mixture solution of 45% by weight of fluorine-siloxane graft polymer and 55% by weight butyl acetate, and the adding amount described in Table 2 was the amount of the fluorine-siloxane graft polymer contained in the added ZX-094.

### (Evaluation of Layer Strength)

The clear hard coat films prepared in Examples 6 to 12 and 5 were cut into A4 size and immersed in a 4 mol/L potassium hydroxide solution for 2 minutes at 60° C. to prepare alkali saponified clear hard coat films. The surface of each of the alkali saponified clear hard coat films was irradiated by light for 120 hours in a weather meter (Eye Super UV Tester, manufactured by Iwasaki Electric Co., Ltd.).

The clear hard coat films without alkali saponification treatment prepared in Examples 6 to 12 and 5 were cut into A4 size and stored for 750 hours in an environment of an ozone content of 10 ppm, a temperature of 30° C. and a relative humidity of 60% to prepare samples for testing the durability under exposing to ozone. The layer strength of each of the prepared samples was evaluated by the foregoing test methods. Thus obtained results are listed in Table 2.

TABLE 2

| | Clear hard coat film | | | | | | | | |
|---|---|---|---|---|---|---|---|---|---|
| | | | Content | | | | | | |
| | | Fluorine- | ratio of | | | | | | |
| | | siloxane | fluorine- | | | | | | |
| | | graft | siloxane | | | | | | |
| | | polymer | graft | Layer strength evaluation | | | | | |
| | | content | polymer | Alkali saponification | | | Durability test under ozone | | |
| | Surface | in hard | to UV | treatment | | | exposure | | |
| | roughness | coat | curable | | Scratch | Pencil | | Scratch | Pencil |
| | (Ra) | Layer | resin | Adhesiveness | resistivity | hardness | Adhesiveness | resistivity | hardness |
| Example 5 | 9 nm | 1.76 | 1.35:100 | A | 2 line | 3H | A | 1 line | 3H |
| Example 6 | 9 nm | 7.70 | 5.92:100 | B | 4 line | 2H | A | 3 line | 2H |
| Example 7 | 9 nm | 7.20 | 5.54:100 | B | 4 line | 2H | A | 3 line | 2H |
| Example 8 | 9 nm | 6.30 | 4.85:100 | A | 1 line | 3H | A | 1 line | 3H |
| Example 9 | 9 nm | 3.60 | 2.77:100 | A | 2 line | 3H | A | 1 line | 3H |
| Example 10 | 9 nm | 0.46 | 0.35:100 | A | 1 line | 3H | A | 1 line | 3H |
| Example 11 | 9 nm | 0.09 | 0.07:100 | A | 2 line | 3H | A | 1 line | 3H |
| Example 12 | 9 nm | 0.05 | 0.03:100 | B | 4 line | 2H | A | 3 line | 2H |

It is under stood that higher layer strength can be obtained under the condition such as the alkali saponification treatment by higher concentration of alkali or the durability test under severer ozone exposure condition when the content ratio of the fluorine-siloxane graft polymer to the energy active radiation curable resin is within the range of from 0.05:100 to 5.00:100.

### Examples 13 to 23

Clear hard coat films were each prepared in the same manner as in Example 5 except that a hard coat composition, which was prepared by adding fine particles as shown in Table 3 and treating for 30 minutes by an ultrasonic homogenizer without filtration, was coated by the microgravure coater. The amount of methyl ethyl ketone to be added to the hard coat composition 1 was controlled for compensating the amount of the methyl ethyl ketone contained in the silica fine particle to be added.

The surface roughness of the hard coat layer of each of the films was measured by the optical interference type surface roughness meter RST/PLUS, manufactured by WYKO. Measured results are listed in the following Table 3.

Details of the silica fine particles were as follows.

Methyl ethyl ketone silica sol 1: Trade name of MEK-ST, particle diameter of 10 to 15 nm, silica concentration of 30%, and manufactured by Nissan Chemical Industries Ltd.

Methyl ethyl ketone silica sol 2: Trade name of MEK-ST-L, particle diameter of 4 to 50 nm, silica concentration of 30%, and manufactured by Nissan Chemical Industries Ltd.

Methyl ethyl ketone silica sol 3: Trade name of MEK-ST-UP, particle diameter of 9 to 15 nm, silica concentration of 20%, and manufactured by Nissan Chemical Industries Ltd.

Poly(methyl methacrylate) type pine particle: Trade name of MG-151, average particle diameter of 80 nm, and manufactured by Nippon Paint Co., Ltd.

Acryl styrene cross-linked resin fine particle: Trade name of FS-102, average particle diameter of 80 nm, and manufactured by Nippon Paint Co., Ltd.

Chlorine-containing poly(methyl acrylate) fine particle: Trade name of FS-701, average particle diameter of 100 nm, and manufactured by Nippon Paint Co., Ltd.

(Evaluation of Layer Strength)

The clear hard coat films prepared in Examples 13 to 23 and 5 were cut into A4 size and immersed in a 4 mol/L potassium hydroxide solution for 2 minutes at 60° C. to prepare alkali saponification treated clear hard coat films. Then the alkali saponified clear hard coat films were stored for 1,000 hours in an environment of an ozone content of 10 ppm, a temperature of 30° C. and a relative humidity of 60% to prepare samples for testing the durability under exposing to ozone. The layer strength of these durability test samples were evaluated by the foregoing test methods. Thus obtained results are listed in Table 3.

TABLE 3

| | | | Layer strength evaluation | | |
|---|---|---|---|---|---|
| | | | Alkali treatment + Durability test | | |
| | Clear hard coat film | | under exposing to ozone (1,000 | | |
| | Surface | Fine particle contained in hard | hours) | | |
| | roughness | coat layer and content thereof | | Scratch | Pencil |
| | (Ra) | (parts by weight) | Adhesiveness | resistivity | hardness |
| Example 5 | 9 nm | None | B | 5 line | 2H |
| Example 13 | 11 nm | **1 (15.0) | A | 1 line | 3H |
| Example 14 | 11 nm | **1 (7.0) | A | 2 line | 3H |
| Example 15 | 13 nm | **2 (15.0) | A | 1 line | 3H |
| Example 16 | 13 nm | **2 (7.0) | A | 1 line | 3H |
| Example 17 | 11 nm | **3 (15.0) | A | 1 line | 3H |
| Example 18 | 11 nm | **3 (7.0) | A | 1 line | 3H |
| Example 19 | 11 nm | **3 (7.0) | A | 1 line | 3H |
| Example 20 | 14 nm | Poly(methyl methacrylate) type | A | 1 line | 3H |
| | | fine particle (7.0) | | | |
| Example 21 | 14 nm | Acryl•Styrene cross-linked fine | A | 1 line | 3H |
| | | particle (7.0) | | | |
| Example 22 | 14 nm | Chlorine-containing | A | 1 line | 3H |
| | | poly(methyl acrylate) fine | | | |
| | | particle (7.0) | | | |
| Example 23 | 14 nm | Chlorine-containing poly(methyl | A | 1 line | 3H |
| | | acrylate) fine particle (7.0) + | | | |
| | | Methyl ethyl ketone silica sol | | | |
| | | 3 (7.0) | | | |

**Methyl ethyl ketone silica sol

It is under stood from Table 3 that further superior layer strength can be obtained in the severer durability test by the addition of the organic and/or inorganic fine particle.

### Example 24

Clear hard coat films were prepared in the same manner as in Example 5 except that the transparent film base 1 was replaced by the following transparent film base 2, and subjected to the durability test in the same conditions as in Examples 13 to 23. The layer strength of each of the samples after the durability test was evaluated by the following test methods. Thus obtained evaluation results are listed in Table 4.

Preparation or transparent film base 2 (cellulose ester film 2)

### (Preparation of Dope Liquid B)

| | | |
|---|---|---|
| Cellulose triacetate | 100 | parts by weight |
| (Acetyl group substitution degree: 2.9) | | |
| Trimethylolpropane tribenzoate | 5 | parts by weight |
| Ethyl phthalyl ethyl glycolate | 5 | parts by weight |
| Silicon oxide fine particle | | |
| (AERISIL R972V, Nippon AERISIL Co., Ltd.) | 0.1 | parts by weight |
| TINUVIN 109 (Ciba specialty Chemicals) | 1 | part by weight |
| TINUVIN 171 (Ciba specialty Chemicals) | 1 | part by weight |
| Methylene chloride | 400 | parts by weight |
| Ethanol | 40 | parts by weight |
| Butanol | 5 | parts by weight |
| SUMILIZSER GS | 0.25 | parts by weight |
| (Sumitomo Chemical Co., Ltd.) | | |
| SUMILIZSER GM | 0.25 | parts by weight |
| (Sumitomo Chemical Co., Ltd.) | | |

The above materials were successively charged into a tightly enclosing vessel and the interior temperature was raised from 20° C. to 80° C., and the contents were stirred for 3 hours while keeping the temperature at 80° C. to completely dissolving the cellulose ester. The silicon oxide fine particles were added in a form of dispersion in a solution of small amount of the cellulose ester in the solvents. The above dope was filtered by filter paper Azumi Filter Paper No. 244 manufactured by Azumi Filter Paper Co., Ltd., to obtain dope liquid B.

Thus obtained dope liquid B was cast on a support composed of a stainless steel-copper endless belt kept at 35° C. through a casting die kept at 35° C. to form a web.

The web was dried on the support and peeled off from the support when the remaining solvent content became 80% by weight.

The web was further transported while drying by air of 90° C. and transported by plural rollers arranged on the upper lower sides in a transporting-drying process, and then the web was held at both edges by a tenter and stretched by 1.1 times of before stretching in the transverse direction. After stretching by the tenter, the web was dried by air at 135° C. in a transporting-drying process having plural rollers arranged on the upper and lower sides. The web was thermally treated for 15 minutes in an atmosphere exchanging at a rate of 15 times per hour, and then cooled by room temperature and wound up. Thus, long length cellulose ester film 2 having a width of 1.5 m, a thickness of 80 μm, a length of 4,000 m and a refractive index of 1.49 was prepared. The stretching ratio in the web transportation direction was 1.1 which was calculated from the rotation speed of the stainless steel band support and the driving speed of the tenter. The surface roughness Ra of the film measured by the optical interference type surface roughness meter RST/PLUS, manufactured by WYKO, was 6 nm.

Clear hard coat film was prepared in the same manner as in Example 1 using the cellulose ester film 2.

(Evaluation of Layer Strength)

The clear hard coat films prepared in Examples 24 and 5 were cut into A4 size and immersed in a 4 mol/L potassium hydroxide solution for 2 minutes at 60° C. to prepare alkali saponified clear hard coat films. Then the alkali saponified clear hard coat films were stored for 1,000 hours in an environment of an ozone content of 10 ppm, a temperature of 30° C. and a relative humidity of 60% to prepare samples for testing the durability under exposing to ozone. The layer strength of these durability test samples were evaluated by the foregoing test methods. Thus obtained results are listed in Table 4.

TABLE 4

| | | | Layer strength evaluation | | |
|---|---|---|---|---|---|
| | | | Alkali treatment + Durability test under | | |
| | Clear hard coat film | | exposing to ozone (1,000 hours) | | |
| | Surface | Transparent | | Scratch | Pencil |
| | roughness (Ra) | film base | Adhesiveness | resistivity | hardness |
| Example 5 | 9 nm | Cellulose | B | 5 line | 2H |
| | | ester film 1 | | | |
| Example 24 | 9 nm | Cellulose | A | 1 line | 3H |
| | | ester film 2 | | | |

As is understood from the results in Table 4, deterioration of the clear hard coat film is prevented by adding the compound having the acryloyl group represented by the foregoing Formula Z-1 and Z-2 to the cellulose ester film 2 as the transparent film base so that higher layer strength can be obtained even when severer ozone exposure durability test is applied.

### Examples 25 to 28

Clear hard coat films were prepared in the same manner as in Example 5 except that Fluorine-acryl copolymer resin 1 and fluorine-acryl copolymer resin 2 each synthesized by the following method, and fluorine-acryl copolymer resin 3 (MODIPER F-600, manufactured by NOF Corp.) available on the market were added as shown in Table 5.

Then the films were subjected to the durability test in the same manner as in Examples 13 to 23 and the layer strength of each the durability test samples was evaluated by the foregoing test methods. The surface roughness of the film measured by the optical interference type surface roughness meter RST/PLUS, manufactured by WYKO, was 9 nm.

### Synthesis of Fluorine-Acryl Copolymer Resin 1

Into a 5 liter four-mouth flask having a thermometer, stirrer and flux cooling tube, 600 g of methyl ethyl ketone was charged and heated by 70° C. while blowing nitrogen gas, then a mixture liquid composed of 200 g of methyl methacrylate, 200 g of butyl methacrylate, 70 g of 2-hydroxyethyl methacrylate and 30 g of methacrylic acid, and a mixture liquid composed of 400 g of methyl ethyl ketone and 110 g of polymeric peroxide, were simultaneously added spending 2 hours, and polymerization reaction was further continued for 4 hours.

Thereafter, a mixture liquid of 850 g of methyl ethyl ketone and 500 g of polymerizable monomer CH₂═CHCOO(CH₂)₂—(CF₂)₇CF₃ was charged spending 40 minutes, and polymerization reaction was performed for 1.5 hours and further continue for 3 hours at 80° C. to obtain a dispersion containing fluorine-acryl copolymer resin 1 (Mw: 35,300) by polymerizing the above monomers.

### Synthesis of Fluorine-Acryl Copolymer Resin 2

Into a 5 liter four-mouth flask having a thermometer, stirrer and flux cooling tube, 600 g of toluene was charged and heated by 70° C. while blowing nitrogen gas, then a mixture liquid composed of 450 g of octadecyl methacrylate, 50 g of butyl methacrylate, and a mixture liquid composed of 400 g of toluene and 80 g of polymeric peroxide, were simultaneously added spending 2 hours, and polymerization reaction was further continued for 4 hours.

Thereafter, a mixture liquid of 80 g of toluene, 250 g of fluorine-containing monomer represented by CH₂═CHCOO(CH₂)₂—(CF₂)₇CF₃ and 250 g of octadecyl acrylate was charged spending 40 minutes, and polymerization reaction was performed for 1.5 hours and further continue for 3 hours at 80° C. to obtain a dispersion containing the fluorine-acryl copolymer (Mw: 31,800) of the fluorine-containing monomer and octadecyl acrylate fluorine-acryl copolymer resin 1 by polymerizing the above monomers.

TABLE 5

| | | | Layer strength evaluation | | |
|---|---|---|---|---|---|
| | Clear hard coat film | | Alkali treatment + Durability test | | |
| | Surface | Additional resin in hard | under exposing to ozone (1,000 hours | | |
| | roughness | coat layer Adding amount | | Scratch | Pencil |
| | (Ra) | in part by weight | Adhesiveness | resistivity | hardness |
| Example 5 | 9 nm | None | B | 5 line | 2H |
| Example 25 | 9 nm | Fluorine-acryl copolymer | A | 1 line | 3H |
| | | resin 1 (2.6) | | | |
| Example 26 | 9 nm | Fluorine-acryl copolymer | A | 2 line | 3H |
| | | resin 2 (2.6) | | | |
| Example 27 | 9 nm | Fluorine-acryl copolymer | A | 1 line | 3H |
| | | resin 3 (2.6) | | | |
| Example 28 | 9 nm | Fluorine-acryl copolymer | A | 2 line | 3H |
| | | resin 3 (5.2) | | | |

As is understood from the results in Table 5, higher layer strength can be obtained by the presence of the above synthesized fluorine-siloxane copolymer resin in the severer durability test.

### Examples 29 to 32

Clear hard coat films were prepared in the same manner as in Example 5 in which the above synthesized fluorine-acryl copolymer resin 1, fluorine-acryl copolymer 2 or fluorine-acryl copolymer resin 3 available on the market (MODIPER 600, manufactured by NOF Corp.) were each dissolved in methyl ethyl ketone in a solid composition concentration of 10% and coated by the extrusion coater so as to form a wet layer thickness of 2 μm and dried at 80° C. Then the clear hard coat films were subjected to the durability test in the same manner as in Examples 13 to 23. The layer strength of each of the samples after the durability test was evaluated by the foregoing test methods.

TABLE 6

| | | | Layer strength evaluation | | |
|---|---|---|---|---|---|
| | Clear hard coat film | | Alkali treatment + Durability test | | |
| | Surface | Hard coat layer | under exposing to ozone (1,000 hours | | |
| | roughness | coating resin (Wet | | Scratch | Pencil |
| | (Ra) | layer thickness: 2 μm) | Adhesiveness | resistivity | hardness |
| Example 5 | 9 nm | None | B | 5 line | 2H |
| Example 29 | 9 nm | Fluorine-acryl | A | 1 line | 3H |
| | | copolymer resin 1 | | | |
| Example 30 | 9 nm | Fluorine-acryl | A | 2 line | 3H |
| | | copolymer resin 2 | | | |
| Example 31 | 9 nm | Fluorine-acryl | A | 1 line | 3H |
| | | copolymer resin 3 | | | |
| Example 32 | 9 nm | Fluorine-acryl | A | 2 line | 3H |
| | | copolymer resin 3 | | | |

As is understood from the results in Table 6, higher layer strength can be obtained in the severer durability test by laminating the layer containing the fluorine-acryl copolymer resin.

### Example 33 and Comparative Example 4

Polarization plates were prepared as follows using the clear hard coat films prepared in Examples 1 to 5 and Comparative Examples 1 to 3, and built in a liquid crystal displaying panels (image displaying device), respectively, and the visibility of these displaying panels were evaluated.

Polarization plates of the invention and comparative polarizing plates were prepare according to the following method each using a sheet of the clear hard coat films of Example 1 to 5 and Comparative Examples 1 to 3 and a sheet of cellulose ester type optical compensation film KC8UCR5, Manufactured by Konica Minolta Inc., as a polarizing plate protection film.

### (a) Preparation of Polarizing Film

One hundred parts by weight of polyvinyl alcohol), hereinafter referred to as PVA, having a saponified degree of 99.95 mole-% and a polymerization degree of 2,400 was impregnated with 10 parts by weight of glycerol and 170 parts by weight of water. The impregnated material was melted, kneaded and defoamed and then extruded onto a metal roller through a T-die to form a film. After that, the extruded film was dried and thermally treated to obtain a PVA film. Thus obtained PVA film had an average thickness of 40 μm, a moisture content of 4.4% and a width of 3 m.

The PVA film was successively subjected to a single-axial stretching treatment, a fixing treatment, a drying treatment and a thermal treatment to prepare a polarizing film according to the following pre-swelling, dyeing and wet method.

The PVA film was pre-swollen by immersing in water for 30 seconds at 30° C., and immersed for 3 minutes in an aqueous solution containing 0.4 g/liter of iodine and 40 g/liter of potassium iodide at 30° C. After that, the film was single axially stretched by 6 times in a 4% boric acid aqueous solution by applying a tension of 700 N/m, and then fixed by immersing for 5 minutes into an aqueous solution containing 40 g/liter of potassium iodide, 40 g/liter of boric acid and 10 g/liter of zinc chloride at 30° C. Then the PVA film was taken out and dried by hot air at 40° C. and further subjected to the thermal treatment at 100° C. for 5 minutes. The obtained polarizing film had an average thickness of 13 μm, and as to the polarization property, a transmittance of 43.0%, a polarization degree of 99.5% and a dichroic ratio of 40.1%.

### (b) Preparation of Polarizing Plate

The inventive and comparative polarizing plates were prepared by pasting the polarizing film and the polarizing plate protection film according to the following Processes 1 to 5.

Process 1: The optical compensation film and the clear hard coat film were immersed for 90 seconds into a 3 mole/L solution of sodium hydroxide at 60° C., and then washed by water and dried.

Similarly, the optical compensation film was immersed for 90 seconds in a 3 mole/L solution of sodium hydroxide at 60° C., and then washed by water and dried.

Process 2: The above polarizing film was dipped for 1 to 2 second into a tank containing a poly(vinyl alcohol) adherence having a solid component concentration of 2% by weight.

Process 3: The adherence excessively adhering on the polarizing film was lightly removed, and the polarizing film was placed and piled between the optical compensation film and the clear hard coat film each treated in Process 1.

Process 4: The above piled films were pasted by rotating two rollers at a rate of 2 m/min while applying a pressure of 20 to 30 N/cm². On this occasion, formation of bubbles was carefully prevented.

Process 5: The sample prepared in Process 4 was dried for 2 minutes in a dryer at 80° C. to prepare the polarizing plate.

The outermost polarizing plate of a liquid crystal panel available on the market was carefully separated and replaced by the inventive or comparative polarizing plate of so as to meet in the polarization direction.

### [Evaluation of Visibility]

Thus obtained inventive and comparative liquid crystal panels were placed on a desk with a height of 80 cm from the floor, and ten of the set composed of two straight tube daylight fluorescent 40 W lamps (FLR40SD/M-X, manufactured by Matsushita Electric Industrial Co., Ltd.) were arranged with an interval of 1.5 m at the ceiling. The fluorescent lamps were arranged so that the lamps were lined at the ceiling in the direction of from the overhead to backward of the observer when the observer placed under the front of the displaying face. The liquid crystal panel was slanted 25° to the perpendicular line of the desk so that the fluorescent lamps were reflected on the panel surface. The easiness of looking of the image was classified into the following ranking for evaluation.

A: The reflection of the fluorescent lamps did not attract notice of the observer, and letters of a font size not more than 8 could be read clearly.

B: The reflection of the nearly arranged fluorescent lamps somewhat attracted notice of the observer, but the ones far position did not attract, notice of the observer, and letters of a font size not more than 8 could be barely read.

C: The reflection of the nearly arranged fluorescent lamps attracted notice of the observer, and letters of a font size not more than 8 could be hardly read.

D: The reflection of the nearly arranged fluorescent lamps considerably attracted notice of the observer, and letters of a font size not more than 8 could not be read.

As the results of the evaluation, the liquid crystal panels using the polarizing plate including the clear hard coat film prepared in Example 1 to 4 or 5 were good which were ranked into B or more. Contrary to that, the liquid crystal panels using the polarizing plate including the clear hard coat film prepared in Comparative Example 1, 2 or 3 were ranked into C or less.

### Example 34

An antireflection film according to the invention was prepared by using the clear hard coat film of example 5.

(Atmospheric Pressure Plasma Treatment)

A clear hard coat film was prepared in the same manner as in Example 5 except that the nitrogen purge at the time of UV irradiation was omitted. The surface of the hard coat layer of the above clear hard coat film was subjected to an atmospheric pressure plasma surface treatment using an atmospheric pressure plasma treatment apparatus in which the electrode gap was set at 0.5 mm and discharging was carried out at 100 kHz while supplying the following discharging gas into the discharging space.

(Discharging Gas).

| | |
|---|---|
| Nitrogen gas | 80.0% by volume |
| Oxygen gas | 20.0% by volume |

(Formation of Layer of High Refractive Index)

For coating a layer of high refractive index on the clear hard coat film treated by the atmospheric plasma treatment, particle dispersion A and then a layer of high refractive index coating composition were prepared.

The following layer of high refractive index coating composition was coated by a die on the hard coat layer of the clear hard coat film treated by the atmospheric pressure plasma treatment and dried at 70° C., and then irradiated by UV rays of 0.2 J/cm² using a high pressure mercury lamp so as to form a layer of high refractive index having a thickness after curing of 120 nm. The refractive index of the layer of high refractive index was 1.60.

(Preparation of Fine Particle Dispersion A)

To 6.0 kg of methanol dispersion of antimony oxide composite (zinc antimonate sol having a solid content of 60%, trade name: CELNAX CX-Z610M-F2, manufactured by Nissan Chemical Industries Lid.), 12.0 kg of isopropyl alcohol was gradually added while stirring to prepare fine particle dispersion A.

(High Refractive Layer Coating Composition)

| | |
|---|---|
| PGME (propylene glycol monomethyl ether) | 40 parts by weight |
| Isopropyl alcohol | 25 parts by weight |
| Methyl ethyl ketone | 25 parts by weight |
| Pentaerythritol triacrylate | 0.9 parts by weight |
| Pentaerythritol pentacrylate | 1.0 parts by weight |
| Urethane acrylate (Trade name: U-4HA, | 0.6 parts by weight |
| Shin-Nakamura Chemical Co., Ltd.) | |
| Fine particle dispersion A | 20 parts by weight |
| IRGACURE 184 (Ciba Specialty Chemicals) | 0.4 parts by weight |
| IRGACURE 907 (Ciba Specialty Chemicals) | 0.2 parts by weight |
| FZ-2207 (10% propylene glycol monomethyl ether, | 0.4 parts by weight |
| Nippon Unicar Co., Ltd.) | |

(Formation of Layer of Low Refractive Index)

On the occasion of forming a layer of low refractive index on the layer of high refractive index of the layer of high refractive index coated clear hard coat film, an isopropyl alcohol dispersion of hollow silica fine particle 1 and a tetraethoxysilane hydrolysis product A were prepared, and layer of low refractive index coating composition 1.

(Preparation of Isopropyl Alcohol Dispersion of Hollow Silica Fine Particle 1)

Process (a): A mixture of 100 g of silica sol containing 20% by weight of SiO₂ having an average diameter of 5 nm and 1,900 g of purified water was heated by 80° C. The pH value of this mother liquid was 10.5. To the mother liquid, 9,000 g of sodium silicate having a concentration of 0.98% by weight in terms of SiO₂ and 9,000 g of aqueous solution of sodium aluminate having a concentration of 1.02% by weight in terms of Al₂O₃ were simultaneously added while keeping the temperature of reacting liquid at 80° C. The pH value of the reacting liquid was raised to 12.5 just after the addition and practically not varied thereafter. After completion of the addition, the reacting liquid was cooled by room temperature and washed by a ultra-filtration membrane to prepare a SiO₂.Al₂O₃ nuclear particle dispersion having a solid content of 20% by weight.

Process (b): To 500 g of the nuclear particle dispersion, 1,700 g of purified water was added and the mixture was heated by 98° C. To thus obtained mixture, 3,000 g of silicic acid liquid having a SiO₂ concentration of 3.5% by weight, which was prepared by de-alkalizing an aqueous solution of sodium silicate by anion exchange resin, was added while keeping the above temperature to obtain dispersion of the nuclear particles on each of which the first silica covering layer was formed.

Process (c): The dispersion of nuclear particle having the first silica layer was washed by using the ultrafiltration membrane so as to make the solid content in the dispersion to 135 by weight. To 500 g of thus obtained nuclear particle dispersion, 1,125 g of purified water was added, and the pH value of the dispersion was adjusted to 1.0 by dropping concentrated hydrochloric acid (35.5%) for de-aluminum treatment. After that, dissolved aluminum salt was removed by using the ultrafiltration membrane while, adding 10 L of hydrochloric acid solution having a pH value of 3 and 5 L of purified water to prepare dispersion of porous particles of SiO₂.Al₂O₃, each of which was formed by removing a part of the composition constituting the nuclear particle having the first silica covering layer.

Process (d): A mixture of 1,500 g of the above porous particle dispersion, 500 g of purified water, 1,750 g of ethanol and 626 g of 28% ammonia water was heated by 35° C. and then 104 g of ethyl silicate (SiO₂: 28% by weight) was added so as to cover the surface of the porous particle having the first silica covering layer by a second silica covering layer of hydrolysis polycondensation product of ethyl silicate. Thereafter, the solvent was replaced by isopropyl alcohol by using the ultrafiltration membrane to prepare dispersion of hollow silica fine particles having a solid content of 20% by weight. The hollow silica fine particle had a thickness of the first silica covering layer of 3 nm, an average particle diameter of 45 nm, a mol ratio of MO_{X}/SiO₂ of 0.0017, and a refractive index of 1.28. The average particle diameter and the variation coefficient of particle diameter were determined by a dynamic light scattering method.

(Preparation of Hydrolysis Product of Tetraethoxysilane)

Two hundred and thirty grams of tetraethoxysilane (trade name: KBE04, manufactured by Shi-Etsu Chemical Co., Ltd.) was mixed with 440 g of ethanol, and stirred for 28 hours at room temperature (25° C.) after addition of 120 g of 2% acetic acid aqueous solution to prepare hydrolysis product of tetraethoxysilane.

(Low Refractive Layer Coating Composition 1)

| | | |
|---|---|---|
| Propylene glycol monomethyl ether | 430 | parts by weight |
| Isopropyl alcohol | 430 | parts by weight |
| Tetraethoxysilane hydrolysis product 1 | 120 | parts by weight |
| (21% in terms of solid component) | | |
| γ-methacryloxypropyltrimethoxysilane | 3.0 | parts by weight |
| (Trade name: KBM503, Shin-Etsu | | |
| Chemical Co., Ltd.) | | |
| Isopropyl alcohol dispersion of hollow silica fine | 60 | parts by weight |
| particle 1 (Average particle diameter: 45 nm, | | |
| Variation coefficient of particle diameter: 30%) | | |
| Aluminum ethylacetoacetate diisopropylate | 3.0 | parts by weight |
| (Kawaken Fine Chemicals Co., Ltd.) | | |
| FZ-2207 (10% solution of propylene glycol | 3.0 | parts by weight |
| monomethyl ether, Nippon Unicar Co., Ltd.) | | |

On the clear hard coat film coated with the layer of high refractive index, the above layer of low refractive index coating composition 1 was coated by a die and dried at 80° C., and irradiated by 0.15 J/cm² of UV rays by a high pressure mercury lamp while nitrogen purging so as to make the oxygen concentration to not more than 1.0% by volume. Thus a layer of low refractive index having a thickness of 86 nm was formed to prepare an antireflection film. The refractive index of the layer of low refractive index was 1.38.

(Measurement of Reflectance)

The reflectance of the above prepared antireflection film measured by CM-3700d, manufactured by Konica Minolta Sensing Inc., was 0.83%, and the film has suitable property. The antireflection film was subjected to the durability test under exposing to ozone in the same manner as in Examples 1 to 5, and the layer strength was evaluated by the same method. The pencil hardness was 3H, and the scratch line number formed by the steel wool of the scratch resistivity test was one; therefore the layer strength was particularly preferred for practical use.

### Example 35

A polarizing plate was prepared using the antireflection film prepared in Example 34 by the method described in Example 33. The polarizing plate was integrated into a liquid crystal displaying panel (image displaying apparatus) and the visibility of it was evaluated in the same manner as in Example 33.

As the results of the evaluation, the liquid crystal panel using the antireflection film prepared in Example 34 was classified into Rank B or more and suitable.

1. A clear hard coat film having a hard coat layer on a transparent film substrate, wherein the hard coat layer comprises a fluorine-siloxane graft polymer and an energy actinic radiation curable resin.

2. The clear hard coat film of claim 1, wherein a content ratio of the fluorine-siloxane graft polymer to energy actinic radiation curable resin is from 0.05:100 to 5.00:100 by weight.

3. The clear hard coat film of claim 1, wherein the energy actinic radiation curable resin is a UV ray curable resin.

4. The clear hard coat film of claim 1, wherein the hard coat layer has been subjected to alkali saponification treatment.

5. The clear hard coat film of claim 1, wherein the hard coat layer comprises organic particles and/or inorganic particles.

6. The clear hard coat film of claim 1, wherein the hard coat layer comprises a fluorine-acryl copolymer resin.

7. The clear hard coat film of claim 1, wherein a layer having at least fluorine-acryl copolymer resin is laminated on the hard coat layer.

8. The clear hard coat film of claim 1, wherein the transparent film substrate is a cellulose ester film.

9. The clear hard coat film of claim 1, wherein the transparent film substrate comprises at least one compound containing an acryloyl group represented by Formula (Z), 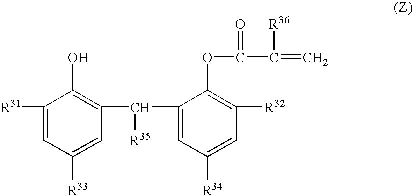
wherein, R³¹ to R³⁵ are same or different each other and a hydrogen atom or an alkyl group having 1 to 10 carbon atoms, R³⁶ is a hydrogen atom or a methyl group.

10. An anti-reflection film wherein a layer of high refractive index is provided on the hard coat layer of the clear hard coat film of claim 1, and a layer of low refractive index is provided on the layer of high refractive index.

11. A polarizing plate wherein the clear hard coat film of claim 1 is employed at one surface.

12. The polarizing plate wherein an anti-reflection film of claim 10 is employed at one surface.

13. A display device wherein the polarizing plate of claim 11 is employed.
